(19) United States
(12) Patent Application Publication
(10) Pub. No.: US 2025/0326682 A1
(43) Pub. Date: Oct. 23, 2025

(54) PHOTOSENSITIVE GLASS MATERIAL, PHOTOSENSITIVE MICROCRYSTALLINE GLASS AND PHOTOSENSITIVE MICROCRYSTALLINE GLASS PRODUCT

(71) Applicant: CDGM GLASS CO., LTD., Chengdu (CN)

(72) Inventors: Bin HU, Chengdu (CN); Baoping YUAN, Chengdu (CN); Changhong WANG, Chengdu (CN); Xuemei CHEN, Chengdu (CN); Jing ZHANG, Chengdu (CN)

(73) Assignee: CDGM GLASS CO., LTD., Chengdu (CN)

(21) Appl. No.: 18/910,037

(22) Filed: Oct. 9, 2024

(30) Foreign Application Priority Data
Apr. 22, 2024 (CN) 2024104835441

(51) Int. Cl. C03C 4/06; C03B 32/02; C03C 3/095; C03C 10/00

(52) U.S. Cl. CPC C03C 4/065; C03B 32/02; C03C 3/095; C03C 10/0054; C03C 2204/04

(57) ABSTRACT

The present invention provides a photosensitive glass material, including the following components in percentage by weight: 65-78% of SiO2; 2-12% of R2O; 5-15% of Li2O; 3-12% of Al2O3; 1.5-10% of ZrO2; 0.01-0.6% of CeO2; 0.01-0.8% of Ag2O, wherein Li2O/ZrO2 is 1.0-7.5, and the R2O is one or two of Na2O and K2O. By reasonable component design, the photosensitive glass material of the present invention has a lower dielectric loss, and photosensitive microcrystalline glass and a photosensitive microcrystalline glass product made therefrom also have lower dielectric losses, and can reduce transmission losses of electric signals of application terminals during use.

### FIELD OF TECHNOLOGY

The present invention relates to a glass material, and in particular to a photosensitive glass material having a lower dielectric loss.

### BACKGROUND OF THE INVENTION

Photosensitive glass materials will undergo structural changes within the glass body under UV light irradiation to produce crystal nuclei, which will generate a large number of crystals in the irradiated area after continued heat treatment at a certain temperature. The part that has been exposed is highly crystallized, the glass becomes darker, and the transmittance decreases; for the part that has not been exposed, the glass is not crystallized and remains transparent, thereby to enable patterns to be made on the photosensitive glass materials by mask exposure.

With the development of the times, in some electronic products, the existence of a transmitter and a receiver of light signals, in a transmission path of the light signals, requires maintaining a higher transmittance and avoiding the interference of external light signals, and therefore the photosensitive glass material can be designed as required to have a specific light signal channel and shield the interference of stray light signals. In the prior art, the surface of the glass can be coated to achieve the above effects, but compared to coating on the surface of the glass, the photosensitive microcrystalline glass device with a pattern prepared from a photosensitive glass material has a crystallization region deep into the glass matrix, and therefore has no risk of coating shedding, and the crystallization region deep into the glass also can avoid crosstalk of the external light signals, and can improve the detection of the device. The photosensitive glass material in the prior art has a higher dielectric loss, and the transmission loss of the electric signals in the glass material is larger, and thus it is difficult to meet the use of high-performance electronic devices and the like.

### SUMMARY OF THE INVENTION

Based on the above reasons, the technical problem to be solved by the present invention is to provide a photosensitive glass material having a lower dielectric loss, and photosensitive microcrystalline glass and a photosensitive microcrystalline glass product made therefrom.

The solutions adopted by the present invention to solve the technical problem are:

(1) A photosensitive glass material, including the following components in percentage by weight: 65-78% of SiO2; 2-12% of R2O; 5-15% of Li2O; 3-12% of Al2O3; 1.5-10% of ZrO2; 0.01-0.6% of CeO2; and 0.01-0.8% of Ag2O, wherein Li2O/ZrO2 is 1.0-7.5, and the R2O is one or two of Na2O and K2O.

(2) The photosensitive glass material according to (1), further including the following components in percentage by weight: 0-1% of Sb2O3; and/or 0-0.5% of SnO2; and/or 0-5% of MO; and/or 0-5% of Ln2O3; and/or 0-1% of Fe2O3, wherein the MO is one or more of MgO, CaO, SrO, BaO, and ZnO, and Ln2O3 is one or more of La2O3, Gd2O3, and Y2O3.

(3) A photosensitive glass material, including the following components in percentage by weight: SiO2, R2O, Li2O, Al2O3, ZrO2, CeO2 and Ag2O, wherein Li2O/ZrO2 is 1.0-7.5, the R2O is one or two of Na2O and K2O, and dielectric loss tan δ of the photosensitive glass material is below 11.0×10−3.

(4) A photosensitive glass material, including the following components: SiO2, R2O, Li2O, and Al2O3, the R2O being one or two of Na2O and K2O, with components thereof expressed in percentage by weight, wherein: (SiO2+Al2O3)/(Li2O+Na2O+K2O) is 3.0-7.5.

(5) A photosensitive glass material, including the following components: SiO2, R2O and ZrO2, the R2O being one or two of Na2O and K2O, with components thereof expressed in percentage by weight, wherein: (K2O+Na2O)/ZrO2 is 0.5-7.1.

(6) A photosensitive glass material, including the following components: SiO2, R2O, Li2O, Al2O3 and ZrO2, the R2O being one or two of Na2O and K2O, with components thereof expressed in percentage by weight, wherein: (SiO2+Li2O)/ZrO2 is 8.0-55.0.

(7) A photosensitive glass material, including the following components: SiO2, R2O, Li2O, Al2O3, ZrO2, CeO2 and Ag2O, the R2O being one or two of Na2O and K2O, Ag2O/CeO2 being 1.0-10.0.

(8) A photosensitive glass material, including the following components: SiO2, R2O, Li2O, Al2O3 and ZrO2, wherein the R2O is one or two of Na2O and K2O, and the matrix glass has Young's modulus E of 7,000×107 Pa-9,500×107 Pa.

(9) A photosensitive glass material, including the following components: SiO2, R2O, Li2O, Al2O3 and ZrO2, wherein the R2O is one or two of Na2O and K2O, and the matrix glass has a dielectric constant εr of 5.5-8.5.

(10) A photosensitive glass material, including the following components: SiO2, R2O, Li2O, Al2O3 and ZrO2, wherein the R2O is one or two of Na2O and K2O, and the matrix glass has a Knoop hardness Hk0.1 above 450 kgf/mm2.

(11) A photosensitive glass material, including the following components: SiO2, R2O, Li2O, Al2O3 and ZrO2, wherein the R2O is one or two of Na2O and K2O, and the matrix glass has a linear expansion coefficient α20° C.-300° C. below 100×10−7/° C.

(12) The photosensitive glass material according to any one of (3)-(11), including the following components in percentage by weight: 65-78% of SiO2; and/or 2-12% of R2O; and/or 5-15% of Li2O; and/or 3-12% of Al2O3; and/or 1.5-10% of ZrO2; and/or 0.01-0.6% of CeO2; and/or 0.01-0.8% of Ag2O; and/or 0-1% of Sb2O3; and/or 0-0.5% of SnO2; and/or 0-5% of MO; and/or 0-5% of Ln2O3; and/or 0-1% of Fe2O3, wherein the R2O is one or two of Na2O and K2O, MO is one or more of MgO, CaO, SrO, BaO, and ZnO, and Ln2O3 is one or more of La2O3, Gd2O3, and Y2O3.

(13) A photosensitive glass material, including the following components in percentage by weight: 65-78% of SiO2; 2-12% of R2O; 5-15% of Li2O; 3-12% of Al2O3; 1.5-10% of ZrO2; 0.01-0.6% of CeO2; 0.01-0.8% of Ag2O, the R2O being one or two of Na2O and K2O.

(14) The photosensitive glass material according to (13), further including the following components in percentage by weight: 0-1% of Sb2O3; and/or 0-0.5% of SnO2; and/or 0-5% of MO; and/or 0-5% of Ln2O3; and/or 0-1% of Fe2O3, wherein the MO is one or more of MgO, CaO, SrO, BaO, and ZnO, and Ln2O3 is one or more of La2O3, Gd2O3, and Y2O3.

(15) The photosensitive glass material according to any one of (1)-(14), wherein components thereof in percentage by weight satisfy one or more of the following 7 circumstances:
1) SiO2/Li2O is 5.5-10.0, preferably SiO2/Li2O is 6.0-9.0, and more preferably SiO2/Li2O is 7.0-8.5;
2) (K2O+Na2O)/ZrO2 is 0.5-7.1, preferably (K2O+Na2O)/ZrO2 is 0.7-4.5, and more preferably (K2O+Na2O)/ZrO2 is 0.8-2.5;
3) Li2O/ZrO2 is 1.2-5.0, preferably Li2O/ZrO2 is 1.4-4.3, and more preferably Li2O/ZrO2 is 1.6-3.0;
4) (SiO2+Li2O)/ZrO2 is 8.0-55.0, preferably (SiO2+Li2O)/ZrO2 is 10.0-37.0, more preferably (SiO2+Li2O)/ZrO2 is 12.0-25.0, and further preferably (SiO2+Li2O)/ZrO2 is 13.0-20.0;
5) (SiO2+Al2O3)/(Li2+Na2O+K2O) is 3.7-6.5, more preferably (SiO2+Al2O3)/(Li2O+Na2O+K2O) is 4.3-6.0, and further preferably (SiO2+Al2O3)/(Li2O+Na2O+K2O) is 4.8-5.8;
6) R2O+Li2O+Al2O3 is 15-30%, preferably R2O+Li2O+Al2O3 is 17.5-29.5%, more preferably R2O+Li2O+Al2O3 is 18.5-26%, and further preferably R2O+Li2O+Al2O3 is 20-25%; and
7) MO/ZrO2 is below 2.5, preferably MO/ZrO2 is below 1.5, and more preferably MO/ZrO2 is below 0.5,
the MO is one or more of MgO, CaO, SrO, BaO, and ZnO, and R2O is one or two of Na2O and K2O.

(16) The photosensitive glass material according to any one of (1)-(15), wherein components thereof in percentage by weight satisfy one or more of the following 7 circumstances:
1) (Sb2O3+SnO2)/Ag2O is 0.1-5.0, preferably (Sb2O3+SnO2)/Ag2O is 0.5-3.5, and more preferably (Sb2O3+SnO2)/Ag2O is 1.0-2.6;
2) Ag2O/CeO2 is 1.0-10.0, preferably Ag2O/CeO2 is 1.5-6.5, and more preferably Ag2O/CeO2 is 2.0-4.5;
3) ZrO2/(Ag2O+CeO2) is 2.3-50.0, preferably ZrO2/(Ag2O+CeO2) is 6.5-35.0, more preferably ZrO2/(Ag2O+CeO2) is 8.5-20.0, and further preferably ZrO2/(Ag2O+CeO2) is 11.0-18.0;
4) (Ag2O+SnO2+Sb2O3)/CeO2 is 1.0-30.0, preferably (Ag2O+SnO2+Sb2O3)/CeO2 is 3.0-20.0, more preferably (Ag2O+SnO2+Sb2O3)/CeO2 is 5.0-12.5, and further preferably (Ag2O+SnO2+Sb2O3)/CeO2 is 7.5-10.0;
5) (Sb2O3+SnO2+CeO2)/Ag2O is 0.1-10.0, preferably (Sb2O3+SnO2+CeO2)/Ag2O is 0.4-5.0, more preferably (Sb2O3+SnO2+CeO2)/Ag2O is 0.7-3.7, and further preferably (Sb2O3+SnO2+CeO2)/Ag2O is 1.5-3.2;
6) SnO2/(CeO2+SnO2) is 0-0.9, preferably SnO2/(CeO2+SnO2) is 0-0.6, and more preferably SnO2/(CeO2+SnO2) is 0-0.5; and
7) Sb2O3+SnO2 is 0.05-1.2%, preferably Sb2O3+SnO2 is 0.1-1%, and more preferably Sb2O3+SnO2 is 0.2-0.7%.

(17) The photosensitive glass material according to any one of (1)-(16), including the following components in percentage by weight: 68-77% of SiO2, preferably 69.5-75.5% of SiO2; and/or 3-10% of R2O, preferably 4-8% of R2O; and/or 7-13% of Li2O, preferably 8.5-12% of Li2O; and/or 4-10% of Al2O3, preferably 5-9% of Al2O3; and/or 2-8% of ZrO2, preferably 3-6.5% of ZrO2; and/or 0.07-0.4% of CeO2, preferably 0.08-0.3% of CeO2; and/or 0.1-0.6% of Ag2O, preferably 0.2-0.5% of Ag2O; and/or 0.01-0.7% of Sb2O3, preferably 0.07-0.5% of Sb2O3; and/or 0-0.3% of SnO2, preferably 0-0.2% of SnO2; and/or 0-3% of MO, preferably 0-1% of MO, more preferably free of MO; and/or 0-3% of Ln2O3, preferably 0-1% of Ln2O3, more preferably free of Ln2O3; and/or 0-0.5% of Fe2O3, preferably 0-0.2% of Fe2O3, more preferably free of Fe2O3, wherein the R2O is one or two of Na2O and K2O, MO is one or more of MgO, CaO, SrO, BaO, and ZnO, and Ln2O3 is one or more of La2O3, Gd2O3, and Y2O3.

(18) The photosensitive glass material according to any one of (1)-(17), wherein the photosensitive glass material has a refractive index nd of 1.51-1.55, preferably 1.52-1.54, more preferably 1.53-1.535, and further preferably 1.53112-1.53284; and/or Young's modulus E of 7,000×107 Pa-9,500×107 Pa, preferably 7,500×107 Pa-9,200×107 Pa, more preferably 7,836×107 Pa-9,014×107 Pa, and further preferably 8,005×107 Pa-8,488×107 Pa; and/or Knoop hardness Hk0.1 above 450 kgf/mm2, preferably 470-600 kgf/mm2, more preferably 480-582 kgf/mm2, and further preferably 492-532 kgf/mm2; and/or a height I for a falling ball test above 200 mm, preferably above 300 mm, and more preferably above 400 mm; and/or dielectric loss tan δ below 11.0×10−3, preferably 7.0×10−3-10.5×10−3, more preferably 7.2×10−3-9.8×10−3, and further preferably 7.4×10−3-9.2×10−3; and/or dielectric constant εr of 5.5-8.5, preferably 6.0-8.0, more preferably 6.2-7.7, and further preferably 6.3-7.0; and/or a linear expansion coefficient α20° C.-300° C. below 100×10−7/° C., preferably 65×10−7/° C.-100×10−7/° C., more preferably 71×10−7/° C.-95×10−7/° C., and further preferably 75×10−7/° C.-90×10−7/° C.

(19) Photosensitive microcrystalline glass, including the following components in percentage by weight: 65-78% of SiO2; 2-12% of R2O; 5-15% of Li2O; 3-12% of Al2O3; 1.5-10% of ZrO2; 0.01-0.6% of CeO2; and 0.01-0.8% of Ag2O, wherein Li2O/ZrO2 is 1.0-7.5, and the R2O is one or two of Na2O and K2O.

(20) Photosensitive microcrystalline glass, including the following components in percentage by weight: 65-78% of SiO2; 2-12% of R2O; 5-15% of Li2O; 3-12% of Al2O3; 1.5-10% of ZrO2; 0.01-0.6% of CeO2; 0.01-0.8% of Ag2O, the R2O being one or two of Na2O and K2O.

(21) The photosensitive microcrystalline glass according to (19) or (20), further including the following components in percentage by weight: 0-1% of Sb2O3; and/or 0-0.5% of SnO2; and/or 0-5% of MO; and/or 0-5% of Ln2O3; and/or 0-1% of Fe2O3, wherein the MO is one or more of MgO, CaO, SrO, BaO, and ZnO, and Ln2O3 is one or more of La2O3, Gd2O3, and Y2O3.

22. Photosensitive microcrystalline glass, including the following components in percentage by weight: SiO2, R2O, Li2O, Al2O3, ZrO2, CeO2 and Ag2O, wherein Li2O/ZrO2 is 1.0-7.5, and the R2O is one or two of Na2O and K2O.

(23) Photosensitive microcrystalline glass, including one or more blackened parts and one or more transparent parts, wherein the photosensitive microcrystalline glass includes a lithium metasilicate crystalline phase, and in the blackened part of the photosensitive microcrystalline glass, the lithium metasilicate crystalline phase has a weight percentage of 5-50%.

(24) Photosensitive microcrystalline glass, including the following components: SiO2, R2O, Li2O, Al2O3, ZrO2, CeO2 and Ag2O, wherein the R2O is one or two of Na2O and K2O, and the photosensitive microcrystalline glass includes one or more blackened parts and one or more transparent parts.

(25) Photosensitive microcrystalline glass, including the following components: SiO2, R2O, Li2O and Al2O3, the R2O being one or two of Na2O and K2O, with components thereof expressed in percentage by weight, wherein (SiO2+Al2O3)/(Li2O+Na2O+K2O) is 3.0-7.5.

(26) Photosensitive microcrystalline glass, including the following components: SiO2, R2O and ZrO2, the R2O being one or two of Na2O and K2O, with components thereof expressed in percentage by weight, wherein (K2O+Na2O)/ZrO2 is 0.5-7.1.

(27) Photosensitive microcrystalline glass, including the following components: SiO2, R2O, Li2O, Al2O3 and ZrO2, the R2O being one or two of Na2O and K2O, with components thereof expressed in percentage by weight, wherein (SiO2+Li2O)/ZrO2 is 8.0-55.0.

(28) Photosensitive microcrystalline glass, including the following components: SiO2, R2O, Li2O, Al2O3, ZrO2, CeO2 and Ag2O, wherein the R2O is one or two of Na2O and K2O, and Ag2O/CeO2 is 1.0-10.0.

(29) Photosensitive microcrystalline glass, including the following components: SiO2, R2O, Li2O, Al2O3 and ZrO2, wherein the R2O is one or two of Na2O and K2O, the photosensitive microcrystalline glass includes a lithium metasilicate crystalline phase, and the lithium metasilicate crystalline phase has a weight percentage higher than those of other crystalline phases.

(30) Photosensitive microcrystalline glass, including the following components: SiO2, R2O, Li2O, Al2O3 and ZrO2, wherein the R2O is one or two of Na2O and K2O, and the photosensitive microcrystalline glass includes a lithium silicate crystalline phase.

(31) Photosensitive microcrystalline glass, including one or more blackened parts and one or more transparent parts, wherein the blackened part of the photosensitive microcrystalline glass with a thickness of 0.2-1.5 mm has a transmittance T870 nm below 15.0% at 870 nm.

(32) Photosensitive microcrystalline glass, including one or more blackened parts and one or more transparent parts, wherein the blackened part of the photosensitive microcrystalline glass with a thickness of 0.2-1.5 mm has a transmittance T940 nm below 50.0% at 940 nm.

(33) The photosensitive microcrystalline glass according to any one of (22)-(32), including the following components in percentage by weight: 65-78% of SiO2; and/or 2-12% of R2O; and/or 5-15% of Li2O; and/or 3-12% of Al2O3; and/or 1.5-10% of ZrO2; and/or 0.01-0.6% of CeO2; and/or 0.01-0.8% of Ag2O; and/or 0-1% of Sb2O3; and/or 0-0.5% of SnO2; and/or 0-5% of MO; and/or 0-5% of Ln2O3; and/or 0-1% of Fe2O3, wherein the R2O is one or two of Na2O and K2O, MO is one or more of MgO, CaO, SrO, BaO, and ZnO, and Ln203 is one or more of La2O3, Gd2O3, and Y2O3.

(34) The photosensitive microcrystalline glass according to any one of (19)-(33), wherein components thereof in percentage by weight satisfy one or more of the following 7 circumstances:
1) SiO2/Li2O is 5.5-10.0, preferably SiO2/Li2O is 6.0-9.0, and more preferably SiO2/Li2O is 7.0-8.5;
2) (K2O+Na2O)/ZrO2 is 0.5-7.1, preferably (K2O+Na2O)/ZrO2 is 0.7-4.5, and more preferably (K2O+Na2O)/ZrO2 is 0.8-2.5;
3) Li2O/ZrO2 is 1.2-5.0, preferably Li2O/ZrO2 is 1.4-4.3, and more preferably Li2O/ZrO2 is 1.6-3.0;
4) (SiO2+Li2O)/ZrO2 is 8.0-55.0, preferably (SiO2+Li2O)/ZrO2 is 10.0-37.0, more preferably (SiO2+Li2O)/ZrO2 is 12.0-25.0, and further preferably (SiO2+Li2O)/ZrO2 is 13.0-20.0;
5) (SiO2+Al2O3)/(Li2O+Na2O+K2O) is 3.0-7.5, preferably (SiO2+Al2O3)/(Li2O+Na2O+K2O) is 3.7-6.5, more preferably (SiO2+Al2O3)/(Li2O+Na2O+K2O) is 4.3-6.0, and further preferably (SiO2+Al2O3)/(Li2O+Na2O+K2O) is 4.8-5.8;
6) R2O+Li2O+Al2O3 is 15-30%, preferably R2O+Li2O+Al2O3 is 17.5-29.5%, more preferably R2O+Li2O+Al2O3 is 18.5-26%, and further preferably R2O+Li2O+Al2O3 is 20-25%; and
7) MO/ZrO2 is below 2.5, preferably MO/ZrO2 is below 1.5, and more preferably MO/ZrO2 is below 0.5,
the MO is one or more of MgO, CaO, SrO, BaO, and ZnO, and R2O is one or two of Na2O and K2O.

(35) The photosensitive microcrystalline glass according to any one of (19)-(34), wherein components thereof in percentage by weight satisfy one or more of the following 7 circumstances:
1) (Sb2O3+SnO2)/Ag2O is 0.1-5.0, preferably (Sb2O3+SnO2)/Ag2O is 0.5-3.5, and more preferably (Sb2O3+SnO2)/Ag2O is 1.0-2.6;
2) Ag2O/CeO2 is 1.0-10.0, preferably Ag2O/CeO2 is 1.5-6.5, and more preferably Ag2O/CeO2 is 2.0-4.5;
3) ZrO2/(Ag2O+CeO2) is 2.3-50.0, preferably ZrO2/(Ag2O+CeO2) is 6.5-35.0, more preferably ZrO2/(Ag2O+CeO2) is 8.5-20.0, and further preferably ZrO2/(Ag2O+CeO2) is 11.0-18.0;
4) (Ag2O+SnO2+Sb2O3)/CeO2 is 1.0-30.0, preferably (Ag2O+SnO2+Sb2O3)/CeO2 is 3.0-20.0, more preferably (Ag2O+SnO2+Sb2O3)/CeO2 is 5.0-12.5, and further preferably (Ag2O+SnO2+Sb2O3)/CeO2 is 7.5-10.0;
5) (Sb2O3+SnO2+CeO2)/Ag2O is 0.1-10.0, preferably (Sb2O3+SnO2+CeO2)/Ag2O is 0.4-5.0, more preferably (Sb2O3+SnO2+CeO2)/Ag2O is 0.7-3.7, and further preferably (Sb2O3+SnO2+CeO2)/Ag2O is 1.5-3.2;
6) SnO2/(CeO2+SnO2) is 0-0.9, preferably SnO2/(CeO2+SnO2) is 0-0.6, and more preferably SnO2/(CeO2+SnO2) is 0-0.5; and
7) Sb2O3+SnO2 is 0.05-1.2%, preferably Sb2O3+SnO2 is 0.1-1%, and more preferably Sb2O3+SnO2 is 0.2-0.7%.

(36) The photosensitive microcrystalline glass according to any one of (19)-(35), including the following components in percentage by weight: 68-77% of SiO2, preferably 69.5-75.5% of SiO2; and/or 3-10% of R2O, preferably 4-8% of R2O; and/or 7-13% of Li2O, preferably 8.5-12% of Li2O; and/or 4-10% of Al2O3, preferably 5-9% of Al2O3; and/or 2-8% of ZrO2, preferably 3-6.5% of ZrO2; and/or 0.07-0.4% of CeO2, preferably 0.08-0.3% of CeO2; and/or 0.1-0.6% of Ag2O, preferably 0.2-0.5% of Ag2O; and/or 0.01-0.7% of Sb2O3, preferably 0.07-0.5% of Sb2O3; and/or 0-0.3% of SnO2, preferably 0-0.2% of SnO2; and/or 0-3% of MO, preferably 0-1% of MO, more preferably free of MO; and/or 0-3% of Ln2O3, preferably 0-1% of Ln2O3, more preferably free of Ln2O3; and/or 0-0.5% of Fe2O3, preferably 0-0.2% of Fe2O3, more preferably free of Fe2O3, wherein the R2O is one or two of Na2O and K2O, MO is one or more of MgO, CaO, SrO, BaO, and ZnO, and Ln2O3 is one or more of La2O3, Gd2O3, and Y2O3.

(37) The photosensitive microcrystalline glass according to any one of (19)-(36), wherein the photosensitive microcrystalline glass includes one or more blackened parts and one or more transparent parts; or the photosensitive microcrystalline glass as a whole is a blackened part.

(38) The photosensitive microcrystalline glass according to any one of (19)-(37), wherein the photosensitive microcrystalline glass includes a lithium silicate crystalline phase, preferably a lithium metasilicate crystalline phase, and more preferably in the blackened part of the photosensitive microcrystalline glass, the lithium metasilicate crystalline phase having a weight percentage of 5-50%, further preferably in the blackened part of the photosensitive microcrystalline glass, the lithium metasilicate crystalline phase having a weight percentage of 5-40%, and even further preferably in the blackened part of the photosensitive microcrystalline glass, the lithium metasilicate crystalline phase having a weight percentage of 10-30%.

(39) The photosensitive microcrystalline glass according to any one of (19)-(38), wherein the transparent part of the photosensitive microcrystalline glass with a thickness of 0.2-1.5 mm has an average transmittance T400-800 nm above 85.0%, preferably above 88.0%, more preferably above 90.0%, further preferably above 91.0%, and even further preferably 91.5-95.0% at a wave band range of 400-800 nm; and/or the blackened part of the photosensitive microcrystalline glass with a thickness of 0.2-1.5 mm has an average transmittance T400-800 nm below 5.0%, preferably below 3.0%, more preferably below 1.5%, further preferably below 1.2%, and even further preferably below 0.5% at a wave band range of 400-800 nm; and/or the blackened part of the photosensitive microcrystalline glass with a thickness of 0.2-1.5 mm has a transmittance T870 nm below 15.0%, preferably 0.1-12.5%, more preferably 0.1-10%, further preferably 0.1-8.0%, and even further preferably 0.1-5.0% at 870 nm; and/or the blackened part of the photosensitive microcrystalline glass with a thickness of 0.2-1.5 mm has a transmittance T940 nm below 50.0%, preferably 0.1-35.0%, more preferably 0.3-20.0%, further preferably 0.3-15.0%, and even further preferably 0.3-10.0% at 940 nm.

(40) The photosensitive microcrystalline glass according to any one of (19)-(39), wherein the photosensitive microcrystalline glass has a thickness of 0.5-1.5 mm, preferably 0.8-1.2 mm, more preferably 0.5 mm, 0.7 mm, 0.8 mm, 0.9 mm, 1.0 mm, 1.1 mm, 1.2 mm.

(41) A photosensitive microcrystalline glass product, including the following components in percentage by weight: 65-78% of SiO2; 2-12% of R2O; 5-15% of Li2O; 3-12% of Al2O3; 1.5-10% of ZrO2; 0.01-0.6% of CeO2; and 0.01-0.8% of Ag2O, wherein Li2O/ZrO2 is 1.0-7.5, and the R2O is one or two of Na2O and K2O.

(42) A photosensitive microcrystalline glass product, including the following components in percentage by weight: 65-78% of SiO2; 2-12% of R2O; 5-15% of Li2O; 3-12% of Al2O3; 1.5-10% of ZrO2; 0.01-0.6% of CeO2; 0.01-0.8% of Ag2O, the R2O being one or two of Na2O and K2O.

(43) The photosensitive microcrystalline glass product according to (41) or (42), further including the following components in percentage by weight: 0-1% of Sb2O3; and/or 0-0.5% of SnO2; and/or 0-5% of MO; and/or 0-5% of Ln2O3; and/or 0-1% of Fe2O3, wherein the MO is one or more of MgO, CaO, SrO, BaO, and ZnO, and Ln2O3 is one or more of La2O3, Gd2O3, and Y2O3.

(44) A photosensitive microcrystalline glass product, including the following components in percentage by weight: SiO2, R2O, Li2O, Al2O3, ZrO2, CeO2 and Ag2O, wherein Li2O/ZrO2 is 1.0-7.5, and the R2O is one or two of Na2O and K2O.

(45) A photosensitive microcrystalline glass product, including the following components: SiO2, Li2O, Al2O3, CeO2 and Ag2O, the photosensitive microcrystalline glass product having a height II for a falling ball test above 800 mm.

(46) A photosensitive microcrystalline glass product, including one or more blackened parts and one or more transparent parts, wherein the photosensitive microcrystalline glass product includes a lithium metasilicate crystalline phase, and in the blackened part of the photosensitive microcrystalline glass product, the lithium metasilicate crystalline phase has a weight percentage of 5-50%.

(47) A photosensitive microcrystalline glass product, including the following components: SiO2, R2O, Li2O, Al2O3, ZrO2, CeO2 and Ag2O, wherein the R2O is one or two of Na2O and K2O, and the microcrystalline glass product includes one or more blackened parts and one or more transparent parts.

(48) A photosensitive microcrystalline glass product, including the following components: SiO2, R2O, Li2O and Al2O3, the R2O being one or two of Na2O and K2O, with components thereof expressed in percentage by weight, wherein (SiO2+Al2O3)/(Li2O+Na2O+K2O) is 3.0-7.5.

(49) A photosensitive microcrystalline glass product, including the following components: SiO2, R2O, Li2O, Al2O3 and ZrO2, the R2O being one or two of Na2O and K2O, with components thereof expressed in percentage by weight, wherein (K2O+Na2O)/ZrO2 is 0.5-7.1.

(50) A photosensitive microcrystalline glass product, including the following components: SiO2, R2O, Li2O, Al2O3 and ZrO2, the R2O being one or two of Na2O and K2O, with components thereof expressed in percentage by weight, wherein (SiO2+Li2O)/ZrO2 is 8.0-55.0.

(51) A photosensitive microcrystalline glass product, including the following components: SiO2, R2O, Li2O, Al2O3 and ZrO2, wherein the R2O is one or two of Na2O and K2O, the photosensitive microcrystalline glass product includes a lithium metasilicate crystalline phase, and the lithium metasilicate crystalline phase has a weight percentage higher than those of other crystalline phases.

(52) A photosensitive microcrystalline glass product, including one or more blackened parts and one or more transparent parts, wherein the blackened part of the photosensitive microcrystalline glass product with a thickness of 0.2-1.5 mm has a transmittance T870 nm below 15.0% at 870 nm.

(53) A photosensitive microcrystalline glass product, including one or more blackened parts and one or more transparent parts, wherein the blackened part of the photosensitive microcrystalline glass product with a thickness of 0.2-1.5 mm has a transmittance T940 nm below 50.0% at 940 nm.

(54) The photosensitive microcrystalline glass product according to any one of (44)-(53), including the following components in percentage by weight: 65-78% of SiO2; and/or 2-12% of R2O; and/or 5-15% of Li2O; and/or 3-12% of Al2O3; and/or 1.5-10% of ZrO2; and/or 0.01-0.6% of CeO2; and/or 0.01-0.8% of Ag2O; and/or 0-1% of Sb2O3; and/or 0-0.5% of SnO2; and/or 0-5% of MO; and/or 0-5% of Ln2O3; and/or 0-1% of Fe2O3, wherein the R2O is one or two of Na2O and K2O, MO is one or more of MgO, CaO, SrO, BaO, and ZnO, and Ln2O3 is one or more of La2O3, Gd2O3, and Y2O3.

(55) The photosensitive microcrystalline glass product according to any one of (41)-(54), wherein components thereof in percentage by weight satisfy one or more of the following 7 circumstances:
1) SiO2/Li2O is 5.5-10.0, preferably SiO2/Li2O is 6.0-9.0, and more preferably SiO2/Li2O is 7.0-8.5;
2) (K2O+Na2O)/ZrO2 is 0.5-7.1, preferably (K2O+Na2O)/ZrO2 is 0.7-4.5, and more preferably (K2O+Na2O)/ZrO2 is 0.8-2.5;
3) Li2O/ZrO2 is 1.2-5.0, preferably Li2O/ZrO2 is 1.4-4.3, and more preferably Li2O/ZrO2 is 1.6-3.0;
4) (SiO2+Li2O)/ZrO2 is 8.0-55.0, preferably (SiO2+Li2O)/ZrO2 is 10.0-37.0, more preferably (SiO2+Li2O)/ZrO2 is 12.0-25.0, and further preferably (SiO2+Li2O)/ZrO2 is 13.0-20.0;
5) (SiO2+Al2O3)/(Li2+Na2O+K2O) is 3.7-6.5, more preferably (SiO2+Al2O3)/(Li2O+Na2O+K2O) is 4.3-6.0, and further preferably (SiO2+Al2O3)/(Li2O+Na2O+K2O) is 4.8-5.8;
6) R2O+Li2O+Al2O3 is 15-30%, preferably R2O+Li2O+Al2O3 is 17.5-29.5%, more preferably R2O+Li2O+Al2O3 is 18.5-26%, and further preferably R2O+Li2O+Al2O3 is 20-25%; and
7) MO/ZrO2 is below 2.5, preferably MO/ZrO2 is below 1.5, and more preferably MO/ZrO2 is below 0.5,
the MO is one or more of MgO, CaO, SrO, BaO, and ZnO, and R2O is one or two of Na2O and K2O.

(56) The photosensitive microcrystalline glass product according to any one of (41)-(55), wherein components thereof in percentage by weight satisfy one or more of the following 7 circumstances:
1) (Sb2O3+SnO2)/Ag2O is 0.1-5.0, preferably (Sb2O3+SnO2)/Ag2O is 0.5-3.5, and more preferably (Sb2O3+SnO2)/Ag2O is 1.0-2.6;
2) Ag2O/CeO2 is 1.0-10.0, preferably Ag2O/CeO2 is 1.5-6.5, and more preferably Ag2O/CeO2 is 2.0-4.5;
3) ZrO2/(Ag2O+CeO2) is 2.3-50.0, preferably ZrO2/(Ag2O+CeO2) is 6.5-35.0, more preferably ZrO2/(Ag2O+CeO2) is 8.5-20.0, and further preferably ZrO2/(Ag2O+CeO2) is 11.0-18.0;
4) (Ag2O+SnO2+Sb2O3)/CeO2 is 1.0-30.0, preferably (Ag2O+SnO2+Sb2O3)/CeO2 is 3.0-20.0, more preferably (Ag2O+SnO2+Sb2O3)/CeO2 is 5.0-12.5, and further preferably (Ag2O+SnO2+Sb2O3)/CeO2 is 7.5-10.0;
5) (Sb2O3+SnO2+CeO2)/Ag2O is 0.1-10.0, preferably (Sb2O3+SnO2+CeO2)/Ag2O is 0.4-5.0, more preferably (Sb2O3+SnO2+CeO2)/Ag2O is 0.7-3.7, and further preferably (Sb2O3+SnO2+CeO2)/Ag2O is 1.5-3.2;
6) SnO2/(CeO2+SnO2) is 0-0.9, preferably SnO2/(CeO2+SnO2) is 0-0.6, and more preferably SnO2/(CeO2+SnO2) is 0-0.5; and
7) Sb2O3+SnO2 is 0.05-1.2%, preferably Sb2O3+SnO2 is 0.1-1%, and more preferably Sb2O3+SnO2 is 0.2-0.7%.

(57) The photosensitive microcrystalline glass product according to any one of (41)-(55), including the following components in percentage by weight: 68-77% of SiO2, preferably 69.5-75.5% of SiO2; and/or 3-10% of R2O, preferably 4-8% of R2O; and/or 7-13% of Li2O, preferably 8.5-12% of Li2O; and/or 4-10% of Al2O3, preferably 5-9% of Al2O3; and/or 2-8% of ZrO2, preferably 3-6.5% of ZrO2; and/or 0.07-0.4% of CeO2, preferably 0.08-0.3% of CeO2; and/or 0.1-0.6% of Ag2O, preferably 0.2-0.5% of Ag2O; and/or 0.01-0.7% of Sb2O3, preferably 0.07-0.5% of Sb2O3; and/or 0-0.3% of SnO2, preferably 0-0.2% of SnO2; and/or 0-3% of MO, preferably 0-1% of MO, more preferably free of MO; and/or 0-3% of Ln2O3, preferably 0-1% of Ln2O3, more preferably free of Ln2O3; and/or 0-0.5% of Fe2O3, preferably 0-0.2% of Fe2O3, more preferably free of Fe2O3, wherein the R2O is one or two of Na2O and K2O, MO is one or more of MgO, CaO, SrO, BaO, and ZnO, and Ln2O3 is one or more of La2O3, Gd2O3, and Y2O3.

(58) The photosensitive microcrystalline glass product according to any one of (41)-(57), wherein the photosensitive microcrystalline glass product includes one or more blackened parts and one or more transparent parts; or the photosensitive microcrystalline glass product as a whole is a blackened part.

(59) The photosensitive microcrystalline glass product according to any one of (41)-(58), wherein the photosensitive microcrystalline glass product includes a lithium silicate crystalline phase, preferably a lithium metasilicate crystalline phase, and more preferably in the blackened part of the photosensitive microcrystalline glass product, the lithium metasilicate crystalline phase having a weight percentage of 5-50%, further preferably in the blackened part of the photosensitive microcrystalline glass product, the lithium metasilicate crystalline phase having a weight percentage of 5-40%, and even further preferably in the blackened part of the photosensitive microcrystalline glass product, the lithium metasilicate crystalline phase having a weight percentage of 10-30%.

(60) The photosensitive microcrystalline glass product according to any one of (41)-(59), wherein the transparent part of the photosensitive microcrystalline glass product with a thickness of 0.2-1.5 mm has an average transmittance T400-800 nm above 85.0%, preferably above 88.0%, more preferably above 90.0%, further preferably above 91.0%, and even further preferably 91.5-95.0% at a wave band range of 400-800 nm; and/or the blackened part of the photosensitive microcrystalline glass product with a thickness of 0.2-1.5 mm has an average transmittance T400-800 nm below 5.0%, preferably below 3.0%, more preferably below 1.5%, further preferably below 1.2%, and even further preferably below 0.5% at a wave band range of 400-800 nm; and/or the blackened part of the photosensitive microcrystalline glass product with a thickness of 0.2-1.5 mm has a transmittance T870 nm below 15.0%, preferably 0.1-12.5%, more preferably 0.1-10%, further preferably 0.1-8.0%, and even further preferably 0.1-5.0% at 870 nm; and/or the blackened part of the photosensitive microcrystalline glass product with a thickness of 0.2-1.5 mm has a transmittance T940 nm below 50.0%, preferably 0.1-35.0%, more preferably 0.3-20.0%, further preferably 0.3-15.0%, and even further preferably 0.3-10.0% at 940 nm.

(61) The photosensitive microcrystalline glass product according to any one of (41)-(60), wherein the photosensitive microcrystalline glass product has a thickness of 0.5-1.5 mm, preferably 0.8-1.2 mm, more preferably 0.5 mm, 0.7 mm, 0.8 mm, 0.9 mm, 1.0 mm, 1.1 mm, 1.2 mm.

(62) The photosensitive microcrystalline glass product according to any one of (41)-(61), wherein the photosensitive microcrystalline glass product has a height II for a falling ball test above 800 mm, preferably above 900 mm, more preferably above 1,000 mm, and further preferably above 1,100 mm.

(63) A glass cover plate, including the photosensitive glass material of any one of (1)-(18), and/or the photosensitive microcrystalline glass of any one of (19)-(40), and/or the photosensitive microcrystalline glass product of any one of (41)-(62).

(64) A glass element, including the photosensitive glass material of any one of (1)-(18), and/or the photosensitive microcrystalline glass of any one of (19)-(40), and/or the photosensitive microcrystalline glass product of any one of (41)-(62).

(65) A device, including the photosensitive glass material of any one of (1)-(18), and/or the photosensitive microcrystalline glass of any one of (19)-(40), and/or the photosensitive microcrystalline glass product of any one of (41)-(62), and/or the glass cover plate of (63), and/or the glass component of (64).

(66) A method for preparing the photosensitive microcrystalline glass of any one of (19)-(40), wherein the method includes the following steps: forming the photosensitive glass material and allowing the photosensitive glass material to form the photosensitive microcrystalline glass by a crystallization process.

(67) The method for preparing the photosensitive microcrystalline glass according to (66), wherein the crystallization process includes subjecting the photosensitive glass material to mask exposure treatment, followed by crystallization heat treatment, and the mask exposure treatment includes subjecting a specific position or region of the photosensitive glass material to UV exposure, at a UV wavelength preferably of 313 nm, for an exposure time preferably of 5-60 minutes.

(68) The method for preparing the photosensitive microcrystalline glass according to claim 66) or (67), wherein the crystallization heat treatment is performed in 2 stages, the 2-stage crystallization heat treatment includes conducting treatment by a nucleation process at a first temperature, and then conducting treatment by a crystal growth process at a second temperature higher than the temperature of the nucleation process, preferably the first temperature is 490° C.-520° C., preferably treatment time at the first temperature is 1-4 hours, preferably the second temperature is 540° C.-620° C., and preferably treatment time at the second temperature is 1-8 hours.

(69) A method for preparing the photosensitive microcrystalline glass product of any one of (41)-(62), including the following steps: forming the photosensitive glass material, allowing the photosensitive glass material to form the photosensitive microcrystalline glass by a crystallization process, and then allowing the photosensitive microcrystalline glass to form the photosensitive microcrystalline glass product by a chemically strengthening process.

(70) The method for preparing the photosensitive microcrystalline glass product according to (69), wherein the crystallization process includes subjecting the photosensitive glass material to mask exposure treatment, followed by crystallization heat treatment, and the mask exposure treatment includes subjecting a specific position or region of the photosensitive glass material to UV exposure, at a UV wavelength preferably of 313 nm, for an exposure time preferably of 5-60 minutes.

(71) The method for preparing the photosensitive microcrystalline glass product according to claim 69) or (70), wherein the crystallization heat treatment is performed in 2 stages, the 2-stage crystallization heat treatment includes conducting treatment by a nucleation process at a first temperature, and then conducting treatment by a crystal growth process at a second temperature higher than the temperature of the nucleation process, preferably the first temperature is 490° C.-520° C., preferably treatment time at the first temperature is 1-4 hours, preferably the second temperature is 540° C.-620° C., and preferably treatment time at the second temperature is 1-8 hours.

(72) The method for preparing the photosensitive microcrystalline glass product according to any one of (69)-(71), wherein the chemically strengthening process includes immersing the photosensitive microcrystalline glass in a salt bath of melt Na salts, and/or K salts, and/or mixed Na salts and K salts at a temperature of 350° C.-470° C. for about 1-36 hours, preferably at the temperature of 380° C.-460° C., preferably for a time of 2-24 hours.

The beneficial effects of the present invention are in that: by reasonable component design, the photosensitive glass material of the present invention has a lower dielectric loss, and photosensitive microcrystalline glass and a photosensitive microcrystalline glass product made therefrom also have lower dielectric losses, and can reduce transmission losses of electric signals of application terminals during use.

### BRIEF DESCRIPTION OF DRAWINGS

Hereinafter, the embodiments of the present invention will be described in detail, but the present invention is not limited to the following embodiments, and may be implemented with appropriate changes within the scope of the purpose of the present invention. Moreover, with respect to the repeated description portion, there are instances where the description is appropriately omitted, which however does not thereby limit the gist of the invention.

The photosensitive microcrystalline glass and the photosensitive microcrystalline glass product of the present invention are materials having a crystalline phase (sometimes also referred to as crystal) and a glass phase, which are different from noncrystalline solids. The crystalline phase of the photosensitive microcrystalline glass and the photosensitive microcrystalline glass product can be distinguished by the peak angle appearing in the X-ray diffraction pattern analyzed by X-ray diffraction and/or determined by TEMEDX.

The inventor of the present invention has repeatedly experimented and studied on the specific components constituting the photosensitive microcrystalline glass and the photosensitive microcrystalline glass product, and obtained the photosensitive microcrystalline glass or the photosensitive microcrystalline glass product of the present invention by specifying the contents and content ratios thereof to be specific values and allowing a specific crystalline phase to precipitate.

In some embodiments, the photosensitive microcrystalline glass of the present invention includes one or more blackened parts and one or more transparent parts, wherein the transparent part refers to the part of the photosensitive microcrystalline glass having an average transmittance (T400-800 nm) above 85.0% at 400-800 nm wave band range, when the photosensitive microcrystalline glass is processed to a thickness of 0.2-1.5 mm, and the blackened part refers to the part of the photosensitive microcrystalline glass having an average transmittance (T400-800 nm) below 5.0% at 400-800 nm wave band range, when the photosensitive microcrystalline glass is processed to a thickness of 0.2-1.5 mm. In some embodiments, the blackened part of the photosensitive microcrystalline glass includes a crystalline phase, and the transparent part of the photosensitive microcrystalline glass includes no crystalline phase. In some embodiments, the crystalline phase of the blackened part of the photosensitive microcrystalline glass is uniformly distributed.

In some embodiments, the photosensitive microcrystalline glass product of the present invention includes one or more blackened parts and one or more transparent parts, wherein the transparent part refers to the part of the photosensitive microcrystalline glass product having an average transmittance (T400-800 nm) above 85.0% at 400-800 nm wave band range, when the photosensitive microcrystalline glass product is processed to a thickness of 0.2-1.5 mm, and the blackened part refers to the part of the photosensitive microcrystalline glass product having an average transmittance (T400-800 nm) below 5.0% at 400-800 nm wave band range, when the photosensitive microcrystalline glass product is processed to a thickness of 0.2-1.5 mm. In some embodiments, the blackened part of the photosensitive microcrystalline glass product includes a crystalline phase, and the transparent part of the photosensitive microcrystalline glass product includes no crystalline phase. In some embodiments, the crystalline phase of the blackened part of the photosensitive microcrystalline glass product is uniformly distributed.

In some embodiments, the present invention photosensitive microcrystalline glass or the photosensitive microcrystalline glass product as a whole is a blackened part, wherein the blackened part refers to the part of the photosensitive microcrystalline glass or the photosensitive microcrystalline glass product having an average transmittance (T400-800 nm) below 5.0% at 400-800 nm wave band range, when the photosensitive microcrystalline glass or the photosensitive microcrystalline glass product is processed to a thickness of 0.2-1.5 mm. In some embodiments, the crystalline phase of the blackened part of the photosensitive microcrystalline glass or the photosensitive microcrystalline glass product is uniformly distributed.

In some embodiments, the photosensitive microcrystalline glass or the photosensitive microcrystalline glass product of the present invention as a whole is a transparent part, wherein the transparent part refers to the part of the photosensitive microcrystalline glass or the photosensitive microcrystalline glass product having an average transmittance (T400-800 nm) above 85.0% at 400-800 nm wave band range, when the photosensitive microcrystalline glass or the photosensitive microcrystalline glass product is processed to a thickness of 0.2-1.5 mm.

In some embodiments, the blackened part in the photosensitive microcrystalline glass or the photosensitive microcrystalline glass product of the present invention can constitute a pattern of any shape and/or size.

Hereinafter, the ranges of various components (ingredients) of the photosensitive glass material, the photosensitive microcrystalline glass and the photosensitive microcrystalline glass product of the present invention will be described. In the specification, if not otherwise specified, the contents of each component are all expressed in weight percent (wt %) relative to the total amount of the substances of the photosensitive glass material, or the photosensitive microcrystalline glass, or the photosensitive microcrystalline glass product that are converted to the composition of the oxides. Herein, the “converted to the composition of the oxides” means that in a case that oxides, compound salts, hydroxides and the like used as raw materials of the components of the photosensitive glass material, the photosensitive microcrystalline glass, or the photosensitive microcrystalline glass product of the present invention decompose and are converted to oxides when melted, the total amount of the oxides is taken as 100%. In addition, in the specification, where only glass is referred to is the photosensitive glass material before crystallization (i.e., a crystallization process treatment), the photosensitive glass material is referred to as photosensitive microcrystalline glass after crystallization (i.e., a crystallization process treatment), and the photosensitive microcrystalline glass product refers to a product obtained after the photosensitive microcrystalline glass is chemically strengthened.

Unless otherwise indicated in a specific case, the ranges of values set forth herein include upper and lower limits, and “above” and “below” include endpoint values, as well as all integers and fractions within the ranges, and are not limited to the specific values listed while the ranges being defined. The term “about” as used herein refers to formulations, parameters and other quantities and characteristics that are not, and need not be, precise, but can be approximate and/or larger or lower if desired, reflecting tolerances, conversion factors, measurement errors, etc. The term “and/or” as referred to herein is inclusive, e.g., “A and/or B” means only A, or only B, or both A and B.

In some embodiments of the present invention, the crystalline phase (crystals) in the photosensitive microcrystalline glass or the photosensitive microcrystalline glass product includes a lithium silicate crystalline phase, preferably a lithium metasilicate crystalline phase (Li2SiO3) crystalline phase. In some embodiments, the lithium metasilicate crystalline phase has a higher weight percentage than other crystalline phases. In some embodiments, the crystalline phase in the photosensitive microcrystalline glass or the photosensitive microcrystalline glass product only includes a lithium metasilicate crystalline phase.

In some embodiments, in the blackened part of the photosensitive microcrystalline glass or the photosensitive microcrystalline glass product, the lithium metasilicate crystalline phase has a weight percentage of 5-50%, preferably the lithium metasilicate crystalline phase has a weight percentage of 5-40%, and more preferably the lithium metasilicate crystalline phase has a weight percentage of 10-30%. In some embodiments, in the blackened part of the photosensitive microcrystalline glass or the photosensitive microcrystalline glass product, the lithium metasilicate crystalline phase has a weight percentage of 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%.

SiO2 is the oxide of a glass-forming body, the skeleton forming the glass, and has lower dielectric constant and dielectric loss, and SiO2 is a component of lithium metasilicate of the photosensitive microcrystalline glass. When the content of SiO₂ is less than 65%, the hardness and the expansion coefficient of glass decrease, and the dielectric constant and the dielectric loss of glass increase. When the content of SiO₂ is higher than 78%, the transmittances of the blackened parts of the photosensitive microcrystalline glass and the photosensitive microcrystalline glass product increase. Therefore, the content range of SiO2 is 65-78%, preferably 68-77%, and more preferably 69.5-75.5%. In some embodiments, about 65%, 65.5%, 66%, 66.5%, 67%, 67.5%, 68%, 68.5%, 69%, 69.5%, 70%, 70.5%, 71%, 71.5%, 72%, 72.5%, 73%, 73.5%, 74%, 74.5%, 75%, 75.5%, 76%, 76.5%, 77%, 77.5%, 78% of SiO2 may be included.

Li2O is a main ingredient forming crystals of the photosensitive microcrystalline glass and the photosensitive microcrystalline glass product of the present invention. when the content of Li2O is less than 5%, the content of the crystals of the photosensitive microcrystalline glass or the photosensitive microcrystalline glass product decreases, and the transmittance of the blackened part is higher; when the content of Li2O is more than 15%, the Young's modulus and the height for a falling ball test of the glass decrease, the refractive index and the dielectric loss of the glass increase, meanwhile the glass of the UV-unexposed part during crystallization of the photosensitive glass material easily precipitates out crystals during the heat treatment, and the transmittances of the transparent parts of the photosensitive microcrystalline glass and the photosensitive microcrystalline glass product decrease. Therefore, the content of Li2O is limited to 5-15%, preferably 7-13%, and more preferably 8.5-12%. In some embodiments, about 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15% of Li2O may be included.

The inventor has found through research that in some embodiments, the hardness and the height for a falling ball test of the glass increase with the increased value of SiO2/Li2O, and the refractive index decreases with the increased value of SiO2/Li2O. Meanwhile, when SiO2/Li2O is lower than 5.5, the transmittances of the transparent parts of the photosensitive microcrystalline glass and the photosensitive microcrystalline glass product decrease, and the transmittances of the blackened parts increase; when SiO2/Li2O is above 10.0, the crystal contents of the blackened parts of the photosensitive microcrystalline glass and the photosensitive microcrystalline glass product are lower, and the transmittances of the blackened parts increase. Thus, in some embodiments, with preferably SiO2/Li2O being 5.5-10.0, more preferably SiO2/Li2O being 6.0-9.0, and further preferably SiO2/Li2O being 7.0-8.5, the transparent parts of the photosensitive microcrystalline glass and the photosensitive microcrystalline glass product have higher transmittances at a visible light wave band, and meanwhile the blackened parts have lower transmittances, particularly suitable for light signal channels or light-shielding systems of electronic products. In some embodiments, the value of SiO2/Li2O may be 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0.

Alkaline metal oxides R2O (R2O is one or two of Na2O and K2O) can promote precipitation of lithium metasilicate crystals, and improve the transmittances of the blackened parts of the photosensitive microcrystalline glass and the photosensitive microcrystalline glass product. When the content of R2O is less than 2%, the crystal contents of the photosensitive microcrystalline glass and the photosensitive microcrystalline glass product decrease, and the transmittances of the blackened parts increase, even unable to achieve blackening effects; when the content of R2O is more than 12%, the Young's modulus and the height for a falling ball test of the glass decrease, and the refractive index, the dielectric constant and the dielectric loss of the glass increase. Thus, the content of R2O is limited to 2-12%, preferably 3-10%, and more preferably 4-8%. In some embodiments, about 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12% of R2O may be included.

Al2O3 can inhibit reduction of the transmittances of the transparent parts of the photosensitive microcrystalline glass and the photosensitive microcrystalline glass product after mask exposure and heat treatment, increase the strength and the hardness of the glass, and enhance the chemical stability of the glass. When the content of Al2O3 is less than 3%, the hardness and the Young's modulus of the glass decrease, and the linear expansion coefficient increases; when the content of Al2O3 is more than 12%, the dielectric constant and the dielectric loss of the glass increase, the crystal contents of the blackened parts of the photosensitive microcrystalline glass and the photosensitive microcrystalline glass product decrease, and the transmittances of the blackened parts increase, even unable to achieve blackening effects. Thus, the content of Al2O3 is 3-12%, preferably 4-10%, and more preferably 5-9%. In some embodiments, about 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12% of Al2O3 may be included.

In some embodiments, when the summed content R2O+Li2O+Al2O3 of R2O, Li2O and Al2O3 is less than 15%, the refractive index, the hardness, and the Young's modulus of the glass decrease; when R2O+Li2O+Al2O3 is more than 30%, the dielectric constant and the dielectric loss of the glass increase. Thus, preferably R2O+Li2O+Al2O3 is 15-30%, more preferably R2O+Li2O+Al2O3 is 17.5-29.5%, further preferably R2O+Li2O+Al2O3 is 18.5-26%, and even further preferably R2O+Li2O+Al2O3 is 20-25%. In some embodiments, R2O+Li2O+Al2O3 is approximately 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, 25%, 25.5%, 26%, 26.5%, 27%, 27.5%, 28%, 28.5%, 29%, 29.5%, 30%.

The inventor has found through extensive experimental research that in some embodiments, the ratio (SiO2+Al2O3)/(Li2O+Na2O+K2O) of the summed content SiO2+Al2O3 of SiO2 and Al2O3 to the summed content Li2O+Na2O+K2O of Li2O, Na2O and K2O is controlled to be within a range of 3.0-7.5, the transmittances of the blackened parts of the photosensitive microcrystalline glass and the photosensitive microcrystalline glass product are lower, and the refractive index of the glass is lower, so that the reflectance of the light signal on the glass surface can be reduced, and the incident rate of the light signal can be increased. Thus, preferably (SiO2+Al2O3)/(Li2O+Na2O+K2O) is 3.0-7.5, more preferably (SiO2+Al2O3)/(Li2O+Na2O+K2O) is 3.7-6.5, further preferably (SiO2+Al2O3)/(Li2O+Na2O+K2O) is 4.3-6.0, and even further preferably (SiO2+Al2O3)/(Li2O+Na2O+K2O) is 4.8-5.8. In some embodiments, the value of (SiO2+Al2O3)/(Li2O+Na2O+K2O) may be is 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5.

ZrO2 can modulate the precision of a black pattern formed by the blackened part after the glass going through the mask exposure, improve the discrimination of an interface between an exposed part and an unexposed part, and prevent the unexposed part from crystal precipitation near the interface position after going through the heat treatment, so that after going through the heat treatment the unexposed part maintains a high transmittance at a visible light wave band, and meanwhile it is ensured that after the exposed part going through the heat treatment, the blackened part has a lower transmittance. When the content of ZrO2 is less than 1.5%, the expansion coefficient of the glass increases, while the glass going through the heat treatment, and the unexposed part easily precipitates crystals, leading to a reduction of the transmittance of the transparent part. When the content of ZrO2 is higher than 10%, the crystal contents of the photosensitive microcrystalline glass and the photosensitive microcrystalline glass product decrease, and the transmittances of the blackened parts increase, even unable to achieve blackening effects. Thus, the content of ZrO2 is 1.5-10%, preferably 2-8%, and more preferably 3-6.5%. In some embodiments, about 1.5%, 2%, 2.5%, 3%, 3.5%, 4%, 4.5%, 5%, 5.5%, 6%, 6.5%, 7%, 7.5%, 8%, 8.5%, 9%, 9.5%, 10% of ZrO2 may be included.

In some embodiments, the ratio (K2O+Na2O)/ZrO2 of the summed content K2O+Na2O of K2O and Na2O to the content of ZrO2 is controlled to be within a range of 0.5-7.1, the transmittances of the transparent parts of the photosensitive microcrystalline glass and the photosensitive microcrystalline glass product are higher, the hardness and the Young's modulus of the glass are higher, and the dielectric constant of the glass is lower. Thus, preferably (K2O+Na2O)/ZrO2 is 0.5-7.1, more preferably (K2O+Na2O)/ZrO2 is 0.7-4.5, and further preferably (K2O+Na2O)/ZrO2 is 0.8-2.5. In some embodiments, the value of (K2O+Na2O)/ZrO2 may be 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.5, 4.6, 4.7, 4.8, 4.9, 5.0, 5.1, 5.2, 5.3, 5.4, 5.5, 6.0, 6.5, 7.0, 7.1.

In some embodiments, controlling the ratio Li2O/ZrO2 of the content of Li2O to the content of ZrO2 to be within a range of 1.0-7.5, can allow the glass to have a lower refractive index and dielectric loss, can improve the precision of a pattern formed within the photosensitive microcrystalline glass and the photosensitive microcrystalline glass product after the glass going through the mask exposure and heat treatment, with the transmittances of the transparent parts of the photosensitive microcrystalline glass and the photosensitive microcrystalline glass product being higher, and the transmittances of the blackened parts being lower. Thus, preferably Li2O/ZrO2 is 1.0-7.5, more preferably Li2O/ZrO2 is 1.2-5.0, further preferably Li2O/ZrO2 is 1.4-4.3, and even further preferably Li2O/ZrO2 is 1.6-3.0. In some embodiments, the value of Li2O/ZrO2 may be 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.5, 6.0, 6.5, 7.0, 7.5.

In some embodiments, controlling the ratio (SiO2+Li2O)/ZrO2 of the summed content SiO2+Li2O of SiO2 and Li2O to the content of ZrO2 to be within a range of 8.0-55.0, can increase the hardness and the height for a falling ball test of the glass, reduce the expansion coefficient and the dielectric constant of the glass, improve the precision of a pattern formed within the photosensitive microcrystalline glass and the photosensitive microcrystalline glass product after the glass going through the mask exposure and heat treatment, and increase the heights for a falling ball test of the photosensitive microcrystalline glass and the photosensitive microcrystalline glass product, with the transmittances of the blackened parts of the photosensitive microcrystalline glass and the photosensitive microcrystalline glass product being lower. Thus, preferably (SiO2+Li2O)/ZrO2 is 8.0-55.0, more preferably (SiO2+Li2O)/ZrO2 is 10.0-37.0, further preferably (SiO2+Li2O)/ZrO2 is 12.0-25.0, and even further preferably (SiO2+Li2O)/ZrO2 is 13.0-20.0. In some embodiments, the value of (SiO2+Li2O)/ZrO2 may be 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, 20.5, 21.0, 21.5, 22.0, 22.5, 23.0, 23.5, 24.0, 24.5, 25.0, 25.5, 26.0, 26.5, 27.0, 27.5, 28.0, 28.5, 29.0, 29.5, 30.0, 30.5, 31.0, 31.5, 32.0, 32.5, 33.0, 33.5, 34.0, 34.5, 35.0, 35.5, 36.0, 36.5, 37.0, 38.0, 39.0, 40.0, 41.0, 42.0, 43.0, 44.0, 45.0, 46.0, 47.0, 48.0, 49.0, 50.0, 51.0, 52.0, 53.0, 54.0, 55.0.

Alkaline earth metal oxides MO (MO being one or more of MgO, CaO, SrO, BaO, and ZnO) can improve the dielectric constant of the glass, and improve the transmittances of the blackened parts of the photosensitive microcrystalline glass and the photosensitive microcrystalline glass product; when the content of MO is higher than 5%, the dielectric constant and the dielectric loss of the glass increase, and the Young's modulus and the height for a falling ball test of the glass decrease. Thus, in the present invention, the content of MO is limited to 0-5%, preferably 0-3%, more preferably 0-1%, and further preferably free of MO. In some embodiments, about 0%, more than 0%, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5% of MO may be included.

In some embodiments, when MO/ZrO2 is more than 2.5, the dielectric loss of the glass increases, the hardness, the Young's modulus and the height for a falling ball test of the glass decrease, and the transmittances of the blackened parts of the photosensitive microcrystalline glass and the photosensitive microcrystalline glass product increase. Thus, preferably MO/ZrO2 is below 2.5, more preferably MO/ZrO2 is below 1.5, and further preferably MO/ZrO2 is below 0.5. In some embodiments, the value of MO/ZrO2 may be 0, more than 0, 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5.

CeO2 is a photosensitizer providing electrons for a component such as Ag, Sb, Sn, etc., when the content of CeO2 is lower than 0.01%, and fails to provide enough electrons, so that crystal content of the photosensitive microcrystalline glass is too low, the transmittances of the blackened parts of the photosensitive microcrystalline glass and the photosensitive microcrystalline glass product decrease, and the Young's modulus of the photosensitive microcrystalline glass and the photosensitive microcrystalline glass product decrease; when the content of CeO2 is higher than 0.6%, the transmittances of the transparent parts of the photosensitive microcrystalline glass and the photosensitive microcrystalline glass product decrease, and the penetration depths of the photosensitive microcrystalline glass and the photosensitive microcrystalline glass product at an ultraviolet wave band decrease, and the crystal contents within the blackened parts of the photosensitive microcrystalline glass and the photosensitive microcrystalline glass product decrease, and the transmittances increase. Thus, the content of CeO2 is 0.01-0.6%, preferably 0.07-0.4%, and more preferably 0.08-0.3%. In some embodiments, about 0.01%, 0.02%, 0.03%, 0.04%, 0.05%, 0.06%, 0.07%, 0.08%, 0.09%, 0.1%, 0.11%, 0.12%, 0.13%, 0.14%, 0.15%, 0.16%, 0.17%, 0.18%, 0.19%, 0.2%, 0.21%, 0.22%, 0.23%, 0.24%, 0.25%, 0.26%, 0.27%, 0.28%, 0.29%, 0.3%, 0.31%, 0.32%, 0.33%, 0.34%, 0.35%, 0.36%, 0.37%, 0.38%, 0.39%, 0.4%, 0.41%, 0.42%, 0.43%, 0.44%, 0.45%, 0.46%, 0.47%, 0.48%, 0.49%, 0.5%, 0.51%, 0.52%, 0.53%, 0.54%, 0.55%, 0.56%, 0.57%, 0.58%, 0.59%, 0.6% of CeO2 may be included.

Ag2O, as a crystal nucleating agent of the photosensitive microcrystalline glass and the photosensitive microcrystalline glass product of the present invention, plays a role to improve blackening effects in the photosensitive microcrystalline glass and the photosensitive microcrystalline glass product. When the content of Ag2O is lower than 0.01%, the transmittances of the blackened parts of the photosensitive microcrystalline glass and the photosensitive microcrystalline glass product increase, even failing to blacken, and the photosensitive microcrystalline glass and the photosensitive microcrystalline glass product have decreased heights for the falling ball test, increased expansion coefficients, and decreased graphic precision. When the content of Ag2O is above 0.8%, during the molding or heat treatment of the glass, the transmittance of the transparent part decreases, and because of the content of crystal nuclei being too high, the amount of crystals within the photosensitive microcrystalline glass and the photosensitive microcrystalline glass product increases, leading to too refined grain sizes, so that the crystals of the blackened parts scatter the visible light with attenuation, easily leading to the increased transmittances of the blackened parts, and the glass easily precipitates crystals while molding. Thus, the content of Ag2O is limited to 0.01-0.8%, preferably 0.1-0.6%, and more preferably 0.2-0.5%. In some embodiments, about 0.01%, 0.02%, 0.03%, 0.04%, 0.05%, 0.06%, 0.07%, 0.08%, 0.09%, 0.1%, 0.11%, 0.12%, 0.13%, 0.14%, 0.15%, 0.16%, 0.17%, 0.18%, 0.19%, 0.2%, 0.21%, 0.22%, 0.23%, 0.24%, 0.25%, 0.26%, 0.27%, 0.28%, 0.29%, 0.3%, 0.31%, 0.32%, 0.33%, 0.34%, 0.35%, 0.36%, 0.37%, 0.38%, 0.39%, 0.4%, 0.41%, 0.42%, 0.43%, 0.44%, 0.45%, 0.46%, 0.47%, 0.48%, 0.49%, 0.5%, 0.51%, 0.52%, 0.53%, 0.54%, 0.55%, 0.56%, 0.57%, 0.58%, 0.59%, 0.6%, 0.61%, 0.62%, 0.63%, 0.64%, 0.65%, 0.66%, 0.67%, 0.68%, 0.69%, 0.7%, 0.71%, 0.72%, 0.73%, 0.74%, 0.75%, 0.76%, 0.77%, 0.78%, 0.79%, 0.8% of Ag2O may be included.

The inventor has found through research that, in some embodiments, by controlling the ratio Ag2O/CeO2 of the content of Ag2O to the content of CeO2 to be within a range of 1.0-10.0, the blackened parts of the photosensitive microcrystalline glass and the photosensitive microcrystalline glass product have larger grain sizes, higher crystal contents, stronger scattering of the light of a visible light wave band, lower transmittances of the blackened parts, and the hardness and the height for a falling ball test of the photosensitive microcrystalline glass and photosensitive microcrystalline glass product increase. Thus, preferably Ag2O/CeO2 is 1.0-10.0, more preferably Ag2O/CeO2 is 1.5-6.5, and further preferably Ag2O/CeO2 is 2.0-4.5. In some embodiments, the value of Ag2O/CeO2 may be 1.0, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.5, 6.0, 6.5, 7.0, 7.5, 8.0, 8.5, 9.0, 9.5, 10.0.

In some embodiments, controlling the ratio ZrO2/(Ag2O+CeO2) of the content of ZrO2 to the summed content Ag2O+CeO2 of Ag2O and CeO2 to be within a range of 2.3-50.0, can optimize the expansion coefficient of the glass, increase the precision of a pattern formed within the photosensitive microcrystalline glass after the glass going through the mask exposure and heat treatment; meanwhile the transmittances of the transparent parts of the photosensitive microcrystalline glass and the photosensitive microcrystalline glass product are higher, and the transmittances of the blackened parts are lower, and the hardness and the falling ball height of the glass and the photosensitive microcrystalline glass product can be increased. Thus, preferably ZrO2/(Ag2O+CeO2) is 2.3-50.0, more preferably ZrO2/(Ag2O+CeO2) is 6.5-35.0, further preferably ZrO2/(Ag2O+CeO2) is 8.5-20.0, and even further preferably ZrO2/(Ag2O+CeO2) is 11.0-18.0. In some embodiments, the value of ZrO2/(Ag2O+CeO2) may be 2.3, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, 20.5, 21.0, 21.5, 22.0, 22.5, 23.0, 23.5, 24.0, 24.5, 25.0, 26.0, 27.0, 28.0, 29.0, 30.0, 31.0, 32.0, 33.0, 34.0, 35.0, 36.0, 37.0, 38.0, 39.0, 40.0, 41.0, 42.0, 43.0, 44.0, 45.0, 46.0, 47.0, 48.0, 49.0, 50.0.

Sb2O3 and SnO2 during UV exposure, absorb the electrons released by Ce3+ to play a role of storing electrons, provide electrons for Ag+during the subsequent heat treatment, form Ag colloid nucleation, and promote the photosensitive microcrystalline glass to be blackened. When the content of Sb2O3+SnO2 is lower than 0.05%, it is difficult for the photosensitive microcrystalline glass or the photosensitive microcrystalline glass product to achieve blackening effects; when the content of Sb2O3+SnO2 is higher than 1.2%, the blackened part of the photosensitive microcrystalline glass or the photosensitive microcrystalline glass product has a trend towards an increased transmittance. Thus, the content of Sb2O3+SnO2 is 0.05-1.2%, preferably 0.1-1%, and more preferably 0.2-0.7%. In some embodiments, the content of Sb2O3+SnO2 is approximately 0.05%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, 1.0%, 1.05%, 1.1%, 1.15%, 1.2%.

SnO2 has a better effect to promote the photosensitive microcrystalline glass to be blackened, but in some embodiments, when the content of SnO2 is higher than 0.5%, while the molding or heat treatment of the glass, the transmittance of the transparent part decreases, even devitrification. Thus, the content of SnO2 is limited to 0-0.5%, preferably 0-0.3%, and more preferably 0-0.2%. The content of Sb2O3 is limited to 0-1%, preferably 0.01-0.7%, and more preferably 0.07-0.5%. In some embodiments, about 0%, more than 0%, 0.01%, 0.02%, 0.03%, 0.04%, 0.05%, 0.06%, 0.07%, 0.08%, 0.09%, 0.1%, 0.11%, 0.12%, 0.13%, 0.14%, 0.15%, 0.16%, 0.17%, 0.18%, 0.19%, 0.2%, 0.21%, 0.22%, 0.23%, 0.24%, 0.25%, 0.26%, 0.27%, 0.28%, 0.29%, 0.3%, 0.31%, 0.32%, 0.33%, 0.34%, 0.35%, 0.36%, 0.37%, 0.38%, 0.39%, 0.4%, 0.41%, 0.42%, 0.43%, 0.44%, 0.45%, 0.46%, 0.47%, 0.48%, 0.49%, 0.5% of SnO2 may be included. In some embodiments, about 0%, more than 0%, 0.01%, 0.02%, 0.03%, 0.04%, 0.05%, 0.06%, 0.07%, 0.08%, 0.09%, 0.1%, 0.11%, 0.12%, 0.13%, 0.14%, 0.15%, 0.16%, 0.17%, 0.18%, 0.19%, 0.2%, 0.21%, 0.22%, 0.23%, 0.24%, 0.25%, 0.26%, 0.27%, 0.28%, 0.29%, 0.3%, 0.31%, 0.32%, 0.33%, 0.34%, 0.35%, 0.36%, 0.37%, 0.38%, 0.39%, 0.4%, 0.41%, 0.42%, 0.43%, 0.44%, 0.45%, 0.46%, 0.47%, 0.48%, 0.49%, 0.5%, 0.55%, 0.6%, 0.65%, 0.7%, 0.75%, 0.8%, 0.85%, 0.9%, 0.95%, 1% of Sb2O3 may be included.

The inventor has found through extensive experimental research that, in some embodiments, controlling the ratio (Sb2O3+SnO2)/Ag2O of the summed content Sb2O3+SnO2 of Sb2O3 and SnO2 to the content of Ag2O to be within a range of 0.1-5.0, can reduce the dielectric loss of the glass, and increase the heights for the falling ball test of the glass and the photosensitive microcrystalline glass product, so that the transmittances of the transparent parts of the photosensitive microcrystalline glass and the photosensitive microcrystalline glass product are higher, and the transmittances of the blackened parts are lower. Thus, preferably (Sb2O3+SnO2)/Ag2O is 0.1-5.0, more preferably (Sb2O3+SnO2)/Ag2O is 0.5-3.5, and further preferably (Sb2O3+SnO2)/Ag2O is 1.0-2.6. In some embodiments, the value of (Sb2O3+SnO2)/Ag2O may be 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0.

In some embodiments, controlling the ratio (Ag2O+SnO2+Sb2O3)/CeO2 of the summed content Ag2O+SnO2+Sb2O3 of Ag2O, SnO2 and Sb2O3 to the content of CeO2 to be within a range of 1.0-30.0, can allow the transmittances of the blackened parts of the photosensitive microcrystalline glass and the photosensitive microcrystalline glass product to be lower, while decreasing the dielectric constant of the glass, to increase the hardness and Young's modulus. Thus, preferably (Ag2O+SnO2+Sb2O3)/CeO2 is 1.0-30.0, more preferably (Ag2O+SnO2+Sb2O3)/CeO2 is 3.0-20.0, further preferably (Ag2O+SnO2+Sb2O3)/CeO2 is 5.0-12.5, and even further preferably (Ag2O+SnO2+Sb2O3)/CeO2 is 7.5-10.0. In some embodiments, the value of (Ag2O+SnO2+Sb2O3)/CeO2 may be 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, 20.5, 21.0, 21.5, 22.0, 22.5, 23.0, 23.5, 24.0, 24.5, 25.0, 25.5, 26.0, 26.5, 27.0, 27.5, 28.0, 28.5, 29.0, 29.5, 30.0.

In some embodiments, controlling the ratio (Sb2O3+SnO2+CeO2)/Ag2O of the summed content Sb2O3+SnO2+CeO2 of Sb2O3, SnO2 and CeO2 to the content of Ag2O to be within a range of 0.1-10.0, can decrease the dielectric loss and the expansion coefficient of the glass, and allow the transmittances of the blackened parts of the photosensitive microcrystalline glass and the photosensitive microcrystalline glass product to be lower. Thus, preferably (Sb2O3+SnO2+CeO2)/Ag2O is 0.1-10.0, more preferably (Sb2O3+SnO2+CeO2)/Ag2O is 0.4-5.0, further preferably (Sb2O3+SnO2+CeO2)/Ag2O is 0.7-3.7, and even further preferably (Sb2O3+SnO2+CeO2)/Ag2O is 1.5-3.2. In some embodiments, the value of (Sb2O3+SnO2+CeO2)/Ag2O may be 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.5, 8.0, 8.5, 9.0, 9.5, 10.0.

In some embodiments, when the value of SnO2/(CeO2+SnO2) is larger than 0.9, during the molding or heat treatment of the glass, the transmittance of the transparent part of the glass sharply decreases, even completely devitrification. Thus, preferably SnO2/(CeO2+SnO2) is 0-0.9, more preferably SnO2/(CeO2+SnO2) is 0-0.6, and further preferably SnO2/(CeO2+SnO2) is 0-0.5. In some embodiments, the value of SnO2/(CeO2+SnO2) may be 0, more than 0, 0.01, 0.02, 0.03, 0.04, 0.05, 0.07, 0.1, 0.13, 0.15, 0.17, 0.2, 0.23, 0.25, 0.27, 0.3, 0.33, 0.35, 0.37, 0.4, 0.43, 0.45, 0.47, 0.5, 0.53, 0.55, 0.57, 0.6, 0.63, 0.65, 0.67, 0.7, 0.73, 0.75, 0.77, 0.8, 0.83, 0.85, 0.87, 0.9.

Ln2O3 (Ln2O3 being one or more of La2O3, Gd2O3, and Y2O3) can adjust the dielectric constant and the dielectric loss of the glass, and can provide electrons for Ag+, to promote the photosensitive microcrystalline glass to be blackened. When Ln2O3 is higher than 5%, the transmittances of the blackened parts of the photosensitive microcrystalline glass and the photosensitive microcrystalline glass product increase, and the dielectric constant and the dielectric loss of the glass increase. Thus, the content of Ln2O3 is limited to 0-5%, preferably 0-3%, more preferably 0-1%, in some embodiments, and further preferably free of Ln2O3. In some embodiments, about 0%, more than 0%, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5% of Ln2O3 may be included.

Fe2O3 during UV exposure of the glass can absorb UV lights, and can provide electrons for Ag+, to promote the photosensitive microcrystalline glass to be blackened. When the content of Fe2O3 is higher than 1%, the transparent parts of the photosensitive microcrystalline glass and the photosensitive microcrystalline glass product have decreased transmittances at a visible light wave band range, and the transmittances of the blackened parts increase, and the photosensitive microcrystalline glass and the photosensitive microcrystalline glass product have decreased heights for the falling ball test. Thus, the content of Fe2O3 is limited to 0-1%, preferably 0-0.5%, more preferably 0-0.2%, in some embodiments, and further preferably free of Fe2O3. In some embodiments, about 0%, more than 0%, 0.01%, 0.02%, 0.03%, 0.04%, 0.05%, 0.06%, 0.07%, 0.08%, 0.09%, 0.1%, 0.11%, 0.12%, 0.13%, 0.14%, 0.15%, 0.16%, 0.17%, 0.18%, 0.19%, 0.2%, 0.21%, 0.22%, 0.23%, 0.24%, 0.25%, 0.26%, 0.27%, 0.28%, 0.29%, 0.3%, 0.31%, 0.32%, 0.33%, 0.34%, 0.35%, 0.36%, 0.37%, 0.38%, 0.39%, 0.4%, 0.41%, 0.42%, 0.43%, 0.44%, 0.45%, 0.46%, 0.47%, 0.48%, 0.49%, 0.5%, 0.55%, 0.6%, 0.65%, 0.7%, 0.75%, 0.8%, 0.85%, 0.9%, 0.95%, 1% of Fe2O3 may be included.

“Free of”, and “0%” recorded herein refer to not intentionally adding the compound, molecule or element or the like as a raw material to the present invention photosensitive glass material, the photosensitive microcrystalline glass or the photosensitive microcrystalline glass product; but as a raw material and/or a device for producing the photosensitive glass material, the photosensitive microcrystalline glass or the photosensitive microcrystalline glass product, there may be some impurities or components unintentionally added, and few or trace may be included in the final photosensitive glass material, the photosensitive microcrystalline glass or the photosensitive microcrystalline glass product, and such circumstances are also within the protection scope of the present invention patent.

Various performance indicators of the photosensitive microcrystalline glass and/or the photosensitive microcrystalline glass product and/or the photosensitive glass material of the present invention are determined by adopting the following methods:

### <Light Transmittance>

The light transmittance is determined according the following method: processing a sample to be tested to a certain thickness and parallelly polishing opposite faces, to test according to National Standard “GB/T 7962.12-2010”.

### <Linear Expansion Coefficient>

The linear expansion coefficient (α20° C.-300° C.) is the data determined at 20° C.-300° C. according to National Standard “GB/T7962.16-2010”. The linear expansion coefficient in the present invention sometimes is abbreviated as the expansion coefficient.

### <Dielectric Constant>

The dielectric constant (εr) is the data determined according to National Standard “GB/T 7265.1-1987” under the test condition of 1 GHz.

### <Dielectric Loss>

The dielectric loss (tan δ) is the data determined according to National Standard “GB/T 7265.1-1987” under the test condition of 1 GHz.

### <Height for a Falling Ball Test>

A sample of φ20×1 mm is placed on a glass loading clamp, allowing a steel ball of 32 g to fall from a specified height, and a maximum height for the falling ball test at which the sample is able to bear the impact without breakage is the height for the falling ball test. In particular, the test begins with a falling ball test height of 100 mm, by changing the height of 100 mm, 200 mm, 300 mm, 400 mm, 500 mm, 600 mm, 700 mm, 800 mm, 900 mm, 100 mm, 1,000 mm, 1,100 mm, 1,200 mm and more in turn, without breakage. For an example having “a falling ball test height II”, the photosensitive microcrystalline glass product is a testing subject. In the Examples, the testing data recorded as 1,000 mm, mean that even allowing a steel ball to fall from a height of 1,000 mm, the photosensitive microcrystalline glass product still can bear the impact without breakage. For an example having “a falling ball test height”, the photosensitive glass material is a testing subject. In the present invention, a height for a falling ball test sometimes is abbreviated as a falling ball height.

### <Knoop Hardness>

It is denoted by a value of dividing the load (N) at which when a diamond pyramid indenter with an included angle of 172.5° between the opposite faces is pressed and left a pyramid-shaped indent into a testing surface by the surface area (mm2) calculated from the length of the indent. The test is performed with a test load of 100 (N), and a holding time of 15 (sec). In the present invention, the Knoop hardness is sometimes abbreviated as a hardness.

### <Young's Modulus>

The Young's modulus (E) is determined by testing velocities of a longitudinal wave and a transverse wave with ultrasound, and calculating by the following formula.

$$E = \frac{4 {G}^{2} - 3 GV \text{?} ρ}{G - V \text{?} ρ}$$

$$G = VS 2 ρ$$

$$\text{?} \text{indicates text missing or illegible when filed}$$

In the formula: E is Young's modulus, Pa;
G is a shear modulus, Pa;
VT is a velocity of a transverse wave, m/s;
VS is a velocity of a longitudinal wave, m/s; and
p is a density of the glass, g/cm3.

### <Refractive Index>

The refractive index (nd) is determined according to the method specified in “GB/T7962.1-2010”.

The photosensitive glass material of the present invention has the following performance:

1) In some embodiments, the photosensitive glass material of the present invention has a refractive index (nd) of 1.51-1.55, preferably 1.52-1.54, more preferably 1.53-1.535, and further preferably 1.53112-1.53284.

2) In some embodiments, the photosensitive glass material of the present invention has a Young's modulus (E) of 7,000×107 Pa-9,500×107 Pa, preferably 7,500×107 Pa-9,200×107 Pa, more preferably 7,836×107 Pa-9,014×107 Pa, and further preferably 8,005×107 Pa-8,488×107 Pa.

3) In some embodiments, the photosensitive glass material of the present invention has a Knoop hardness (Hk0.1) above 450 kgf/mm2, preferably 470-600 kgf/mm2, more preferably 480-582 kgf/mm2, and further preferably 492-532 kgf/mm2.

4) In some embodiments, the photosensitive glass material of the present invention has a height I for a falling ball test above 200 mm, preferably above 300 mm, and more preferably above 400 mm.

5) In some embodiments, the photosensitive glass material of the present invention has a dielectric loss (tan δ) below 11.0×10−3, preferably 7.0×10−3-10.5×10−3, more preferably 7.2×10−3-9.8×10−3, and further preferably 7.4×10−3-9.2×10−3.

6) In some embodiments, the photosensitive glass material of the present invention has a dielectric constant (εr) of 5.5-8.5, preferably 6.0-8.0, more preferably 6.2-7.7, and further preferably 6.3-7.0.

7) In some embodiments, the photosensitive glass material of the present invention has a linear expansion coefficient (α20° C.-300° C.) below 100×10−7/° C., preferably 65×10−7/° C.-100×10−7/° C., more preferably 71×10−7/° C.-95×10−7/° C., and further preferably 75×10−7/° C.-90×10−7/° C.

The photosensitive microcrystalline glass of the present invention has the following performance:

1) In some embodiments, the transparent part of the photosensitive microcrystalline glass with a thickness of 0.2-1.5 mm has an average transmittance (T400-800 nm) above 85.0%, preferably above 88.0%, more preferably above 90.0%, further preferably above 91.0%, and even further preferably 91.5-95.0% at 400-800 nm wave band range. The above thickness is preferably 0.5-1.5 mm, more preferably 0.8-1.2 mm, and further preferably 0.5 mm, 0.7 mm, 0.8 mm, 0.9 mm, 1.0 mm, 1.1 mm, 1.2 mm.

2) In some embodiments, the blackened part of the photosensitive microcrystalline glass with a thickness of 0.2-1.5 mm has an average transmittance (T400-800 nm) below 5.0%, preferably below 3.0%, more preferably below 1.5%, further preferably below 1.2%, and even further preferably below 0.5% at 400-800 nm wave band range. The above thickness is preferably 0.5-1.5 mm, more preferably 0.8-1.2 mm, and further preferably 0.5 mm, 0.7 mm, 0.8 mm, 0.9 mm, 1.0 mm, 1.1 mm, 1.2 mm.

3) In some embodiments, the blackened part of the photosensitive microcrystalline glass with a thickness of 0.2-1.5 mm has a transmittance (T870 nm) below 15.0%, preferably 0.1-12.5%, more preferably 0.1-10%, further preferably 0.1-8.0%, and even further preferably 0.1-5.0% at 870 nm. The above thickness is preferably 0.5-1.5 mm, more preferably 0.8-1.2 mm, and further preferably 0.5 mm, 0.7 mm, 0.8 mm, 0.9 mm, 1.0 mm, 1.1 mm, 1.2 mm.

4) In some embodiments, the blackened part of the photosensitive microcrystalline glass with a thickness of 0.2-1.5 mm has a transmittance (T940 nm) below 50.0%, preferably 0.1-35.0%, more preferably 0.3-20.0%, further preferably 0.3-15.0%, and even further preferably 0.3-10.0% at 940 nm. The above thickness is preferably 0.5-1.5 mm, more preferably 0.8-1.2 mm, and further preferably 0.5 mm, 0.7 mm, 0.8 mm, 0.9 mm, 1.0 mm, 1.1 mm, 1.2 mm.

In some embodiments, the transparent part of the photosensitive microcrystalline glass of the present invention does not form crystals, and thus has the same performance as that of the photosensitive glass material described above, e.g., the Young's modulus (E), the Knoop hardness (Hk0.1), the height for a falling ball test, the dielectric loss (tan δ), the dielectric constant (εr), the linear expansion coefficient (α20° C.-300° C.) etc. In particular, in some embodiments, the transparent part of the photosensitive microcrystalline glass of the present invention has a Young's modulus (E) of 7,000×107 Pa-9,500×107 Pa, preferably 7,500×107 Pa-9,200×107 Pa, more preferably 7,836×107 Pa-9,014×107 Pa, and further preferably 8,005×107 Pa-8,488×107 Pa. In some embodiments, the transparent Part of the photosensitive microcrystalline glass of the present invention has a Knoop hardness (Hk0.1) above 450 kgf/mm2, preferably 470-600 kgf/mm2, more preferably 480-582 kgf/mm2, and further preferably 492-532 kgf/mm2. In some embodiments, the transparent part of the photosensitive microcrystalline glass of the present invention has a height for a falling ball test above 200 mm, preferably above 300 mm, more preferably above 400 mm. In some embodiments, the transparent part of the photosensitive microcrystalline glass of the present invention has a dielectric loss (tan δ) below 11.0×10−3, preferably 7.0×10−3-10.5×10−3, more preferably 7.2×10−3-9.8×10−3, and further preferably 7.4×10−3-9.2×10−3. In some embodiments, the transparent part of the photosensitive microcrystalline glass of the present invention has a dielectric constant (εr) of 5.5-8.5, preferably 6.0-8.0, more preferably 6.2-7.7, and further preferably 6.3-7.0. In some embodiments, the transparent part of the photosensitive microcrystalline glass of the present invention has a linear expansion coefficient (α20° C.-300° C.) below 100×10−7/° C., preferably 65×10−7/° C.-100×10−7/° C., more preferably 71×10−7/° C.-95×10−7/° C., and further preferably 75×10−7/° C.-90×10−7/° C.

The photosensitive microcrystalline glass product of the present invention has the following performance:

1) In some embodiments, the transparent part of the photosensitive microcrystalline glass product with a thickness of 0.2-1.5 mm has an average transmittance (T400-800 nm) above 85.0%, preferably above 88.0%, more preferably above 90.0%, further preferably above 91.0%, and even further preferably 91.5-95.0% at 400-800 nm wave band range. The above thickness is preferably 0.5-1.5 mm, more preferably 0.8-1.2 mm, and further preferably 0.5 mm, 0.7 mm, 0.8 mm, 0.9 mm, 1.0 mm, 1.1 mm, 1.2 mm.

2) In some embodiments, the blackened part of the photosensitive microcrystalline glass product with a thickness of 0.2-1.5 mm has an average transmittance (T400-800 nm) below 5.0%, preferably below 3.0%, more preferably below 1.5%, further preferably below 1.2%, and even further preferably below 0.5% at 400-800 nm wave band range. The above thickness is preferably 0.5-1.5 mm, more preferably 0.8-1.2 mm, and further preferably 0.5 mm, 0.7 mm, 0.8 mm, 0.9 mm, 1.0 mm, 1.1 mm, 1.2 mm.

3) In some embodiments, the blackened part of the photosensitive microcrystalline glass product with a thickness of 0.2-1.5 mm has a transmittance (T870 nm) below 15.0%, preferably 0.1-12.5%, more preferably 0.1-10%, further preferably 0.1-8.0%, and even further preferably 0.1-5.0% at 870 nm. The above thickness is preferably 0.5-1.5 mm, more preferably 0.8-1.2 mm, and further preferably 0.5 mm, 0.7 mm, 0.8 mm, 0.9 mm, 1.0 mm, 1.1 mm, 1.2 mm.

4) In some embodiments, the blackened part of the photosensitive microcrystalline glass product with a thickness of 0.2-1.5 mm has a transmittance (T940 nm) below 50.0%, preferably 0.1-35.0%, more preferably 0.3-20.0%, further preferably 0.3-15.0%, and even further preferably 0.3-10.0% at 940 nm. The above thickness is preferably 0.5-1.5 mm, more preferably 0.8-1.2 mm, and further preferably 0.5 mm, 0.7 mm, 0.8 mm, 0.9 mm, 1.0 mm, 1.1 mm, 1.2 mm.

5) In some embodiments, the photosensitive microcrystalline glass product of the present invention has a height II for a falling ball test above 800 mm, preferably above 900 mm, more preferably above 1,000 mm, and further preferably above 1,100 mm.

In some embodiments, the photosensitive glass material/the photosensitive microcrystalline glass/the photosensitive microcrystalline glass product of the present invention has a lower dielectric constant and dielectric loss, and can reduce the transmission loss of the electric signal.

In some embodiments, the photosensitive glass material/the photosensitive microcrystalline glass/the photosensitive microcrystalline glass product of the present invention has a higher Knoop hardness, Young's modulus and height of a falling ball.

In some embodiments, the photosensitive glass material/the photosensitive microcrystalline glass/the photosensitive microcrystalline glass product of the present invention has a lower linear expansion coefficient, to improve the precision of the light signal channel or mask graph.

In some embodiments, the photosensitive glass material/the photosensitive microcrystalline glass/the photosensitive microcrystalline glass product of the present invention has a lower refractive index, such that the reflectance of the light signal on a surface can be reduced, and the incident rate of the light signal can be increased.

The photosensitive microcrystalline glass, the photosensitive microcrystalline glass product, and the photosensitive glass material of the present invention, due to the above-mentioned excellent performance, can be widely made into a glass cover plate or a glass element; meanwhile, the photosensitive microcrystalline glass, the photosensitive microcrystalline glass product, the photosensitive glass material of the present invention, and the glass cover plate or the glass element made therefrom can be applied to produce various apparatuses or devices, and the apparatuses or devices include but are not limited to electronic devices, medical devices, decorations or crafts, such as cell phones, watches, computers, biomedical testing, etc., and be used to produce the local light shielding glass or cover plate glass with patterns of cell phones, smart phones, tablet PCs, laptops, TVs, etc., or used in the light signal channel glass of smart watches, biomedical devices, etc., or used to produce decorations or craft glass with Patterns.

The photosensitive glass material, the photosensitive microcrystalline glass and the photosensitive microcrystalline glass product of the present invention can be produced and prepared by the following method:

A preparation method of the photosensitive glass material includes the following steps: weighing and evenly mixing raw materials according to the ratios of the components, placing the evenly mixed raw materials into a crucible made of platinum or quartz, melting, clarifying, homogenizing at 1,450-1,600° C. and then cooling down, pouring the molten glass melt into a mold for molding and passing in the circulating cooling air to ensure that the glass does not precipitate crystals, preferably preheating the mold to 200-500° C., placing the molded glass together with the mold into an annealing furnace for insulation annealing, and then cooling with the furnace after power off to obtain the photosensitive glass material.

A preparation method of the photosensitive microcrystalline glass includes the following steps: forming the photosensitive glass material, treating the photosensitive glass material by a crystallization process, or processing the photosensitive glass material to a glass element of a specific shape and then treating by a crystallization process, to obtain the photosensitive microcrystalline glass of the present invention. The method of processing to a glass element of a specific shape of the present invention includes a method known by a person skilled in the art such as hot-pressing, grinding or polishing processing, etc. The crystallization process treatment of the present invention includes treating the photosensitive glass material by mask exposure, followed by a crystallization heat treatment, so that crystals evenly precipitate at the exposed position of the glass. The mask exposure treatment of the present invention refers to UV exposing a specific position or region of the photosensitive glass material, with a UV wavelength preferably at 313 nm, and can customize specialized photomask patterns according to application needs, with an exposure time preferably of 5-60 min. The crystallization heat treatment of the present invention can be performed in 1-stage, and also can be performed in 2-stage, and preferably the crystallization heat treatment is performed in 2-stage. The 2-stage crystallization heat treatment refers to treating by a nucleation process at a first temperature, and then treating by a crystal growth process at a second temperature higher than the temperature of the nucleation process, preferably the first temperature is 490° C.-520° C., preferably treatment time at the first temperature is 1-4 h, preferably the second temperature is 540° C.-620° C., and preferably treatment time at the second temperature is 1-8 h.

A preparation method of the photosensitive microcrystalline glass product includes the following steps: treating the photosensitive microcrystalline glass of the present invention by a chemically strengthening process, or processing the photosensitive microcrystalline glass to a photosensitive microcrystalline glass element of a specific shape and then treating by a chemically strengthening process, to obtain the photosensitive microcrystalline glass product of the present invention. The method of processing to a specific shape of the present invention includes a method known by a person skilled in the art such as hot-pressing, grinding or polishing processing, etc.

The chemically strengthening of the present invention is an ion exchange method. During the ion exchange, the smaller metal ions in the photosensitive microcrystalline glass are replaced or “exchanged” by the larger metal ions having the same valence state near the photosensitive microcrystalline glass. By replacing the smaller ions with the larger ions, a compressive stress is built up in the photosensitive microcrystalline glass to form a compressive stress layer.

In some embodiments, the metal ions are monovalent alkaline metal ions (e.g., Na+, K+, Rb+, Cs+, etc.), the ion exchange is performed by immersing the photosensitive microcrystalline glass in a salt bath including at least one melt salts of larger metal ions, and the larger metal ions are used to replace the smaller metal ions in the photosensitive microcrystalline glass. Alternatively, other monovalent metal ions, e.g., Ag+, Tl+, Cu+, etc., also may be used to exchange monovalent ions. One or more ion exchange processes used to chemically strengthen the photosensitive microcrystalline glass may include but are not limited to: immersing it in a single salt bath, or immersing it in multiple salt baths having the same or different composition, and a washing and/or an annealing step may be added between the immersion.

In some embodiments, the photosensitive microcrystalline glass may be ion-exchanged by immersing in a salt bath of melt Na salts (e.g., NaNO3), and/or K salts (e.g., KNO3), and/or mixed Na salts and K salts at a temperature of about 350° C.-470° C. for 1-36 h, preferably the temperature range being 380° C.-460° C., preferably for a time range of 2-24 h.

In some embodiments, the photosensitive glass material of the present invention may produce reinforced glass by the above chemically strengthening process, and then treating by the above crystallization process to obtain the photosensitive microcrystalline glass product. In some embodiments, the photosensitive glass material of the present invention may be processed to a glass element, and then the glass element produces the reinforced glass by the above chemically strengthening process, followed by the above crystallization process treatment to obtain the photosensitive microcrystalline glass product.

### EXAMPLES

To further clearly explain and illustrate the technical solutions of the present invention, the following non-limiting examples are provided. The examples of the present invention have been through a lot of efforts to ensure the precision of the values (e.g., amounts, etc.), but the presence of some errors and deviations must be considered. The composition itself based on the oxides is given in weight %, and has been normalized to 100%.

### <Examples of the Photosensitive Glass Material>

The Examples applied the above preparation method of the photosensitive glass material to obtain the photosensitive glass material having the composition shown in Tables 1-4. Additionally, the properties of various photosensitive glass materials were determined by the testing methods of the present invention, and the testing results were shown in Tables 1-4.

TABLE 1

| | Examples (wt %) | | | | |
|---|---|---|---|---|---|
| | 1# | 2# | 3# | 4# | 5# |
| SiO₂ | 72.66 | 67.2 | 69.9 | 65 | 77.19 |
| Al₂O₃ | 7.4 | 9.46 | 6.9 | 10 | 3 |
| Li₂O | 10 | 8.7 | 11.6 | 10.5 | 9.9 |
| K₂O | 4.2 | 3.8 | 3.5 | 5.5 | 2.5 |
| Na₂O | 2.2 | 5.6 | 4.9 | 3.6 | 3 |
| ZrO₂ | 2.6 | 4.5 | 2.2 | 4.6 | 3.5 |
| CeO₂ | 0.1 | 0.07 | 10.12 | 0.06 | 0.14 |
| Ag₂O | 0.2 | 0.42 | 0.38 | 0.32 | 0.34 |
| Sb₂O₃ | 0.52 | 0.2 | 0.36 | 10.32 | 0.42 |
| SnO₂ | 0.12 | 0.05 | 0.14 | 0.1 | 0.01 |
| ZnO | 0 | 0 | 0 | 0 | 0 |
| MgO | 0 | 0 | 0 | 0 | 0 |
| CaO | 0 | 0 | 0 | 0 | 0 |
| SrO | 0 | 0 | 0 | 0 | 0 |
| BaO | 0 | 0 | 0 | 0 | 0 |
| La₂O₃ | 0 | 0 | 0 | 0 | 0 |
| Gd₂O₃ | 0 | 0 | 0 | 0 | 0 |
| Y₂O₃ | 0 | 0 | 0 | 0 | 0 |
| Fe₂O₃ | 0 | 0 | 0 | 0 | 0 |
| Total | 100 | 100 | 100 | 100 | 100 |
| R₂O | 6.4 | 9.4 | 8.4 | 9.1 | 5.5 |
| SiO₂/Li₂O | 7.27 | 7.72 | 6.03 | 6.19 | 7.8 |
| Sb₂O₃ + SnO₂ | 0.64 | 0.25 | 0.5 | 0.42 | 0.43 |
| (Sb₂O₃ + | 3.2 | 0.6 | 1.32 | 1.31 | 1.26 |
| SnO₂)/Ag₂O | | | | | |
| Ag₂O/CeO₂ | 2 | 6 | 3.17 | 5.33 | 2.43 |
| Li₂O/ZrO₂ | 3.85 | 1.93 | 5.27 | 2.28 | 2.83 |
| (K₂O + | 2.46 | 2.09 | 3.82 | 1.98 | 1.57 |
| Na₂O)/ZrO₂ | | | | | |
| SiO₂ + | 31.79 | 16.87 | 37.05 | 16.41 | 24.88 |
| Li₂O)/ZrO₂ | | | | | |
| MO/ZrO₂ | 0 | 0 | 0 | 0 | 0 |
| ZrO₂/(Ag₂O + | 8.67 | 9.18 | 4.4 | 12.11 | 7.29 |
| CeO₂) | | | | | |
| (Ag₂O + SnO₂ + | 8.4 | 9.57 | 7.33 | 12.33 | 5.5 |
| Sb₂O₃)/CeO₂ | | | | | |
| (Sb₂O₃ + SnO₂ + | 3.7 | 0.76 | 1.63 | 1.50 | 1.68 |
| CeO₂)/Ag₂O | | | | | |
| SnO₂/(CeO₂ + | 0.55 | 0.42 | 0.54 | 0.63 | 0.07 |
| SnO₂) | | | | | |
| R₂O + Li₂O + | 23.8 | 27.56 | 26.9 | 29.6 | 18.4 |
| A₁₂₀₃ | | | | | |
| SiO₂ + Al₂O₃)/(Li₂O + | 4.88 | 4.24 | 3.84 | 3.83 | 5.21 |
| Na₂O + K₂O) | | | | | |
| εr | 6.9 | 7.3 | 7.2 | 7.5 | 6.3 |
| Tanδ (×10⁻³) | 8.7 | 9.57 | 9.43 | 10.06 | 7.43 |
| HK_{0.1} | 516 | 494 | 479 | 478 | 528 |
| (kgf/mm²) | | | | | |
| E (×10⁷ Pa) | 8,254 | 8,035 | 7,892 | 7,886 | 8,372 |
| α_{20° C.-300° C.} | 83 | 90 | 95 | 95 | 79 |
| (×10⁻⁷/° C.) | | | | | |
| Height I for the | 400 | 400 | 300 | 300 | 400 |
| Falling Ball Test | | | | | |
| (mm) | | | | | |
| n_{d} | 1.53234 | 1.53277 | 1.53238 | 1.53284 | 1.53037 |
| | Examples (wt %) | | | | |
| | 6# | 7# | 8# | 9# | 10# |
| SiO₂ | 74.37 | 75.58 | 70.1 | 69.2 | 71.5 |
| Al₂O₃ | 6.7 | 5.5 | 5.9 | 7.7 | 9 |
| Li₂O | 10.6 | 8.6 | 11.5 | 8.7 | 8.3 |
| K₂O | 2.7 | 4.8 | 4.1 | 5.1 | 2.2 |
| Na₂O | 2.6 | 1.7 | 3.9 | 4.3 | 5 |
| ZrO₂ | 2.5 | 3.1 | 3.2 | 4 | 1.5 |
| CeO₂ | 0.07 | 0.08 | 0.14 | 0.1 | 0.09 |
| Ag₂O | 0.27 | 0.33 | 0.45 | 0.47 | 0.41 |
| Sb₂O₃ | 0.15 | 0.15 | 0.09 | 0.32 | 0.46 |
| SnO₂ | 0.04 | 0.16 | 0.12 | 0.11 | 0.04 |
| ZnO | 0 | 0 | 0 | 0 | 1.5 |
| MgO | 0 | 0 | 0 | 0 | 0 |
| CaO | 0 | 0 | 0 | 0 | 0 |
| SrO | 0 | 0 | 0 | 0 | 0 |
| BaO | 0 | 0 | 0 | 0 | 0 |
| La₂O₃ | 0 | 0 | 0 | 0 | 0 |
| Gd₂O₃ | 0 | 0 | 0 | 0 | 0 |
| Y₂O₃ | 0 | 0 | 0 | 0 | 0 |
| Fe₂O₃ | 0 | 0 | 0.5 | 0 | 0 |
| Total | 100 | 100 | 100 | 100 | 100 |
| R₂O | 5.3 | 16.5 | 8 | 9.4 | 7.2 |
| SiO₂/Li₂O | 7.02 | 8.79 | 6.1 | 7.95 | 8.61 |
| Sb₂O₃ + SnO₂ | 0.19 | 0.31 | 0.21 | 0.43 | 0.5 |
| (Sb₂O₃ + | 0.7 | 0.94 | 0.47 | 0.91 | 1.22 |
| SnO₂)/Ag₂O | | | | | |
| Ag₂O/CeO₂ | 3.86 | 4.13 | 3.21 | 4.7 | 4.56 |
| Li₂O/ZrO₂ | 4.24 | 2.77 | 3.59 | 2.18 | 5.53 |
| (K₂O + | 2.12 | 2.1 | 2.5 | 2.35 | 4.8 |
| Na₂O)/ZrO₂ | | | | | |
| SiO₂ + | 33.99 | 27.15 | 25.50 | 19.48 | 53.2 |
| Li₂O)/ZrO₂ | | | | | |
| MO/ZrO₂ | 0 | 0 | 0 | 0 | 1 |
| ZrO₂/(Ag₂O + | 7.35 | 7.56 | 5.42 | 7.02 | 3 |
| CeO₂) | | | | | |
| (Ag₂O + SnO₂ + | 6.57 | 8 | 4.71 | 9 | 10.11 |
| Sb₂O₃)/CeO₂ | | | | | |
| (Sb₂O₃ + SnO₂ + | 0.96 | 1.18 | 0.78 | 1.13 | 1.44 |
| CeO₂)/Ag₂O | | | | | |
| SnO₂/(CeO₂ + | 0.36 | 0.67 | 0.46 | 0.52 | 10.31 |
| SnO₂) | | | | | |
| R₂O + Li₂O + | 22.6 | 20.6 | 25.4 | 25.8 | 24.5 |
| A₁₂₀₃ | | | | | |
| SiO₂ + Al₂O₃)/(Li₂O + | 5.1 | 5.37 | 3.9 | 4.25 | 5.19 |
| Na₂O + K₂O) | | | | | |
| εr | 6.8 | 6.6 | 7.1 | 7.1 | 7.2 |
| Tanδ (×10⁻³) | 8.43 | 7.96 | 9.13 | 9.17 | 9.33 |
| HK_{0.1} | 523 | 532 | 479 | 493 | 506 |
| (kgf/mm²) | | | | | |
| E (×10⁷ Pa) | 8,324 | 8,413 | 7,897 | 8,032 | 8,157 |
| α_{20° C.-300° C.} | 81 | 78 | 95 | 90 | 86 |
| (×10⁻⁷/° C.) | | | | | |
| Height I for the | 400 | 400 | 400 | 300 | 400 |
| Falling Ball Test | | | | | |
| (mm) | | | | | |
| n_{d} | 1.53225 | 1.53190 | 1.53216 | 1.53252 | 1.53265 |

TABLE 2

| | Examples (wt %) | | | | |
|---|---|---|---|---|---|
| | 11# | 12# | 13# | 14# | 15# |
| SiO₂ | 73.78 | 72.36 | 76.2 | 74.27 | 69.2 |
| Al₂O₃ | 6.9 | 5.3 | 3.8 | 4.9 | 5.5 |
| Li₂O | 7.5 | 8.3 | 9.2 | 9.6 | 10.4 |
| K₂O | 1.1 | 3.4 | 2.4 | 3 | 3.8 |
| Na₂O | 3.4 | 3.7 | 2 | 2.5 | 4.4 |
| ZrO₂ | 6.6 | 6.1 | 5.6 | 4.5 | 6.2 |
| CeO₂ | 0.07 | 0.13 | 0.13 | 0.1 | 0.09 |
| Ag₂O | 0.42 | 0.44 | 0.3 | 0.46 | 0.24 |
| Sb₂O₃ | 0.07 | 0.1 | 0.22 | 0.55 | 0.07 |
| SnO₂ | 0.16 | 0.17 | 0.15 | 0.12 | 0.1 |
| ZnO | 0 | 0 | 0 | 0 | 0 |
| MgO | 0 | 0 | 0 | 0 | 0 |
| CaO | 0 | 0 | 0 | 0 | 0 |
| SrO | 0 | 0 | 0 | 0 | 0 |
| BaO | 0 | 0 | 0 | 0 | 0 |
| La₂O₃ | 0 | 0 | 0 | 0 | 0 |
| Gd₂O₃ | 0 | 0 | 0 | 0 | 0 |
| Y₂O₃ | 0 | 0 | 0 | 0 | 0 |
| Fe₂O₃ | 0 | 0 | 0 | 0 | 0 |
| Total | 100 | 100 | 100 | 100 | 100 |
| R₂O | 4.5 | 7.1 | 4.4 | 5.5 | 8.2 |
| SiO₂/Li₂O | 9.84 | 8.72 | 8.28 | 7.74 | 6.65 |
| Sb₂O₃ + SnO₂ | 0.23 | 0.27 | 0.37 | 0.67 | 0.17 |
| (Sb₂O₃ + | 0.55 | 0.61 | 1.23 | 1.46 | 0.71 |
| SnO₂)/Ag₂O | | | | | |
| Ag₂O/CeO₂ | 6 | 3.38 | 2.31 | 4.6 | 2.67 |
| Li₂O/ZrO₂ | 1.14 | 1.36 | 1.64 | 2.13 | 1.68 |
| (K₂O + | 0.68 | 1.16 | 0.79 | 1.22 | 1.32 |
| Na₂O)/ZrO₂ | | | | | |
| (SiO₂ + | 12.32 | 13.22 | 15.25 | 18.64 | 12.84 |
| Li₂O)/ZrO₂ | | | | | |
| MO/ZrO₂ | 0 | 0 | 0 | 0 | 0 |
| ZrO₂/(Ag₂O + | 13.47 | 10.7 | 13.02 | 8.04 | 18.79 |
| CeO₂) | | | | | |
| (Ag₂O + SnO₂ + | 9.29 | 5.46 | 5.15 | 11.3 | 4.56 |
| Sb₂O₃)/CeO₂ | | | | | |
| (Sb₂O₃ + SnO₂ + | 0.71 | 0.91 | 1.67 | 1.67 | 1.08 |
| CeO₂)/Ag₂O | | | | | |
| SnO₂/(CeO₂ + | 0.7 | 0.57 | 0.54 | 0.55 | 0.53 |
| SnO₂) | | | | | |
| R₂O + Li₂O + | 18.9 | 20.7 | 17.4 | 20 | 24.1 |
| Al₂O₃ | | | | | |
| (SiO₂ + Al₂O₃)/ | 6.72 | 5.04 | 5.88 | 5.24 | 4.02 |
| (Li₂O + Na₂O + | | | | | |
| K₂O) | | | | | |
| εᵣ | 6.4 | 6.5 | 6.2 | 6.5 | 6.9 |
| Tanδ (×10⁻³) | 7.56 | 7.94 | 7.2 | 7.78 | 8.78 |
| HK_{0.1} (kgf/mm²) | 582 | 523 | 553 | 531 | 485 |
| E (×10⁷ Pa) | 8,892 | 8,322 | 8,611 | 8,396 | 7,951 |
| α_{20° C.-300° C.} (×10⁻⁷/° C.) | 66 | 81 | 71 | 78 | 93 |
| Height I for | 400 | 400 | 400 | 400 | 300 |
| the Falling | | | | | |
| Ball Test (mm) | | | | | |
| n_{d} | 1.53230 | 1.53191 | 1.53112 | 1.53173 | 1.53207 |
| | Examples (wt %) | | | | |
| | 16# | 17# | 18# | 19# | 20# |
| SiO₂ | 72.56 | 70.4 | 72.7 | 76.3 | 75.4 |
| Al₂O₃ | 4.9 | 7 | 7.8 | 5.4 | 6.4 |
| Li₂O | 7.3 | 11.9 | 10 | 10.5 | 8 |
| K₂O | 3.3 | 4 | 3.3 | 1.4 | 2.3 |
| Na₂O | 4.1 | 1.5 | 1.3 | 1.5 | 2.2 |
| ZrO₂ | 5.3 | 4.7 | 4.1 | 3.9 | 5.2 |
| CeO₂ | 0.1 | 0.12 | 0.11 | 0.13 | 0.11 |
| Ag₂O | 0.37 | 0.23 | 0.22 | 0.32 | 0.23 |
| Sb₂O₃ | 0.06 | 0.08 | 0.45 | 0.51 | 0.11 |
| SnO₂ | 0.01 | 0.07 | 0.02 | 0.04 | 0.05 |
| ZnO | 0 | 0 | 0 | 0 | 0 |
| MgO | 0 | 0 | 0 | 0 | 0 |
| CaO | 0 | 0 | 0 | 0 | 0 |
| SrO | 0 | 0 | 0 | 0 | 0 |
| BaO | 0 | 0 | 0 | 0 | 0 |
| La₂O₃ | 2 | 0 | 0 | 0 | 0 |
| Gd₂O₃ | 0 | 0 | 0 | 0 | 0 |
| Y₂O₃ | 0 | 0 | 0 | 0 | 0 |
| Fe₂O₃ | 0 | 0 | 0 | 0 | 0 |
| Total | 100 | 100 | 100 | 100 | 100 |
| R₂O | 7.4 | 5.5 | 4.6 | 2.9 | 4.5 |
| SiO₂/Li₂O | 9.94 | 5.92 | 7.27 | 7.27 | 9.43 |
| Sb₂O₃ + SnO₂ | 0.07 | 0.15 | 0.47 | 0.55 | 0.16 |
| (Sb₂O₃ + | 0.19 | 0.65 | 2.14 | 1.72 | 0.7 |
| SnO₂)/Ag₂O | | | | | |
| Ag₂O/CeO₂ | 3.7 | 1.92 | 2 | 2.46 | 2.09 |
| Li₂O/ZrO₂ | 1.38 | 2.53 | 2.44 | 2.69 | 1.54 |
| (K₂O + | 1.4 | 1.17 | 1.12 | 0.74 | 0.87 |
| Na₂O)/ZrO₂ | | | | | |
| (SiO₂ + | 15.07 | 17.51 | 20.17 | 22.26 | 16.04 |
| Li₂O)/ZrO₂ | | | | | |
| MO/ZrO₂ | 0 | 0 | 0 | 0 | 0 |
| ZrO₂/(Ag₂O + | 11.28 | 13.43 | 12.42 | 8.67 | 15.29 |
| CeO₂) | | | | | |
| (Ag₂O + SnO₂ + | 4.4 | 3.17 | 6.27 | 6.69 | 3.55 |
| Sb₂O₃)/CeO₂ | | | | | |
| (Sb₂O₃ + SnO₂ + | 0.46 | 1.17 | 2.64 | 2.13 | 1.17 |
| CeO₂)/Ag₂O | | | | | |
| SnO₂/(CeO₂ + | 0.09 | 0.37 | 0.15 | 0.24 | 0.31 |
| SnO₂) | | | | | |
| R₂O + Li₂O + | 19.6 | 24.4 | 22.4 | 18.8 | 18.9 |
| Al₂O₃ | | | | | |
| (SiO₂ + Al₂O₃)/ | 5.27 | 4.45 | 5.51 | 6.1 | 6.54 |
| (Li₂O + Na₂O + | | | | | |
| K₂O) | | | | | |
| εᵣ | 6.7 | 7.0 | 6.7 | 6.4 | 6.4 |
| Tanδ (×10⁻³) | 8.19 | 8.86 | 8.36 | 7.53 | 7.55 |
| HK_{0.1} (kgf/mm²) | 507 | 500 | 540 | 559 | 577 |
| E (×10⁷ Pa) | 8,166 | 8,094 | 8,488 | 8,677 | 8,846 |
| α_{20° C.-300° C.} (×10⁻⁷/° C.) | 86 | 88 | 75 | 69 | 63 |
| Height I for | 400 | 400 | 400 | 400 | 400 |
| the Falling | | | | | |
| Ball Test (mm) | | | | | |
| n_{d} | 1.53176 | 1.53239 | 1.53248 | 1.53186 | 1.53216 |

TABLE 3

| | Examples (wt %) | | | | |
|---|---|---|---|---|---|
| | 21# | 22# | 23# | 24# | 25# |
| SiO₂ | 72.76 | 72 | 72.5 | 69.8 | 69.4 |
| Al₂O₃ | 5.7 | 6 | 6.1 | 6.5 | 8.4 |
| Li₂O | 9.2 | 10.2 | 9.8 | 10 | 12 |
| K₂O | 4.3 | 3 | 3.1 | 5.2 | 2.1 |
| Na₂O | 1.9 | 2.5 | 2.8 | 5.4 | 3.3 |
| ZrO₂ | 5.5 | 5.5 | 4.8 | 2.4 | 3.7 |
| CeO₂ | 0.1 | 0.1 | 0.15 | 0.14 | 0.09 |
| Ag₂O | 0.29 | 0.33 | 0.22 | 0.21 | 0.5 |
| Sb₂O₃ | 0.07 | 0.23 | 0.42 | 0.3 | 0.43 |
| SnO₂ | 0.18 | 0.14 | 0.11 | 0.05 | 0.08 |
| ZnO | 0 | 0 | 0 | 0 | 0 |
| MgO | 0 | 0 | 0 | 0 | 0 |
| CaO | 0 | 0 | 0 | 0 | 0 |
| SrO | 0 | 0 | 0 | 0 | 0 |
| BaO | 0 | 0 | 0 | 0 | 0 |
| La₂O₃ | 0 | 0 | 0 | 0 | 0 |
| Gd₂O₃ | 0 | 0 | 0 | 0 | 0 |
| Y₂O₃ | 0 | 0 | 0 | 0 | 0 |
| Fe₂O₃ | 0 | 0 | 0 | 0 | 0 |
| Total | 100 | 100 | 100 | 100 | 100 |
| R₂O | 6.2 | 5.5 | 5.9 | 10.6 | 5.4 |
| SiO₂/Li₂O | 7.91 | 7.06 | 7.40 | 6.98 | 5.78 |
| Sb₂O₃ + SnO₂ | 0.25 | 0.37 | 0.53 | 0.35 | 0.51 |
| (Sb₂O₃ + | 0.86 | 1.12 | 2.41 | 1.67 | 1.02 |
| SnO₂)/Ag₂O | | | | | |
| Ag₂O/CeO₂ | 2.9 | 3.3 | 1.47 | 1.5 | 5.56 |
| Li₂O/ZrO₂ | 1.67 | 1.85 | 2.04 | 4.17 | 3.24 |
| (K₂O + | 1.13 | 1 | 1.23 | 4.42 | 1.46 |
| Na₂O)/ZrO₂ | | | | | |
| (SiO₂ + | 14.9 | 14.95 | 17.15 | 33.25 | 22 |
| Li₂O)/ZrO₂ | | | | | |
| MO/ZrO₂ | 0 | 0 | 0 | 0 | 0 |
| ZrO₂/(Ag₂O + | 14.1 | 12.79 | 12.97 | 6.86 | 6.27 |
| CeO₂) | | | | | |
| (Ag₂O + SnO₂ + | 5.4 | 7 | 5 | 4 | 11.22 |
| Sb₂O₃)/CeO₂ | | | | | |
| (Sb₂O₃ + SnO₂ + | 1.21 | 1.42 | 3.09 | 2.33 | 1.2 |
| CeO₂)/Ag₂O | | | | | |
| SnO₂/(CeO₂ + | 0.64 | 0.58 | 0.42 | 0.26 | 0.47 |
| SnO₂) | | | | | |
| R₂O + Li₂O + | 21.1 | 21.7 | 21.8 | 27.1 | 25.8 |
| Al₂O₃ | | | | | |
| (SiO₂ + Al₂O₃)/ | 5.09 | 4.97 | 5.01 | 3.7 | 4.47 |
| (Li₂O + Na₂O + | | | | | |
| K₂O) | | | | | |
| εᵣ | 6.6 | 6.7 | 6.7 | 7.3 | 7.1 |
| Tanδ (×10⁻³) | 8.07 | 8.24 | 8.26 | 9.5 | 9.17 |
| HK_{0.1} (kgf/mm²) | 523 | 519 | 520 | 473 | 501 |
| E (×10⁷ Pa) | 8,326 | 8,284 | 8,289 | 7,836 | 8,109 |
| α_{20° C.-300° C.} (×10⁻⁷/° C.) | 81 | 82 | 82 | 97 | 88 |
| Height I for | 400 | 400 | 400 | 300 | 300 |
| the Falling | | | | | |
| Ball Test (mm) | | | | | |
| n_{d} | 1.53203 | 1.53216 | 1.53216 | 1.53231 | 1.53261 |
| | Examples (wt %) | | | | |
| | 26# | 27# | 28# | 29# | 30# |
| SiO₂ | 73.5 | 71 | 71.5 | 67.5 | 78 |
| Al₂O₃ | 7.6 | 7.9 | 9.5 | 6 | 3 |
| Li₂O | 9.2 | 11.2 | 9.8 | 11.6 | 11.8 |
| K₂O | 2.5 | 3.7 | 1.8 | 3.7 | 3 |
| Na₂O | 1.7 | 4 | 3.7 | 4.1 | 1 |
| ZrO₂ | 4.6 | 1.6 | 2.9 | 6.5 | 2.1 |
| CeO₂ | 0.1 | 0.07 | 0.11 | 0.12 | 0.14 |
| Ag₂O | 0.31 | 0.3 | 0.4 | 0.32 | 0.4 |
| Sb₂O₃ | 0.29 | 0.22 | 0.21 | 0.14 | 0.46 |
| SnO₂ | 0.2 | 0.01 | 0.08 | 0.02 | 0.1 |
| ZnO | 0 | 0 | 0 | 0 | 0 |
| MgO | 0 | 0 | 0 | 0 | 0 |
| CaO | 0 | 0 | 0 | 0 | 0 |
| SrO | 0 | 0 | 0 | 0 | 0 |
| BaO | 0 | 0 | 0 | 0 | 0 |
| La₂O₃ | 0 | 0 | 0 | 0 | 0 |
| Gd₂O₃ | 0 | 0 | 0 | 0 | 0 |
| Y₂O₃ | 0 | 0 | 0 | 0 | 0 |
| Fe₂O₃ | 0 | 0 | 0 | 0 | 0 |
| Total | 100 | 100 | 100 | 100 | 100 |
| R₂O | 4.2 | 7.7 | 5.5 | 7.8 | 4 |
| SiO₂/Li₂O | 7.99 | 6.34 | 7.30 | 5.82 | 6.61 |
| Sb₂O₃ + SnO₂ | 0.49 | 0.23 | 0.29 | 0.16 | 0.56 |
| (Sb₂O₃ + | 1.58 | 0.77 | 0.73 | 0.5 | 1.4 |
| SnO₂)/Ag₂O | | | | | |
| Ag₂O/CeO₂ | 3.1 | 4.29 | 3.64 | 2.67 | 2.86 |
| Li₂O/ZrO₂ | 2 | 7 | 3.38 | 1.78 | 5.62 |
| (K₂O + | 0.91 | 4.81 | 1.9 | 1.2 | 1.9 |
| Na₂O)/ZrO₂ | | | | | |
| (SiO₂ + | 17.98 | 51.38 | 28.03 | 12.17 | 42.76 |
| Li₂O)/ZrO₂ | | | | | |
| MO/ZrO₂ | 0 | 0 | 0 | 0 | 0 |
| ZrO₂/(Ag₂O + | 11.22 | 4.32 | 5.69 | 14.77 | 3.89 |
| CeO₂) | | | | | |
| (Ag₂O + SnO₂ + | 8 | 7.57 | 6.27 | 4 | 6.86 |
| Sb₂O₃)/CeO₂ | | | | | |
| (Sb₂O₃ + SnO₂ + | 1.9 | 1 | 1 | 0.88 | 1.75 |
| CeO₂)/Ag₂O | | | | | |
| SnO₂/(CeO₂ + | 0.67 | 0.13 | 0.42 | 0.14 | 0.42 |
| SnO₂) | | | | | |
| R₂O + Li₂O + | 21 | 26.8 | 24.8 | 25.4 | 18.8 |
| Al₂O₃ | | | | | |
| (SiO₂ + Al₂O₃)/ | 6.05 | 4.17 | 5.29 | 3.79 | 5.13 |
| (Li₂O + Na₂O + | | | | | |
| K₂O) | | | | | |
| εᵣ | 6.6 | 7.2 | 7.0 | 7.1 | 6.4 |
| Tanδ (×10⁻³) | 8.06 | 9.41 | 8.94 | 9.08 | 7.54 |
| HK_{0.1} (kgf/mm²) | 558 | 490 | 531 | 477 | 524 |
| E (×10⁷ Pa) | 8,660 | 8,005 | 8,396 | 7,871 | 8,334 |
| α_{20° C.-300° C.} (×10⁻⁷/° C.) | 69 | 91 | 78 | 96 | 80 |
| Height I for | 400 | 400 | 400 | 300 | 400 |
| the Falling | | | | | |
| Ball Test (mm) | | | | | |
| n_{d} | 1.53244 | 1.53252 | 1.53271 | 1.53223 | 1.53034 |

TABLE 4

| | Examples (wt %) | | | | |
|---|---|---|---|---|---|
| | 31# | 32# | 33# | 34# | 35# |
| SiO₂ | 71.1 | 70.9 | 73.5 | 72.3 | 74.2 |
| Al₂O₃ | 8.9 | 8.4 | 3.5 | 7.6 | 5.9 |
| Li₂O | 8.5 | 10.2 | 11 | 9.6 | 9.8 |
| K₂O | 1.8 | 3.2 | 3.8 | 2.3 | 3.2 |
| Na₂O | 5.5 | 1.9 | 3.2 | 1.1 | 2.9 |
| ZrO₂ | 2 | 4.8 | 4.3 | 2 | 3.4 |
| CeO₂ | 0.15 | 0.12 | 0.09 | 0.15 | 0.09 |
| Ag₂O | 0.36 | 0.24 | 0.23 | 0.34 | 0.29 |
| Sb₂O₃ | 0.5 | 0.21 | 0.31 | 0.43 | 0.15 |
| SnO₂ | 0.09 | 0.03 | 0.07 | 0.18 | 0.07 |
| ZnO | 1.1 | 0 | 0 | 4 | 0 |
| MgO | 0 | 0 | 0 | 0 | 0 |
| CaO | 0 | 0 | 0 | 0 | 0 |
| SrO | 0 | 0 | 0 | 0 | 0 |
| BaO | 0 | 0 | 0 | 0 | 0 |
| La₂O₃ | 0 | 0 | 0 | 0 | 0 |
| Gd₂O₃ | 0 | 0 | 0 | 0 | 0 |
| Y₂O₃ | 0 | 0 | 0 | 0 | 0 |
| Fe₂O₃ | 0 | 0 | 0 | 0 | 0 |
| Total | 100 | 100 | 100 | 100 | 100 |
| R₂O | 7.3 | 5.1 | 7 | 3.4 | 6.1 |
| SiO₂/Li₂O | 8.36 | 6.95 | 6.68 | 7.53 | 7.57 |
| Sb₂O₃ + SnO₂ | 0.59 | 0.24 | 0.38 | 0.61 | 0.22 |
| (Sb₂O₃ + | 1.64 | 1 | 1.65 | 1.79 | 0.76 |
| SnO₂)/Ag₂O | | | | | |
| Ag₂O/CeO₂ | 2.4 | 2 | 2.56 | 2.27 | 3.22 |
| Li₂O/ZrO₂ | 4.25 | 2.13 | 2.56 | 4.8 | 2.88 |
| (K₂O + | 3.65 | 1.06 | 1.63 | 1.7 | 1.79 |
| Na₂O)/ZrO₂ | | | | | |
| (SiO₂ + | 39.8 | 16.9 | 19.65 | 40.95 | 24.71 |
| Li₂O)/ZrO₂ | | | | | |
| MO/ZrO₂ | 0.55 | 0 | 0 | 2 | 0 |
| ZrO₂/(Ag₂O + | 3.92 | 13.33 | 13.44 | 4.08 | 8.95 |
| CeO₂) | | | | | |
| (Ag₂O + SnO₂ + | 6.33 | 4 | 6.78 | 6.33 | 5.67 |
| Sb₂O₃)/CeO₂ | | | | | |
| (Sb₂O₃ + SnO₂ + | 2.06 | 1.5 | 2.04 | 2.24 | 1.07 |
| CeO₂)/Ag₂O | | | | | |
| SnO₂/(CeO₂ + | 0.38 | 0.2 | 0.44 | 0.55 | 0.44 |
| SnO₂) | | | | | |
| R₂O + Li₂O + | 24.7 | 23.7 | 21.5 | 20.6 | 21.8 |
| Al₂O₃ | | | | | |
| (SiO₂ + Al₂O₃)/ | 5.06 | 5.18 | 4.28 | 6.15 | 5.04 |
| (Li₂O + Na₂O + | | | | | |
| K₂O) | | | | | |
| εᵣ | 7.2 | 6.9 | 6.7 | 6.7 | 6.7 |
| Tanδ (×10⁻³) | 9.39 | 8.7 | 8.18 | 8.19 | 8.25 |
| HK_{0.1} (kgf/mm²) | 502 | 526 | 494 | 555 | 521 |
| E (×10⁷ Pa) | 8,118 | 8,348 | 8,038 | 8,629 | 8,299 |
| α_{20° C.-300° C.} (×10⁻⁷/° C.) | 88 | 80 | 90 | 70 | 81 |
| Height I for | 400 | 400 | 400 | 400 | 400 |
| the Falling | | | | | |
| Ball Test (mm) | | | | | |
| n_{d} | 1.53265 | 1.53259 | 1.53098 | 1.53238 | 1.53207 |
| | Examples (wt %) | | | | |
| | 36# | 37# | 38# | 39# | 40# |
| SiO₂ | 72.5 | 72.1 | 72.9 | 70.1 | 70.5 |
| Al₂O₃ | 6 | 6 | 4.8 | 9.7 | 8 |
| Li₂O | 10.4 | 10.7 | 10.8 | 7.4 | 11.6 |
| K₂O | 3.4 | 4.5 | 3.7 | 4.6 | 1.1 |
| Na₂O | 2.1 | 2.8 | 3.9 | 1.3 | 2.5 |
| ZrO₂ | 5.1 | 3 | 3.4 | 6.1 | 5.4 |
| CeO₂ | 0.1 | 0.11 | 0.1 | 0.13 | 0.13 |
| Ag₂O | 0.22 | 0.3 | 0.25 | 0.24 | 0.3 |
| Sb₂O₃ | 0.08 | 0.39 | 0.14 | 0.35 | 0.44 |
| SnO₂ | 0.1 | 0.1 | 0.01 | 0.08 | 0.03 |
| ZnO | 0 | 0 | 0 | 0 | 0 |
| MgO | 0 | 0 | 0 | 0 | 0 |
| CaO | 0 | 0 | 0 | 0 | 0 |
| SrO | 0 | 0 | 0 | 0 | 0 |
| BaO | 0 | 0 | 0 | 0 | 0 |
| La₂O₃ | 0 | 0 | 0 | 0 | 0 |
| Gd₂O₃ | 0 | 0 | 0 | 0 | 0 |
| Y₂O₃ | 0 | 0 | 0 | 0 | 0 |
| Fe₂O₃ | 0 | 0 | 0 | 0 | 0 |
| Total | 100 | 100 | 100 | 100 | 100 |
| R₂O | 5.5 | 7.3 | 7.6 | 5.9 | 3.6 |
| SiO₂/Li₂O | 6.97 | 6.74 | 6.75 | 9.47 | 6.08 |
| Sb₂O₃ + SnO₂ | 0.18 | 0.49 | 0.15 | 0.43 | 0.47 |
| (Sb₂O₃ + | 0.82 | 1.63 | 0.60 | 1.79 | 1.57 |
| SnO₂)/Ag₂O | | | | | |
| Ag₂O/CeO₂ | 2.2 | 2.73 | 2.5 | 1.85 | 2.31 |
| Li₂O/ZrO₂ | 2.04 | 3.57 | 3.18 | 1.21 | 2.15 |
| (K₂O + | 1.08 | 2.43 | 2.24 | 0.97 | 0.67 |
| Na₂O)/ZrO₂ | | | | | |
| (SiO₂ + | 16.25 | 27.6 | 24.62 | 12.7 | 15.2 |
| Li₂O)/ZrO₂ | | | | | |
| MO/ZrO₂ | 0 | 0 | 0 | 0 | 0 |
| ZrO₂/(Ag₂O + | 15.94 | 7.32 | 9.71 | 16.49 | 12.56 |
| CeO₂) | | | | | |
| (Ag₂O + SnO₂ + | 4 | 7.18 | 4 | 5.15 | 5.92 |
| Sb₂O₃)/CeO₂ | | | | | |
| (Sb₂O₃ + SnO₂ + | 1.27 | 2 | 1 | 2.33 | 2 |
| CeO₂)/Ag₂O | | | | | |
| SnO₂/(CeO₂ + | 0.5 | 0.48 | 0.09 | 0.38 | 0.19 |
| SnO₂) | | | | | |
| R₂O + Li₂O + | 21.9 | 24 | 23.2 | 23 | 23.2 |
| Al₂O₃ | | | | | |
| (SiO₂ + Al₂O₃)/ | 4.94 | 4.34 | 4.22 | 6 | 5.16 |
| (Li₂O + Na₂O + | | | | | |
| K₂O) | | | | | |
| εᵣ | 6.7 | 6.9 | 6.8 | 6.8 | 6.8 |
| Tanδ (×10⁻³) | 8.28 | 8.76 | 8.56 | 8.53 | 8.56 |
| HK_{0.1} (kgf/mm²) | 517 | 496 | 492 | 554 | 526 |
| E (×10⁷ Pa) | 8,264 | 8,060 | 8,021 | 8,624 | 8,351 |
| α_{20° C.-300° C.} (×10⁻⁷/° C.) | 83 | 90 | 91 | 71 | 80 |
| Height I for | 400 | 400 | 400 | 400 | 400 |
| the Falling | | | | | |
| Ball Test (mm) | | | | | |
| n_{d} | 1.53212 | 1.53213 | 1.53172 | 1.53274 | 1.53254 |

### <Examples of the Photosensitive Microcrystalline Glass>

The Examples applied the above preparation method of the photosensitive microcrystalline glass to obtain the photosensitive microcrystalline glass having the composition shown in Tables 5-8. Additionally, the properties of various photosensitive microcrystalline glass were determined by the testing methods of the present invention, and the testing results were shown in Tables 5-8, and in the following Examples the transmittances of the photosensitive microcrystalline glass were determined by using samples with a thickness of 1 mm.

TABLE 5

| | Examples (wt %) | | | | | | | | | |
|---|---|---|---|---|---|---|---|---|---|---|
| | 1# | 2# | 3# | 4# | 5# | 6# | 7# | 8# | 9# | 10# |
| SiO₂ | 72.66 | 67.2 | 69.9 | 65 | 77.19 | 74.37 | 75.58 | 70.1 | 69.2 | 71.5 |
| Al₂O₃ | 7.4 | 9.46 | 6.9 | 10 | 3 | 6.7 | 5.5 | 5.9 | 7.7 | 9 |
| Li₂O | 10 | 8.7 | 11.6 | 10.5 | 9.9 | 10.6 | 8.6 | 11.5 | 8.7 | 8.3 |
| K₂O | 4.2 | 3.8 | 3.5 | 5.5 | 2.5 | 2.7 | 4.8 | 4.1 | 5.1 | 2.2 |
| Na₂O | 2.2 | 5.6 | 4.9 | 3.6 | 3 | 2.6 | 1.7 | 3.9 | 4.3 | 5 |
| ZrO₂ | 2.6 | 4.5 | 2.2 | 4.6 | 3.5 | 2.5 | 3.1 | 3.2 | 4 | 1.5 |
| CeO₂ | 0.1 | 0.07 | 0.12 | 0.06 | 0.14 | 0.07 | 0.08 | 0.14 | 0.1 | 0.09 |
| Ag₂O | 0.2 | 0.42 | 0.38 | 0.32 | 0.34 | 0.27 | 0.33 | 0.45 | 0.47 | 0.41 |
| Sb₂O₃ | 0.52 | 0.2 | 0.36 | 0.32 | 0.42 | 0.15 | 0.15 | 0.09 | 0.32 | 0.46 |
| SnO₂ | 0.12 | 0.05 | 0.14 | 0.1 | 0.01 | 0.04 | 0.16 | 0.12 | 0.11 | 0.04 |
| ZnO | 0 | 0 | 0 | 0 | 0 | 0 | 0 | 0 | 0 | 1.5 |
| MgO | 0 | 0 | 0 | 0 | 0 | 0 | 0 | 0 | 0 | 0 |
| CaO | 0 | 0 | 0 | 0 | 0 | 0 | 0 | 0 | 0 | 0 |
| SrO | 0 | 0 | 0 | 0 | 0 | 0 | 0 | 0 | 0 | 0 |
| BaO | 0 | 0 | 0 | 0 | 0 | 0 | 0 | 0 | 0 | 0 |
| La₂O₃ | 0 | 0 | 0 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Fe₂O₃ | 0 | 0 | 0 | 0 | 0 | 0 | 0 | 0.5 | 0 | 0 |
| Total | 100 | 100 | 100 | 100 | 100 | 100 | 100 | 100 | 100 | 100 |
| R₂O | 6.4 | 9.4 | 8.4 | 9.1 | 5.5 | 5.3 | 6.5 | 8 | 9.4 | 7.2 |
| SiO₂/Li₂O | 7.27 | 7.72 | 6.03 | 6.19 | 7.8 | 7.02 | 8.79 | 6.1 | 7.95 | 8.61 |
| Sb₂O₃ + SnO₂ | 0.64 | 0.25 | 0.5 | 0.42 | 0.43 | 0.19 | 0.31 | 0.21 | 0.43 | 0.5 |
| (Sb₂O₃ + | 3.2 | 0.6 | 1.32 | 1.31 | 1.26 | 0.7 | 0.94 | 0.47 | 0.91 | 1.22 |
| SnO₂)/Ag₂O | | | | | | | | | | |
| Ag₂O/CeO₂ | 2 | 6 | 3.17 | 5.33 | 2.43 | 3.86 | 4.13 | 3.21 | 4.7 | 4.56 |
| Li₂O/ZrO₂ | 3.85 | 1.93 | 5.27 | 2.28 | 2.83 | 4.24 | 2.77 | 3.59 | 2.18 | 5.53 |
| (K₂O + | 2.46 | 2.09 | 3.82 | 1.98 | 1.57 | 2.12 | 2.1 | 2.5 | 2.35 | 4.8 |
| Na₂O)/ZrO₂ | | | | | | | | | | |
| (SiO₂ + | 31.79 | 16.87 | 37.05 | 16.41 | 24.88 | 33.99 | 27.15 | 25.50 | 19.48 | 53.2 |
| Li₂O)/ZrO₂ | | | | | | | | | | |
| MO/ZrO₂ | 0 | 0 | 0 | 0 | 0 | 0 | 0 | 0 | 0 | 1 |
| ZrO₂/(Ag₂O + | 8.67 | 9.18 | 4.4 | 12.11 | 7.29 | 7.35 | 7.56 | 5.42 | 7.02 | 3 |
| CeO₂) | | | | | | | | | | |
| (Ag₂O + SnO₂ + | 8.4 | 9.57 | 7.33 | 12.33 | 5.5 | 6.57 | 8 | 4.71 | 9 | 10.11 |
| Sb₂O₃)/CeO₂ | | | | | | | | | | |
| (Sb₂O₃ + SnO₂ + | 3.7 | 0.76 | 1.63 | 1.50 | 1.68 | 0.96 | 1.18 | 0.78 | 1.13 | 1.44 |
| CeO₂)/Ag₂O | | | | | | | | | | |
| SnO₂/(CeO₂ + | 0.55 | 0.42 | 0.54 | 0.63 | 0.07 | 0.36 | 0.67 | 0.46 | 0.52 | 0.31 |
| SnO₂) | | | | | | | | | | |
| R₂O + Li₂O + | 23.8 | 27.56 | 26.9 | 29.6 | 18.4 | 22.6 | 20.6 | 25.4 | 25.8 | 24.5 |
| Al₂O₃ | | | | | | | | | | |
| (SiO₂ + Al₂O₃)/ | 4.88 | 4.24 | 3.84 | 3.83 | 5.21 | 5.1 | 5.37 | 3.9 | 4.25 | 5.19 |
| (Li₂O + Na₂O + | | | | | | | | | | |
| K₂O) | | | | | | | | | | |
| Transparent | 91.8 | 92.0 | 91.6 | 91.8 | 92.0 | 92.0 | 90.7 | 91.6 | 91.8 | 92.0 |
| Part T_{400-800 nm} (%) | | | | | | | | | | |
| Blackened | 0.3 | 21.7 | 3.3 | 2.8 | 4.0 | 17.1 | 10.1 | 2.5 | 11.1 | 4.8 |
| Part T_{940 nm} (%) | | | | | | | | | | |
| Blackened | 0.3 | 7.6 | 1.2 | 1.0 | 1.4 | 6.0 | 3.5 | 0.9 | 3.9 | 1.7 |
| Part T_{870 nm} (%) | | | | | | | | | | |
| Blackened | 0 | 0.7 | 0.3 | 0.3 | 0.3 | 0.6 | 0.5 | 0.3 | 0.5 | 0.3 |
| Part T_{400-800 nm} (%) | | | | | | | | | | |

TABLE 6

| | Examples (wt %) | | | | | | | | | |
|---|---|---|---|---|---|---|---|---|---|---|
| | 11# | 12# | 13# | 14# | 15# | 16# | 17# | 18# | 19# | 20# |
| SiO₂ | 73.78 | 72.36 | 76.2 | 74.27 | 69.2 | 72.56 | 70.4 | 72.7 | 76.3 | 75.4 |
| Al₂O₃ | 6.9 | 5.3 | 3.8 | 4.9 | 5.5 | 4.9 | 7 | 7.8 | 5.4 | 6.4 |
| Li₂O | 7.5 | 8.3 | 9.2 | 9.6 | 10.4 | 7.3 | 11.9 | 10 | 10.5 | 8 |
| K₂O | 1.1 | 3.4 | 2.4 | 3 | 3.8 | 3.3 | 4 | 3.3 | 1.4 | 2.3 |
| Na₂O | 3.4 | 3.7 | 2 | 2.5 | 4.4 | 4.1 | 1.5 | 1.3 | 1.5 | 2.2 |
| ZrO₂ | 6.6 | 6.1 | 5.6 | 4.5 | 6.2 | 5.3 | 4.7 | 4.1 | 3.9 | 5.2 |
| CeO₂ | 0.07 | 0.13 | 0.13 | 0.1 | 0.09 | 0.1 | 0.12 | 0.11 | 0.13 | 0.11 |
| Ag₂O | 0.42 | 0.44 | 0.3 | 0.46 | 0.24 | 0.37 | 0.23 | 0.22 | 0.32 | 0.23 |
| Sb₂O₃ | 0.07 | 0.1 | 0.22 | 0.55 | 0.07 | 0.06 | 0.08 | 0.45 | 0.51 | 0.11 |
| SnO₂ | 0.16 | 0.17 | 0.15 | 0.12 | 0.1 | 0.01 | 0.07 | 0.02 | 0.04 | 0.05 |
| ZnO | 0 | 0 | 0 | 0 | 0 | 0 | 0 | 0 | 0 | 0 |
| MgO | 0 | 0 | 0 | 0 | 0 | 0 | 0 | 0 | 0 | 0 |
| CaO | 0 | 0 | 0 | 0 | 0 | 0 | 0 | 0 | 0 | 0 |
| SrO | 0 | 0 | 0 | 0 | 0 | 0 | 0 | 0 | 0 | 0 |
| BaO | 0 | 0 | 0 | 0 | 0 | 0 | 0 | 0 | 0 | 0 |
| La₂O₃ | 0 | 0 | 0 | 0 | 0 | 2 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Fe₂O₃ | 0 | 0 | 0 | 0 | 0 | 0 | 0 | 0 | 0 | 0 |
| Total | 100 | 100 | 100 | 100 | 100 | 100 | 100 | 100 | 100 | 100 |
| R₂O | 4.5 | 7.1 | 4.4 | 5.5 | 8.2 | 7.4 | 5.5 | 4.6 | 2.9 | 4.5 |
| SiO₂/Li₂O | 9.84 | 8.72 | 8.28 | 7.74 | 6.65 | 9.94 | 5.92 | 7.27 | 7.27 | 9.43 |
| Sb₂O₃ + SnO₂ | 0.23 | 0.27 | 0.37 | 0.67 | 0.17 | 0.07 | 0.15 | 0.47 | 0.55 | 0.16 |
| (Sb₂O₃ + | 0.55 | 0.61 | 1.23 | 1.46 | 0.71 | 0.19 | 0.65 | 2.14 | 1.72 | 0.7 |
| SnO₂)/Ag₂O | | | | | | | | | | |
| Ag₂O/CeO₂ | 6 | 3.38 | 2.31 | 4.6 | 2.67 | 3.7 | 1.92 | 2 | 2.46 | 2.09 |
| Li₂O/ZrO₂ | 1.14 | 1.36 | 1.64 | 2.13 | 1.68 | 1.38 | 2.53 | 2.44 | 2.69 | 1.54 |
| (K₂O + | 0.68 | 1.16 | 0.79 | 1.22 | 1.32 | 1.4 | 1.17 | 1.12 | 0.74 | 0.87 |
| Na₂O)/ZrO₂ | | | | | | | | | | |
| (SiO₂ + | 12.32 | 13.22 | 15.25 | 18.64 | 12.84 | 15.07 | 17.51 | 20.17 | 22.26 | 16.04 |
| Li₂O)/ZrO₂ | | | | | | | | | | |
| MO/ZrO₂ | 0 | 0 | 0 | 0 | 0 | 0 | 0 | 0 | 0 | 0 |
| ZrO₂/(Ag₂O + | 13.47 | 10.7 | 13.02 | 8.04 | 18.79 | 11.28 | 13.43 | 12.42 | 8.67 | 15.29 |
| CeO₂) | | | | | | | | | | |
| (Ag₂O + SnO₂ + | 9.29 | 5.46 | 5.15 | 11.3 | 4.56 | 4.4 | 3.17 | 6.27 | 6.69 | 3.55 |
| Sb₂O₃)/CeO₂ | | | | | | | | | | |
| (Sb₂O₃ + SnO₂ + | 0.71 | 0.91 | 1.67 | 1.67 | 1.08 | 0.46 | 1.17 | 2.64 | 2.13 | 1.17 |
| CeO₂)/Ag₂O | | | | | | | | | | |
| SnO₂/(CeO₂ + | 0.7 | 0.57 | 0.54 | 0.55 | 0.53 | 0.09 | 0.37 | 0.15 | 0.24 | 0.31 |
| SnO₂) | | | | | | | | | | |
| R₂O + Li₂O + | 18.9 | 20.7 | 17.4 | 20 | 24.1 | 19.6 | 24.4 | 22.4 | 18.8 | 18.9 |
| Al₂O₃ | | | | | | | | | | |
| (SiO₂ + Al₂O₃)/ | 6.72 | 5.04 | 5.88 | 5.24 | 4.02 | 5.27 | 4.45 | 5.51 | 6.1 | 6.54 |
| (Li₂O + Na₂O + | | | | | | | | | | |
| K₂O) | | | | | | | | | | |
| Transparent | 90.7 | 90.7 | 91.5 | 90.7 | 91.8 | 92.0 | 92.0 | 92.0 | 92.0 | 92.0 |
| Part T_{400-800 nm} (%) | | | | | | | | | | |
| Blackened | 20.7 | 18.8 | 4.7 | 1.0 | 19.7 | 35.9 | 18.3 | 0.4 | 0.4 | 12.8 |
| Part T_{940 nm} (%) | | | | | | | | | | |
| Blackened | 7.3 | 6.6 | 1.7 | 0.4 | 6.9 | 12.6 | 6.4 | 0.1 | 0.1 | 4.5 |
| Part T_{870 nm} (%) | | | | | | | | | | |
| Blackened | 0.7 | 0.6 | 0.3 | 0.2 | 0.6 | 1.2 | 0.6 | 0 | 0 | 0.2 |
| Part T_{400-800 nm} (%) | | | | | | | | | | |

TABLE 7

| | Examples (wt %) | | | | | | | | | |
|---|---|---|---|---|---|---|---|---|---|---|
| | 21# | 22# | 23# | 24# | 25# | 26# | 27# | 28# | 29# | 30# |
| SiO₂ | 72.76 | 72 | 72.5 | 69.8 | 69.4 | 73.5 | 71 | 71.5 | 67.5 | 78 |
| Al₂O₃ | 5.7 | 6 | 6.1 | 6.5 | 8.4 | 7.6 | 7.9 | 9.5 | 6 | 3 |
| Li₂O | 9.2 | 10.2 | 9.8 | 10 | 12 | 9.2 | 11.2 | 9.8 | 11.6 | 11.8 |
| K₂O | 4.3 | 3 | 3.1 | 5.2 | 2.1 | 2.5 | 3.7 | 1.8 | 3.7 | 3 |
| Na₂O | 1.9 | 2.5 | 2.8 | 5.4 | 3.3 | 1.7 | 4 | 3.7 | 4.1 | 1 |
| ZrO₂ | 5.5 | 5.5 | 4.8 | 2.4 | 3.7 | 4.6 | 1.6 | 2.9 | 6.5 | 2.1 |
| CeO₂ | 0.1 | 0.1 | 0.15 | 0.14 | 0.09 | 0.1 | 0.07 | 0.11 | 0.12 | 0.14 |
| Ag₂O | 0.29 | 0.33 | 0.22 | 0.21 | 0.5 | 0.31 | 0.3 | 0.4 | 0.32 | 0.4 |
| Sb₂O₃ | 0.07 | 0.23 | 0.42 | 0.3 | 0.43 | 0.29 | 0.22 | 0.21 | 0.14 | 0.46 |
| SnO₂ | 0.18 | 0.14 | 0.11 | 0.05 | 0.08 | 0.2 | 0.01 | 0.08 | 0.02 | 0.1 |
| ZnO | 0 | 0 | 0 | 0 | 0 | 0 | 0 | 0 | 0 | 0 |
| MgO | 0 | 0 | 0 | 0 | 0 | 0 | 0 | 0 | 0 | 0 |
| CaO | 0 | 0 | 0 | 0 | 0 | 0 | 0 | 0 | 0 | 0 |
| SrO | 0 | 0 | 0 | 0 | 0 | 0 | 0 | 0 | 0 | 0 |
| BaO | 0 | 0 | 0 | 0 | 0 | 0 | 0 | 0 | 0 | 0 |
| La₂O₃ | 0 | 0 | 0 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Fe₂O₃ | 0 | 0 | 0 | 0 | 0 | 0 | 0 | 0 | 0 | 0 |
| Total | 100 | 100 | 100 | 100 | 100 | 100 | 100 | 100 | 100 | 100 |
| R₂O | 6.2 | 5.5 | 5.9 | 10.6 | 5.4 | 4.2 | 7.7 | 5.5 | 7.8 | 4 |
| SiO₂/Li₂O | 7.91 | 7.06 | 7.40 | 6.98 | 5.78 | 7.99 | 6.34 | 7.30 | 5.82 | 6.61 |
| Sb₂O₃ + SnO₂ | 0.25 | 0.37 | 0.53 | 0.35 | 0.51 | 0.49 | 0.23 | 0.29 | 0.16 | 0.56 |
| (Sb₂O₃ + | 0.86 | 1.12 | 2.41 | 1.67 | 1.02 | 1.58 | 0.77 | 0.73 | 0.5 | 1.4 |
| SnO₂)/Ag₂O | | | | | | | | | | |
| Ag₂O/CeO₂ | 2.9 | 3.3 | 1.47 | 1.5 | 5.56 | 3.1 | 4.29 | 3.64 | 2.67 | 2.86 |
| Li₂O/ZrO₂ | 1.67 | 1.85 | 2.04 | 4.17 | 3.24 | 2 | 7 | 3.38 | 1.78 | 5.62 |
| (K₂O + | 1.13 | 1 | 1.23 | 4.42 | 1.46 | 0.91 | 4.81 | 1.9 | 1.2 | 1.9 |
| Na₂O)/ZrO₂ | | | | | | | | | | |
| (SiO₂ + | 14.9 | 14.95 | 17.15 | 33.25 | 22 | 17.98 | 51.38 | 28.03 | 12.17 | 42.76 |
| Li₂O)/ZrO₂ | | | | | | | | | | |
| MO/ZrO₂ | 0 | 0 | 0 | 0 | 0 | 0 | 0 | 0 | 0 | 0 |
| ZrO₂/(Ag₂O + | 14.1 | 12.79 | 12.97 | 6.86 | 6.27 | 11.22 | 4.32 | 5.69 | 14.77 | 3.89 |
| CeO₂) | | | | | | | | | | |
| (Ag₂O + SnO₂ + | 5.4 | 7 | 5 | 4 | 11.22 | 8 | 7.57 | 6.27 | 4 | 6.86 |
| Sb₂O₃)/CeO₂ | | | | | | | | | | |
| (Sb₂O₃ + SnO₂ + | 1.21 | 1.42 | 3.09 | 2.33 | 1.2 | 1.9 | 1 | 1 | 0.88 | 1.75 |
| CeO₂)/Ag₂O | | | | | | | | | | |
| SnO₂/(CeO₂ + | 0.64 | 0.58 | 0.42 | 0.26 | 0.47 | 0.67 | 0.13 | 0.42 | 0.14 | 0.42 |
| SnO₂) | | | | | | | | | | |
| R₂O + Li₂O + | 21.1 | 21.7 | 21.8 | 27.1 | 25.8 | 21 | 26.8 | 24.8 | 25.4 | 18.8 |
| Al₂O₃ | | | | | | | | | | |
| (SiO₂ + Al₂O₃)/ | 5.09 | 4.97 | 5.01 | 3.7 | 4.47 | 6.05 | 4.17 | 5.29 | 3.79 | 5.13 |
| (Li₂O + Na₂O + | | | | | | | | | | |
| K₂O) | | | | | | | | | | |
| Transparent | 90.8 | 91.6 | 91.6 | 92.0 | 92.0 | 90.5 | 92.0 | 92.0 | 92.0 | 90.5 |
| Part T_{400-800 nm} (%) | | | | | | | | | | |
| Blackened | 12.6 | 7.0 | 7.9 | 2.1 | 6.4 | 0.9 | 17.0 | 17.5 | 24.6 | 0.5 |
| Part T_{940 nm} (%) | | | | | | | | | | |
| Blackened | 4.4 | 2.5 | 2.8 | 0.7 | 2.2 | 0.3 | 6.0 | 6.2 | 8.6 | 0.2 |
| Part T_{870 nm} (%) | | | | | | | | | | |
| Blackened | 0.2 | 0.4 | 0.4 | 0.3 | 0.4 | 0.1 | 0.6 | 0.6 | 0.7 | 0 |
| Part T_{400-800 nm} (%) | | | | | | | | | | |

TABLE 8

| | Examples (wt %) | | | | | | | | | |
|---|---|---|---|---|---|---|---|---|---|---|
| | 31# | 32# | 33# | 34# | 35# | 36# | 37# | 38# | 39# | 40# |
| SiO₂ | 71.1 | 70.9 | 73.5 | 72.3 | 74.2 | 72.5 | 72.1 | 72.9 | 70.1 | 70.5 |
| Al₂O₃ | 8.9 | 8.4 | 3.5 | 7.6 | 5.9 | 6 | 6 | 4.8 | 9.7 | 8 |
| Li₂O | 8.5 | 10.2 | 11 | 9.6 | 9.8 | 10.4 | 10.7 | 10.8 | 7.4 | 11.6 |
| K₂O | 1.8 | 3.2 | 3.8 | 2.3 | 3.2 | 3.4 | 4.5 | 3.7 | 4.6 | 1.1 |
| Na₂O | 5.5 | 1.9 | 3.2 | 1.1 | 2.9 | 2.1 | 2.8 | 3.9 | 1.3 | 2.5 |
| ZrO₂ | 2 | 4.8 | 4.3 | 2 | 3.4 | 5.1 | 3 | 3.4 | 6.1 | 5.4 |
| CeO₂ | 0.15 | 0.12 | 0.09 | 0.15 | 0.09 | 0.1 | 0.11 | 0.1 | 0.13 | 0.13 |
| Ag₂O | 0.36 | 0.24 | 0.23 | 0.34 | 0.29 | 0.22 | 0.3 | 0.25 | 0.24 | 0.3 |
| Sb₂O₃ | 0.5 | 0.21 | 0.31 | 0.43 | 0.15 | 0.08 | 0.39 | 0.14 | 0.35 | 0.44 |
| SnO₂ | 0.09 | 0.03 | 0.07 | 0.18 | 0.07 | 0.1 | 0.1 | 0.01 | 0.08 | 0.03 |
| ZnO | 1.1 | 0 | 0 | 4 | 0 | 0 | 0 | 0 | 0 | 0 |
| MgO | 0 | 0 | 0 | 0 | 0 | 0 | 0 | 0 | 0 | 0 |
| CaO | 0 | 0 | 0 | 0 | 0 | 0 | 0 | 0 | 0 | 0 |
| SrO | 0 | 0 | 0 | 0 | 0 | 0 | 0 | 0 | 0 | 0 |
| BaO | 0 | 0 | 0 | 0 | 0 | 0 | 0 | 0 | 0 | 0 |
| La₂O₃ | 0 | 0 | 0 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Fe₂O₃ | 0 | 0 | 0 | 0 | 0 | 0 | 0 | 0 | 0 | 0 |
| Total | 100 | 100 | 100 | 100 | 100 | 100 | 100 | 100 | 100 | 100 |
| R₂O | 7.3 | 5.1 | 7 | 3.4 | 6.1 | 5.5 | 7.3 | 7.6 | 5.9 | 3.6 |
| SiO₂/Li₂O | 8.36 | 6.95 | 6.68 | 7.53 | 7.57 | 6.97 | 6.74 | 6.75 | 9.47 | 6.08 |
| Sb₂O₃ + SnO₂ | 0.59 | 0.24 | 0.38 | 0.61 | 0.22 | 0.18 | 0.49 | 0.15 | 0.43 | 0.47 |
| (Sb₂O₃ + | 1.64 | 1 | 1.65 | 1.79 | 0.76 | 0.82 | 1.63 | 0.60 | 1.79 | 1.57 |
| SnO₂)/Ag₂O | | | | | | | | | | |
| Ag₂O/CeO₂ | 2.4 | 2 | 2.56 | 2.27 | 3.22 | 2.2 | 2.73 | 2.5 | 1.85 | 2.31 |
| Li₂O/ZrO₂ | 4.25 | 2.13 | 2.56 | 4.8 | 2.88 | 2.04 | 3.57 | 3.18 | 1.21 | 2.15 |
| (K₂O + | 3.65 | 1.06 | 1.63 | 1.7 | 1.79 | 1.08 | 2.43 | 2.24 | 0.97 | 0.67 |
| Na₂O)/ZrO₂ | | | | | | | | | | |
| (SiO₂ + | 39.8 | 16.9 | 19.65 | 40.95 | 24.71 | 16.25 | 27.6 | 24.62 | 12.7 | 15.2 |
| Li₂O)/ZrO₂ | | | | | | | | | | |
| MO/ZrO₂ | 0.55 | 0 | 0 | 2 | 0 | 0 | 0 | 0 | 0 | 0 |
| ZrO₂/(Ag₂O + | 3.92 | 13.33 | 13.44 | 4.08 | 8.95 | 15.94 | 7.32 | 9.71 | 16.49 | 12.56 |
| CeO₂) | | | | | | | | | | |
| (Ag₂O + SnO₂ + | 6.33 | 4 | 6.78 | 6.33 | 5.67 | 4 | 7.18 | 4 | 5.15 | 5.92 |
| Sb₂O₃)/CeO₂ | | | | | | | | | | |
| (Sb₂O₃ + SnO₂ + | 2.06 | 1.5 | 2.04 | 2.24 | 1.07 | 1.27 | 2 | 1 | 2.33 | 2 |
| CeO₂)/Ag₂O | | | | | | | | | | |
| SnO₂/(CeO₂ + | 0.38 | 0.2 | 0.44 | 0.55 | 0.44 | 0.5 | 0.48 | 0.09 | 0.38 | 0.19 |
| SnO₂) | | | | | | | | | | |
| R₂O + Li₂O + | 24.7 | 23.7 | 21.5 | 20.6 | 21.8 | 21.9 | 24 | 23.2 | 23 | 23.2 |
| Al₂O₃ | | | | | | | | | | |
| (SiO₂ + Al₂O₃)/ | 5.06 | 5.18 | 4.28 | 6.15 | 5.04 | 4.94 | 4.34 | 4.22 | 6 | 5.16 |
| (Li₂O + Na₂O + | | | | | | | | | | |
| K₂O) | | | | | | | | | | |
| Transparent | 91.8 | 92.0 | 92.0 | 90.8 | 92.0 | 92.0 | 92.0 | 92.0 | 92.0 | 92.0 |
| Part T_{400-800 nm} (%) | | | | | | | | | | |
| Blackened | 0.3 | 7.1 | 0.5 | 0.9 | 22.7 | 9.7 | 0.7 | 21.7 | 0.3 | 1.0 |
| Part T_{940 nm} (%) | | | | | | | | | | |
| Blackened | 0.1 | 2.5 | 0.2 | 0.3 | 8.0 | 3.4 | 0.2 | 7.6 | 0.1 | 0.3 |
| Part T_{870 nm} (%) | | | | | | | | | | |
| Blackened | 0 | 0.4 | 0 | 0 | 0.7 | 0.2 | 0 | 0.7 | 0 | 0.1 |
| Part T_{400-800 nm} (%) | | | | | | | | | | |

### <Examples of the Photosensitive Microcrystalline Glass Product>

The Examples applied the above preparation method of the photosensitive microcrystalline glass product to obtain the photosensitive microcrystalline glass products having the composition shown in Tables 9-12. Additionally, the properties of various photosensitive microcrystalline glass products were determined by the testing methods of the present invention, and the testing results were shown in Tables 9-12, and in the following Examples the transmittances of the photosensitive microcrystalline glass products were determined by using samples with a thickness of 1 mm.

TABLE 9

| | Examples (wt %) | | | | | | | | | |
|---|---|---|---|---|---|---|---|---|---|---|
| | 1# | 2# | 3# | 4# | 5# | 6# | 7# | 8# | 9# | 10# |
| SiO₂ | 72.66 | 67.2 | 69.9 | 65 | 77.19 | 74.37 | 75.58 | 70.1 | 69.2 | 71.5 |
| Al₂O₃ | 7.4 | 9.46 | 6.9 | 10 | 3 | 6.7 | 5.5 | 5.9 | 7.7 | 9 |
| Li₂O | 10 | 8.7 | 11.6 | 10.5 | 9.9 | 10.6 | 8.6 | 11.5 | 8.7 | 8.3 |
| K₂O | 4.2 | 3.8 | 3.5 | 5.5 | 2.5 | 2.7 | 4.8 | 4.1 | 5.1 | 2.2 |
| Na₂O | 2.2 | 5.6 | 4.9 | 3.6 | 3 | 2.6 | 1.7 | 3.9 | 4.3 | 5 |
| ZrO₂ | 2.6 | 4.5 | 2.2 | 4.6 | 3.5 | 2.5 | 3.1 | 3.2 | 4 | 1.5 |
| CeO₂ | 0.1 | 0.07 | 0.12 | 0.06 | 0.14 | 0.07 | 0.08 | 0.14 | 0.1 | 0.09 |
| Ag₂O | 0.2 | 0.42 | 0.38 | 0.32 | 0.34 | 0.27 | 0.33 | 0.45 | 0.47 | 0.41 |
| Sb₂O₃ | 0.52 | 0.2 | 0.36 | 0.32 | 0.42 | 0.15 | 0.15 | 0.09 | 0.32 | 0.46 |
| SnO₂ | 0.12 | 0.05 | 0.14 | 0.1 | 0.01 | 0.04 | 0.16 | 0.12 | 0.11 | 0.04 |
| ZnO | 0 | 0 | 0 | 0 | 0 | 0 | 0 | 0 | 0 | 1.5 |
| MgO | 0 | 0 | 0 | 0 | 0 | 0 | 0 | 0 | 0 | 0 |
| CaO | 0 | 0 | 0 | 0 | 0 | 0 | 0 | 0 | 0 | 0 |
| SrO | 0 | 0 | 0 | 0 | 0 | 0 | 0 | 0 | 0 | 0 |
| BaO | 0 | 0 | 0 | 0 | 0 | 0 | 0 | 0 | 0 | 0 |
| La₂O₃ | 0 | 0 | 0 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Fe₂O₃ | 0 | 0 | 0 | 0 | 0 | 0 | 0 | 0.5 | 0 | 0 |
| Total | 100 | 100 | 100 | 100 | 100 | 100 | 100 | 100 | 100 | 100 |
| R₂O | 6.4 | 9.4 | 8.4 | 9.1 | 5.5 | 5.3 | 6.5 | 8 | 9.4 | 7.2 |
| SiO₂/Li₂O | 7.27 | 7.72 | 6.03 | 6.19 | 7.8 | 7.02 | 8.79 | 6.1 | 7.95 | 8.61 |
| Sb₂O₃ + SnO₂ | 0.64 | 0.25 | 0.5 | 0.42 | 0.43 | 0.19 | 0.31 | 0.21 | 0.43 | 0.5 |
| (Sb₂O₃ + | 3.2 | 0.6 | 1.32 | 1.31 | 1.26 | 0.7 | 0.94 | 0.47 | 0.91 | 1.22 |
| SnO₂)/Ag₂O | | | | | | | | | | |
| Ag₂O/CeO₂ | 2 | 6 | 3.17 | 5.33 | 2.43 | 3.86 | 4.13 | 3.21 | 4.7 | 4.56 |
| Li₂O/ZrO₂ | 3.85 | 1.93 | 5.27 | 2.28 | 2.83 | 4.24 | 2.77 | 3.59 | 2.18 | 5.53 |
| (K₂O + | 2.46 | 2.09 | 3.82 | 1.98 | 1.57 | 2.12 | 2.1 | 2.5 | 2.35 | 4.8 |
| Na₂O)/ZrO₂ | | | | | | | | | | |
| (SiO₂ + | 31.79 | 16.87 | 37.05 | 16.41 | 24.88 | 33.99 | 27.15 | 25.50 | 19.48 | 53.2 |
| Li₂O)/ZrO₂ | | | | | | | | | | |
| MO/ZrO₂ | 0 | 0 | 0 | 0 | 0 | 0 | 0 | 0 | 0 | 1 |
| ZrO₂/(Ag₂O + | 8.67 | 9.18 | 4.4 | 12.11 | 7.29 | 7.35 | 7.56 | 5.42 | 7.02 | 3 |
| CeO₂) | | | | | | | | | | |
| (Ag₂O + SnO₂ + | 8.4 | 9.57 | 7.33 | 12.33 | 5.5 | 6.57 | 8 | 4.71 | 9 | 10.11 |
| Sb₂O₃)/CeO₂ | | | | | | | | | | |
| (Sb₂O₃ + SnO₂ + | 3.7 | 0.76 | 1.63 | 1.50 | 1.68 | 0.96 | 1.18 | 0.78 | 1.13 | 1.44 |
| CeO₂)/Ag₂O | | | | | | | | | | |
| SnO₂/(CeO₂ + | 0.55 | 0.42 | 0.54 | 0.63 | 0.07 | 0.36 | 0.67 | 0.46 | 0.52 | 0.31 |
| SnO₂) | | | | | | | | | | |
| R₂O + Li₂O + | 23.8 | 27.56 | 26.9 | 29.6 | 18.4 | 22.6 | 20.6 | 25.4 | 25.8 | 24.5 |
| Al₂O₃ | | | | | | | | | | |
| (SiO₂ + Al₂O₃)/ | 4.88 | 4.24 | 3.84 | 3.83 | 5.21 | 5.1 | 5.37 | 3.9 | 4.25 | 5.19 |
| (Li₂O + Na₂O + | | | | | | | | | | |
| K₂O) | | | | | | | | | | |
| Transparent | 91.8 | 92.0 | 91.6 | 91.8 | 92.0 | 92.0 | 90.7 | 91.6 | 91.8 | 92.0 |
| Part T_{400-800 nm} (%) | | | | | | | | | | |
| Blackened | 0.3 | 21.7 | 3.3 | 2.8 | 4.0 | 17.1 | 10.1 | 2.5 | 11.1 | 4.8 |
| Part T_{940 nm} (%) | | | | | | | | | | |
| Blackened | 0.3 | 7.6 | 1.2 | 1.0 | 1.4 | 6.0 | 3.5 | 0.9 | 3.9 | 1.7 |
| Part T_{870 nm} (%) | | | | | | | | | | |
| Blackened | 0 | 0.7 | 0.3 | 0.3 | 0.3 | 0.6 | 0.5 | 0.3 | 0.5 | 0.3 |
| Part T_{400-800 nm} (%) | | | | | | | | | | |
| Height II for | 1,200 | 800 | 900 | 800 | 800 | 1,200 | 900 | 1,100 | 800 | 1,200 |
| the falling | | | | | | | | | | |
| ball test (mm) | | | | | | | | | | |

TABLE 10

| | Examples (wt %) | | | | | | | | | |
|---|---|---|---|---|---|---|---|---|---|---|
| | 11# | 12# | 13# | 14# | 15# | 16# | 17# | 18# | 19# | 20# |
| SiO₂ | 73.78 | 72.36 | 76.2 | 74.27 | 69.2 | 72.56 | 70.4 | 72.7 | 76.3 | 75.4 |
| Al₂O₃ | 6.9 | 5.3 | 3.8 | 4.9 | 5.5 | 4.9 | 7 | 7.8 | 5.4 | 6.4 |
| Li₂O | 7.5 | 8.3 | 9.2 | 9.6 | 10.4 | 7.3 | 11.9 | 10 | 10.5 | 8 |
| K₂O | 1.1 | 3.4 | 2.4 | 3 | 3.8 | 3.3 | 4 | 3.3 | 1.4 | 2.3 |
| Na₂O | 3.4 | 3.7 | 2 | 2.5 | 4.4 | 4.1 | 1.5 | 1.3 | 1.5 | 2.2 |
| ZrO₂ | 6.6 | 6.1 | 5.6 | 4.5 | 6.2 | 5.3 | 4.7 | 4.1 | 3.9 | 5.2 |
| CeO₂ | 0.07 | 0.13 | 0.13 | 0.1 | 0.09 | 0.1 | 0.12 | 0.11 | 0.13 | 0.11 |
| Ag₂O | 0.42 | 0.44 | 0.3 | 0.46 | 0.24 | 0.37 | 0.23 | 0.22 | 0.32 | 0.23 |
| Sb₂O₃ | 0.07 | 0.1 | 0.22 | 0.55 | 0.07 | 0.06 | 0.08 | 0.45 | 0.51 | 0.11 |
| SnO₂ | 0.16 | 0.17 | 0.15 | 0.12 | 0.1 | 0.01 | 0.07 | 0.02 | 0.04 | 0.05 |
| ZnO | 0 | 0 | 0 | 0 | 0 | 0 | 0 | 0 | 0 | 0 |
| MgO | 0 | 0 | 0 | 0 | 0 | 0 | 0 | 0 | 0 | 0 |
| CaO | 0 | 0 | 0 | 0 | 0 | 0 | 0 | 0 | 0 | 0 |
| SrO | 0 | 0 | 0 | 0 | 0 | 0 | 0 | 0 | 0 | 0 |
| BaO | 0 | 0 | 0 | 0 | 0 | 0 | 0 | 0 | 0 | 0 |
| La₂O₃ | 0 | 0 | 0 | 0 | 0 | 2 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Fe₂O₃ | 0 | 0 | 0 | 0 | 0 | 0 | 0 | 0 | 0 | 0 |
| Total | 100 | 100 | 100 | 100 | 100 | 100 | 100 | 100 | 100 | 100 |
| R₂O | 4.5 | 7.1 | 4.4 | 5.5 | 8.2 | 7.4 | 5.5 | 4.6 | 2.9 | 4.5 |
| SiO₂/Li₂O | 9.84 | 8.72 | 8.28 | 7.74 | 6.65 | 9.94 | 5.92 | 7.27 | 7.27 | 9.43 |
| Sb₂O₃ + SnO₂ | 0.23 | 0.27 | 0.37 | 0.67 | 0.17 | 0.07 | 0.15 | 0.47 | 0.55 | 0.16 |
| (Sb₂O₃ + | 0.55 | 0.61 | 1.23 | 1.46 | 0.71 | 0.19 | 0.65 | 2.14 | 1.72 | 0.7 |
| SnO₂)/Ag₂O | | | | | | | | | | |
| Ag₂O/CeO₂ | 6 | 3.38 | 2.31 | 4.6 | 2.67 | 3.7 | 1.92 | 2 | 2.46 | 2.09 |
| Li₂O/ZrO₂ | 1.14 | 1.36 | 1.64 | 2.13 | 1.68 | 1.38 | 2.53 | 2.44 | 2.69 | 1.54 |
| (K₂O + | 0.68 | 1.16 | 0.79 | 1.22 | 1.32 | 1.4 | 1.17 | 1.12 | 0.74 | 0.87 |
| Na₂O)/ZrO₂ | | | | | | | | | | |
| (SiO₂ + | 12.32 | 13.22 | 15.25 | 18.64 | 12.84 | 15.07 | 17.51 | 20.17 | 22.26 | 16.04 |
| Li₂O)/ZrO₂ | | | | | | | | | | |
| MO/ZrO₂ | 0 | 0 | 0 | 0 | 0 | 0 | 0 | 0 | 0 | 0 |
| ZrO₂/(Ag₂O + | 13.47 | 10.7 | 13.02 | 8.04 | 18.79 | 11.28 | 13.43 | 12.42 | 8.67 | 15.29 |
| CeO₂) | | | | | | | | | | |
| (Ag₂O + SnO₂ + | 9.29 | 5.46 | 5.15 | 11.3 | 4.56 | 4.4 | 3.17 | 6.27 | 6.69 | 3.55 |
| Sb₂O₃)/CeO₂ | | | | | | | | | | |
| (Sb₂O₃ + SnO₂ + | 0.71 | 0.91 | 1.67 | 1.67 | 1.08 | 0.46 | 1.17 | 2.64 | 2.13 | 1.17 |
| CeO₂)/Ag₂O | | | | | | | | | | |
| SnO₂/(CeO₂ + | 0.7 | 0.57 | 0.54 | 0.55 | 0.53 | 0.09 | 0.37 | 0.15 | 0.24 | 0.31 |
| SnO₂) | | | | | | | | | | |
| R₂O + Li₂O + | 18.9 | 20.7 | 17.4 | 20 | 24.1 | 19.6 | 24.4 | 22.4 | 18.8 | 18.9 |
| Al₂O₃ | | | | | | | | | | |
| (SiO₂ + Al₂O₃)/ | 6.72 | 5.04 | 5.88 | 5.24 | 4.02 | 5.27 | 4.45 | 5.51 | 6.1 | 6.54 |
| (Li₂O + Na₂O + | | | | | | | | | | |
| K₂O) | | | | | | | | | | |
| Transparent | 90.7 | 90.7 | 91.5 | 90.7 | 91.8 | 92.0 | 92.0 | 92.0 | 92.0 | 92.0 |
| Part T_{400-800 nm} (%) | | | | | | | | | | |
| Blackened | 20.7 | 18.8 | 4.7 | 1.0 | 19.7 | 35.9 | 18.3 | 0.4 | 0.4 | 12.8 |
| Part T_{940 nm} (%) | | | | | | | | | | |
| Blackened | 7.3 | 6.6 | 1.7 | 0.4 | 6.9 | 12.6 | 6.4 | 0.1 | 0.1 | 4.5 |
| Part T_{870 nm} (%) | | | | | | | | | | |
| Blackened | 0.7 | 0.6 | 0.3 | 0.2 | 0.6 | 1.2 | 0.6 | 0 | 0 | 0.2 |
| Part T_{400-800 nm} (%) | | | | | | | | | | |
| Height II for | 800 | 900 | 900 | 1,000 | 800 | 800 | 800 | 1,200 | 1,100 | 800 |
| the falling | | | | | | | | | | |
| ball test (mm) | | | | | | | | | | |

TABLE 11

| | Examples (wt %) | | | | | | | | | |
|---|---|---|---|---|---|---|---|---|---|---|
| | 21# | 22# | 23# | 24# | 25# | 26# | 27# | 28# | 29# | 30# |
| SiO₂ | 72.76 | 72 | 72.5 | 69.8 | 69.4 | 73.5 | 71 | 71.5 | 67.5 | 78 |
| Al₂O₃ | 5.7 | 6 | 6.1 | 6.5 | 8.4 | 7.6 | 7.9 | 9.5 | 6 | 3 |
| Li₂O | 9.2 | 10.2 | 9.8 | 10 | 12 | 9.2 | 11.2 | 9.8 | 11.6 | 11.8 |
| K₂O | 4.3 | 3 | 3.1 | 5.2 | 2.1 | 2.5 | 3.7 | 1.8 | 3.7 | 3 |
| Na₂O | 1.9 | 2.5 | 2.8 | 5.4 | 3.3 | 1.7 | 4 | 3.7 | 4.1 | 1 |
| ZrO₂ | 5.5 | 5.5 | 4.8 | 2.4 | 3.7 | 4.6 | 1.6 | 2.9 | 6.5 | 2.1 |
| CeO₂ | 0.1 | 0.1 | 0.15 | 0.14 | 0.09 | 0.1 | 0.07 | 0.11 | 0.12 | 0.14 |
| Ag₂O | 0.29 | 0.33 | 0.22 | 0.21 | 0.5 | 0.31 | 0.3 | 0.4 | 0.32 | 0.4 |
| Sb₂O₃ | 0.07 | 0.23 | 0.42 | 0.3 | 0.43 | 0.29 | 0.22 | 0.21 | 0.14 | 0.46 |
| SnO₂ | 0.18 | 0.14 | 0.11 | 0.05 | 0.08 | 0.2 | 0.01 | 0.08 | 0.02 | 0.1 |
| ZnO | 0 | 0 | 0 | 0 | 0 | 0 | 0 | 0 | 0 | 0 |
| MgO | 0 | 0 | 0 | 0 | 0 | 0 | 0 | 0 | 0 | 0 |
| CaO | 0 | 0 | 0 | 0 | 0 | 0 | 0 | 0 | 0 | 0 |
| SrO | 0 | 0 | 0 | 0 | 0 | 0 | 0 | 0 | 0 | 0 |
| BaO | 0 | 0 | 0 | 0 | 0 | 0 | 0 | 0 | 0 | 0 |
| La₂O₃ | 0 | 0 | 0 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Fe₂O₃ | 0 | 0 | 0 | 0 | 0 | 0 | 0 | 0 | 0 | 0 |
| Total | 100 | 100 | 100 | 100 | 100 | 100 | 100 | 100 | 100 | 100 |
| R₂O | 6.2 | 5.5 | 5.9 | 10.6 | 5.4 | 4.2 | 7.7 | 5.5 | 7.8 | 4 |
| SiO₂/Li₂O | 7.91 | 7.06 | 7.40 | 6.98 | 5.78 | 7.99 | 6.34 | 7.30 | 5.82 | 6.61 |
| Sb₂O₃ + SnO₂ | 0.25 | 0.37 | 0.53 | 0.35 | 0.51 | 0.49 | 0.23 | 0.29 | 0.16 | 0.56 |
| (Sb₂O₃ + | 0.86 | 1.12 | 2.41 | 1.67 | 1.02 | 1.58 | 0.77 | 0.73 | 0.5 | 1.4 |
| SnO₂)/Ag₂O | | | | | | | | | | |
| Ag₂O/CeO₂ | 2.9 | 3.3 | 1.47 | 1.5 | 5.56 | 3.1 | 4.29 | 3.64 | 2.67 | 2.86 |
| Li₂O/ZrO₂ | 1.67 | 1.85 | 2.04 | 4.17 | 3.24 | 2 | 7 | 3.38 | 1.78 | 5.62 |
| (K₂O + | 1.13 | 1 | 1.23 | 4.42 | 1.46 | 0.91 | 4.81 | 1.9 | 1.2 | 1.9 |
| Na₂O)/ZrO₂ | | | | | | | | | | |
| (SiO₂ + | 14.9 | 14.95 | 17.15 | 33.25 | 22 | 17.98 | 51.38 | 28.03 | 12.17 | 42.76 |
| Li₂O)/ZrO₂ | | | | | | | | | | |
| MO/ZrO₂ | 0 | 0 | 0 | 0 | 0 | 0 | 0 | 0 | 0 | 0 |
| ZrO₂/(Ag₂O + | 14.1 | 12.79 | 12.97 | 6.86 | 6.27 | 11.22 | 4.32 | 5.69 | 14.77 | 3.89 |
| CeO₂) | | | | | | | | | | |
| (Ag₂O + SnO₂ + | 5.4 | 7 | 5 | 4 | 11.22 | 8 | 7.57 | 6.27 | 4 | 6.86 |
| Sb₂O₃)/CeO₂ | | | | | | | | | | |
| (Sb₂O₃ + SnO₂ + | 1.21 | 1.42 | 3.09 | 2.33 | 1.2 | 1.9 | 1 | 1 | 0.88 | 1.75 |
| CeO₂)/Ag₂O | | | | | | | | | | |
| SnO₂/(CeO₂ + | 0.64 | 0.58 | 0.42 | 0.26 | 0.47 | 0.67 | 0.13 | 0.42 | 0.14 | 0.42 |
| SnO₂) | | | | | | | | | | |
| R₂O + Li₂O + | 21.1 | 21.7 | 21.8 | 27.1 | 25.8 | 21 | 26.8 | 24.8 | 25.4 | 18.8 |
| Al₂O₃ | | | | | | | | | | |
| (SiO₂ + Al₂O₃)/ | 5.09 | 4.97 | 5.01 | 3.7 | 4.47 | 6.05 | 4.17 | 5.29 | 3.79 | 5.13 |
| (Li₂O + Na₂O + | | | | | | | | | | |
| K₂O) | | | | | | | | | | |
| Transparent | 90.8 | 91.6 | 91.6 | 92.0 | 92.0 | 90.5 | 92.0 | 92.0 | 92.0 | 90.5 |
| Part T_{400-800 nm} (%) | | | | | | | | | | |
| Blackened | 12.6 | 7.0 | 7.9 | 2.1 | 6.4 | 0.9 | 17.0 | 17.5 | 24.6 | 0.5 |
| Part T_{940 nm} (%) | | | | | | | | | | |
| Blackened | 4.4 | 2.5 | 2.8 | 0.7 | 2.2 | 0.3 | 6.0 | 6.2 | 8.6 | 0.2 |
| Part T_{870 nm} (%) | | | | | | | | | | |
| Blackened | 0.2 | 0.4 | 0.4 | 0.3 | 0.4 | 0.1 | 0.6 | 0.6 | 0.7 | 0 |
| Part T_{400-800 nm} (%) | | | | | | | | | | |
| Height II for | 1,200 | 1,200 | 1,100 | 800 | 800 | 1,200 | 900 | 1,200 | 800 | 1,000 |
| the falling | | | | | | | | | | |
| ball test (mm) | | | | | | | | | | |

TABLE 12

| | Examples (wt %) | | | | | | | | | |
|---|---|---|---|---|---|---|---|---|---|---|
| | 31# | 32# | 33# | 34# | 35# | 36# | 37# | 38# | 39# | 40# |
| SiO₂ | 71.1 | 70.9 | 73.5 | 72.3 | 74.2 | 72.5 | 72.1 | 72.9 | 70.1 | 70.5 |
| Al₂O₃ | 8.9 | 8.4 | 3.5 | 7.6 | 5.9 | 6 | 6 | 4.8 | 9.7 | 8 |
| Li₂O | 8.5 | 10.2 | 11 | 9.6 | 19.8 | 10.4 | 10.7 | 10.8 | 7.4 | 11.6 |
| K₂O | 1.8 | 3.2 | 3.8 | 2.3 | 3.2 | 3.4 | 4.5 | 3.7 | 4.6 | 1.1 |
| Na₂O | 5.5 | 1.9 | 3.2 | 1.1 | 2.9 | 2.1 | 2.8 | 3.9 | 1.3 | 2.5 |
| ZrO₂ | 2 | 4.8 | 4.3 | 2 | 3.4 | 5.1 | 3 | 3.4 | 6.1 | 5.4 |
| CeO₂ | 0.15 | 0.12 | 0.09 | 0.15 | 0.09 | 0.1 | 0.11 | 0.1 | 0.13 | 0.13 |
| Ag₂O | 0.36 | 0.24 | 0.23 | 0.34 | 0.29 | 0.22 | 0.3 | 0.25 | 0.24 | 0.3 |
| Sb₂O₃ | 0.5 | 0.21 | 0.31 | 0.43 | 0.15 | 0.08 | 0.39 | 0.14 | 0.35 | 0.44 |
| SnO₂ | 0.09 | 10.03 | 0.07 | 0.18 | 0.07 | 0.1 | 0.1 | 0.01 | 0.08 | 0.03 |
| ZnO | 1.1 | 0 | 0 | 4 | 0 | 0 | 0 | 0 | 0 | 0 |
| MgO | 0 | 0 | 0 | 0 | 0 | 0 | 0 | 0 | 0 | 0 |
| CaO | 0 | 0 | 0 | 0 | 0 | 0 | 0 | 0 | 0 | 0 |
| SrO | 0 | 0 | 0 | 0 | 0 | 0 | 0 | 0 | 0 | 0 |
| BaO | 0 | 0 | 0 | 0 | 0 | 0 | 0 | 0 | 0 | 0 |
| La₂O₃ | 0 | 0 | 0 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Fe₂O₃ | 0 | 0 | 0 | 0 | 0 | 0 | 0 | 0 | 0 | 0 |
| Total | 100 | 100 | 100 | 100 | 100 | 100 | 100 | 100 | 100 | 100 |
| R₂O | 7.3 | 5.1 | 7 | 3.4 | 6.1 | 5.5 | 7.3 | 7.6 | 5.9 | 3.6 |
| SiO₂/Li₂O | 8.36 | 6.95 | 6.68 | 7.53 | 7.57 | 6.97 | 6.74 | 6.75 | 19.47 | 6.08 |
| Sb₂O₃ + SnO₂ | 0.59 | 0.24 | 0.38 | 0.61 | 0.22 | 0.18 | 0.49 | 0.15 | 0.43 | 0.47 |
| (Sb₂O₃ + | 1.64 | 1 | 1.65 | 1.79 | 0.76 | 0.82 | 1.63 | 0.60 | 1.79 | 1.57 |
| SnO₂)/Ag₂O | | | | | | | | | | |
| Ag₂O/CeO₂ | 2.4 | 2 | 2.56 | 2.27 | 3.22 | 2.2 | 2.73 | 2.5 | 1.85 | 2.31 |
| Li₂O/ZrO₂ | 4.25 | 2.13 | 2.56 | 4.8 | 2.88 | 2.04 | 3.57 | 3.18 | 1.21 | 2.15 |
| (K₂O + | 3.65 | 1.06 | 1.63 | 1.7 | 1.79 | 1.08 | 2.43 | 2.24 | 0.97 | 0.67 |
| Na₂O)/ZrO₂ | | | | | | | | | | |
| (SiO₂ + | 39.8 | 16.9 | 19.65 | 40.95 | 24.71 | 16.25 | 27.6 | 24.62 | 12.7 | 15.2 |
| Li₂O)/ZrO₂ | | | | | | | | | | |
| MO/ZrO₂ | 0.55 | 0 | 0 | 2 | 0 | 0 | 0 | 0 | 0 | 0 |
| ZrO₂/(Ag₂O + | 3.92 | 13.33 | 13.44 | 4.08 | 18.95 | 15.94 | 7.32 | 9.71 | 16.49 | 12.56 |
| CeO₂) | | | | | | | | | | |
| (Ag₂O + SnO₂ + | 6.33 | 4 | 6.78 | 6.33 | 5.67 | 4 | 7.18 | 4 | 5.15 | 5.92 |
| Sb₂O₃)/CeO₂ | | | | | | | | | | |
| (Sb₂O₃ + SnO₂ + | 2.06 | 1.5 | 2.04 | 2.24 | 1.07 | 1.27 | 2 | 1 | 2.33 | 2 |
| CeO₂)/Ag₂O | | | | | | | | | | |
| SnO₂/(CeO₂ + | 0.38 | 0.2 | 0.44 | 0.55 | 0.44 | 0.5 | 0.48 | 0.09 | 0.38 | 0.19 |
| SnO₂) | | | | | | | | | | |
| R₂O + Li₂O + | 24.7 | 23.7 | 21.5 | 20.6 | 21.8 | 21.9 | 24 | 23.2 | 23 | 23.2 |
| Al₂O₃ | | | | | | | | | | |
| (SiO₂ + Al₂O₃)/ | 5.06 | 5.18 | 4.28 | 6.15 | 5.04 | 4.94 | 4.34 | 4.22 | 6 | 5.16 |
| (Li₂O + Na₂O + | | | | | | | | | | |
| K₂O) | | | | | | | | | | |
| Transparent | 91.8 | 92.0 | 92.0 | 90.8 | 92.0 | 92.0 | 92.0 | 92.0 | 92.0 | 92.0 |
| Part T_{400-800 nm} (%) | | | | | | | | | | |
| Blackened | 0.3 | 7.1 | 10.5 | 10.9 | 22.7 | 19.7 | 10.7 | 21.7 | 0.3 | 1.0 |
| Part T_{940 nm} (%) | | | | | | | | | | |
| Blackened | 0.1 | 2.5 | 0.2 | 0.3 | 8.0 | 3.4 | 0.2 | 7.6 | 0.1 | 0.3 |
| Part T_{870 nm} (%) | | | | | | | | | | |
| Blackened | 0 | 0.4 | 0 | 0 | 0.7 | 0.2 | 0 | 0.7 | 0 | 0.1 |
| Part T_{400-800 nm} (%) | | | | | | | | | | |
| Height II for | 1,200 | 1,100 | 1,000 | 900 | 800 | 800 | 800 | 800 | 800 | 800 |
| the falling | | | | | | | | | | |
| ball test (mm) | | | | | | | | | | |

What is claimed is:

1. A photosensitive glass material, comprising the following components in percentage by weight: SiO₂, R₂O, Li₂O, Al₂O₃, ZrO₂, CeO₂ and Ag₂O, wherein Li₂O/ZrO₂ is 1.0-7.5, the R₂O is one or two of Na₂O and K₂O, and dielectric loss tan δ of the photosensitive glass material is below 11.0×10⁻³.

2. The photosensitive glass material according to claim 1, comprising the following components in percentage by weight: 65-78% of SiO₂; and/or 2-12% of R₂O; and/or 5-15% of Li₂O; and/or 3-12% of Al₂O₃; and/or 1.5-10% of ZrO₂; and/or 0.01-0.6% of CeO₂; and/or 0.01-0.8% of Ag₂O; and/or 0-1% of Sb₂O₃; and/or 0-0.5% of SnO₂; and/or 0-5% of MO; and/or 0-5% of Ln₂O₃; and/or 0-1% of Fe₂O₃, wherein the R₂O is one or two of Na₂O and K₂O, MO is one or more of MgO, CaO, SrO, BaO, and ZnO, and Ln₂O₃ is one or more of La₂O₃, Gd₂O₃, and Y₂O₃.

3. The photosensitive glass material according to claim 1, wherein components thereof in percentage by weight satisfy one or more of the following 14 circumstances:
1) SiO₂/Li₂O is 5.5-10.0;
2) (K₂O+Na₂O)/ZrO₂ is 0.5-7.1;
3) Li₂O/ZrO₂ is 1.2-5.0;
4) (SiO₂+Li₂O)/ZrO₂ is 8.0-55.0;
5) (SiO₂+Al₂O₃)/(Li₂O+Na₂O+K₂O) is 3.0-7.5;
6) R₂O+Li₂O+Al₂O₃ is 15-30%;
7) MO/ZrO₂ is below 2.5;
8) (Sb₂O₃+SnO₂)/Ag₂O is 0.1-5.0;
9) Ag₂O/CeO₂ is 1.0-10.0;
10) ZrO₂/(Ag₂O+CeO₂) is 2.3-50.0;
11) (Ag₂O+SnO₂+Sb₂O₃)/CeO₂ is 1.0-30.0;
12) (Sb₂O₃+SnO₂+CeO₂)/Ag₂O is 0.1-10.0;
13) SnO₂/(CeO₂+SnO₂) is 0-0.9; and
14) Sb₂O₃+SnO₂ is 0.05-1.2%,
the MO is one or more of MgO, CaO, SrO, BaO, and ZnO, and R₂O is one or two of Na₂O and K₂O.

4. (canceled)

5. The photosensitive glass material according to claim 1, wherein components thereof in percentage by weight satisfy one or more of the following 14 circumstances:
1) SiO₂/Li₂O is 7.0-8.5;
2) (K₂O+Na₂O)/ZrO₂ is 0.8-2.5;
3) Li₂O/ZrO₂ is 1.6-3.0;
4) (SiO₂+Li₂O)/ZrO₂ is 13.0-20.0;
5) (SiO₂+Al₂O₃)/(Li₂O+Na₂O+K₂O) is 4.8-5.8;
6) R₂O+Li₂O+Al₂O₃ is 20-25%;
7) MO/ZrO₂ is below 0.5;
8) (Sb₂O₃+SnO₂)/Ag₂O is 1.0-2.6;
9) Ag₂O/CeO₂ is 2.0-4.5;
10) ZrO₂/(Ag₂O+CeO₂) is 11.0-18.0;
11) (Ag₂O+SnO₂+Sb₂O₃)/CeO₂ is 7.5-10.0;
12) (Sb₂O₃+SnO₂+CeO₂)/Ag₂O is 1.5-3.2;
13) SnO₂/(CeO₂+SnO₂) is 0-0.5; and
14) Sb₂O₃+SnO₂ is 0.2-0.7%,
the MO is one or more of MgO, CaO, SrO, BaO, and ZnO, and R₂O is one or two of Na₂O and K₂O.

6. (canceled)

7. The photosensitive glass material according to claim 1, comprising the following components in percentage by weight: 69.5-75.5% of SiO₂; and/or 4-8% of R₂O; and/or 8.5-12% of Li₂O; and/or 5-9% of Al₂O₃; and/or 3-6.5% of ZrO₂; and/or 0.08-0.3% of CeO₂; and/or 0.2-0.5% of Ag₂O; and/or 0.07-0.5% of Sb₂O₃; and/or 0-0.2% of SnO₂; and/or 0-1% of MO; and/or 0-1% of Ln₂O₃; and/or 0-0.2% of Fe₂O₃, wherein the R₂O is one or two of Na₂O and K₂O, MO is one or more of MgO, CaO, SrO, BaO, and ZnO, and Ln₂O₃ is one or more of La₂O₃, Gd₂O₃, and Y₂O₃.

8. The photosensitive glass material according to claim 1, wherein the photosensitive glass material has refractive index n_{d} of 1.51-1.55; and/or Young's modulus E of 7,000×10⁷ Pa-9,500×10⁷ Pa; and/or Knoop hardness Hk_{0.1} of no less than 450 kgf/mm²; and/or a height I for a falling ball test of no less than 200 mm; and/or dielectric loss tan δ of 7.0×10⁻³-10.5×10⁻³; and/or dielectric constant εr of 5.5-8.5; and/or a linear expansion coefficient α_{20° C.-300° C.} below 100×10⁻⁷/° C.

9. (canceled)

10. Photosensitive microcrystalline glass, comprising the following components in percentage by weight: SiO₂, R₂O, Li₂O, Al₂O₃, ZrO₂, CeO₂ and Ag₂O, wherein Li₂O/ZrO₂ is 1.0-7.5, and the R₂O is one or two of Na₂O and K₂O.

11. The photosensitive microcrystalline glass according to claim 10, comprising the following components in percentage by weight: 65-78% of SiO₂; and/or 2-12% of R₂O; and/or 5-15% of Li₂O; and/or 3-12% of Al₂O₃; and/or 1.5-10% of ZrO₂; and/or 0.01-0.6% of CeO₂; and/or 0.01-0.8% of Ag₂O; and/or 0-1% of Sb₂O₃; and/or 0-0.5% of SnO₂; and/or 0-5% of MO; and/or 0-5% of Ln₂O₃; and/or 0-1% of Fe₂O₃, wherein the R₂O is one or two of Na₂O and K₂O, MO is one or more of MgO, CaO, SrO, BaO, and ZnO, and Ln₂O₃ is one or more of La₂O₃, Gd₂O₃, and Y₂O₃.

12. The photosensitive microcrystalline glass according to claim 10, wherein components thereof in percentage by weight satisfy one or more of the following 14 circumstances:
1) SiO₂/Li₂O is 5.5-10.0;
2) (K₂O+Na₂O)/ZrO₂ is 0.5-7.1;
3) Li₂O/ZrO₂ is 1.2-5.0;
4) (SiO₂+Li₂O)/ZrO₂ is 8.0-55.0;
5) (SiO₂+Al₂O₃)/(Li₂O+Na₂O+K₂O) is 3.0-7.5;
6) R₂O+Li₂O+Al₂O₃ is 15-30%;
7) MO/ZrO₂ is below 2.5;
8) (Sb₂O₃+SnO₂)/Ag₂O is 0.1-5.0;
9) Ag₂O/CeO₂ is 1.0-10.0;
10) ZrO₂/(Ag₂O+CeO₂) is 2.3-50.0;
11) (Ag₂O+SnO₂+Sb₂O₃)/CeO₂ is 1.0-30.0;
12) (Sb₂O₃+SnO₂+CeO₂)/Ag₂O is 0.1-10.0;
13) SnO₂/(CeO₂+SnO₂) is 0-0.9; and
14) Sb₂O₃+SnO₂ is 0.05-1.2%,
the MO is one or more of MgO, CaO, SrO, BaO, and ZnO, and R₂O is one or two of Na₂O and K₂O.

13. (canceled)

14. The photosensitive microcrystalline glass according to claim 10, wherein components thereof in percentage by weight satisfy one or more of the following 14 circumstances:
1) SiO₂/Li₂O is 7.0-8.5;
2) (K₂O+Na₂O)/ZrO₂ is 0.8-2.5;
3) Li₂O/ZrO₂ is 1.6-3.0;
4) (SiO₂+Li₂O)/ZrO₂ is 13.0-20.0;
5) (SiO₂+Al₂O₃)/(Li₂O+Na₂O+K₂O) is 4.8-5.8;
6) R₂O+Li₂O+Al₂O₃ is 20-25%;
7) MO/ZrO₂ is below 0.5;
8) (Sb₂O₃+SnO₂)/Ag₂O is 1.0-2.6;
9) Ag₂O/CeO₂ is 2.0-4.5;
10) ZrO₂/(Ag₂O+CeO₂) is 11.0-18.0;
11) (Ag₂O+SnO₂+Sb₂O₃)/CeO₂ is 7.5-10.0;
12) (Sb₂O₃+SnO₂+CeO₂)/Ag₂O is 1.5-3.2;
13) SnO₂/(CeO₂+SnO₂) is 0-0.5; and
14) Sb₂O₃+SnO₂ is 0.2-0.7%,
the MO is one or more of MgO, CaO, SrO, BaO, and ZnO, and R₂O is one or two of Na₂O and K₂O.

15. (canceled)

16. The photosensitive microcrystalline glass according to claim 10, comprising the following components in percentage by weight: 69.5-75.5% of SiO₂; and/or 4-8% of R₂O; and/or 8.5-12% of Li₂O; and/or 5-9% of Al₂O₃; and/or 3-6.5% of ZrO₂; and/or 0.08-0.3% of CeO₂; and/or 0.2-0.5% of Ag₂O; and/or 0.07-0.5% of Sb₂O₃; and/or 0-0.2% of SnO₂; and/or 0-3% of MO; and/or 0-3% of Ln₂O₃; and/or 0-0.5% of Fe₂O₃, wherein the R₂O is one or two of Na₂O and K₂O, MO is one or more of MgO, CaO, SrO, BaO, and ZnO, and Ln₂O₃ is one or more of La₂O₃, Gd₂O₃, and Y₂O₃.

17. The photosensitive microcrystalline glass according to claim 10, wherein the photosensitive microcrystalline glass comprises one or more blackened parts and one or more transparent parts, or the photosensitive microcrystalline glass as a whole is a blackened part, the photosensitive microcrystalline glass comprise a lithium metasilicate crystalline phase, and in the blackened part of the photosensitive microcrystalline glass, the lithium metasilicate crystalline phase has a weight percentage of 5-40%.

18.-19. (canceled)

20. The photosensitive microcrystalline glass according to claim 17, wherein the transparent part of the photosensitive microcrystalline glass with a thickness of 0.2-1.5 mm has an average transmittance T_{400-800 nm} above 85.0% at a wave band range of 400-800 nm; and/or the blackened part of the photosensitive microcrystalline glass with a thickness of 0.2-1.5 mm has an average transmittance T_{400-800 nm} above 5.0% at a wave band range of 400-800 nm; and/or the blackened part of the photosensitive microcrystalline glass with a thickness of 0.2-1.5 mm has a transmittance T_{870 nm} below 15.0% at 870 nm; and/or the blackened part of the photosensitive microcrystalline glass with a thickness of 0.2-1.5 mm has a transmittance T_{940 nm} below 50.0% at 940 nm.

21. (canceled)

22. The photosensitive microcrystalline glass according to claim 17, wherein the transparent part of the photosensitive microcrystalline glass with a thickness of 0.2-1.5 mm has an average transmittance T_{400-800 nm} of 91.5-95.0% at a wave band range of 400-800 nm; and/or the blackened part of the photosensitive microcrystalline glass with a thickness of 0.2-1.5 mm has an average transmittance T_{400-800 nm} below 0.5% at a wave band range of 400-800 nm; and/or the blackened part of the photosensitive microcrystalline glass with a thickness of 0.2-1.5 mm has a transmittance T_{870 nm} of 0.1-5.0% at 870 nm; and/or the blackened part of the photosensitive microcrystalline glass with a thickness of 0.2-1.5 mm has a transmittance T_{940 nm} of 0.3-10.0% at 940 nm.

23. (canceled)

24. A photosensitive microcrystalline glass product, comprising the following components in percentage by weight: SiO₂, R₂O, Li₂O, Al₂O₃, ZrO₂, CeO₂ and Ag₂O, wherein Li₂O/ZrO₂ is 1.0-7.5, and the R₂O is one or two of Na₂O and K₂O.

25. The photosensitive microcrystalline glass product according to claim 24, comprising the following components in percentage by weight: 65-78% of SiO₂; and/or 2-12% of R₂O; and/or 5-15% of Li₂O; and/or 3-12% of Al₂O₃; and/or 1.5-10% of ZrO₂; and/or 0.01-0.6% of CeO₂; and/or 0.01-0.8% of Ag₂O; and/or 0-1% of Sb₂O₃; and/or 0-0.5% of SnO₂; and/or 0-5% of MO; and/or 0-5% of Ln₂O₃; and/or 0-1% of Fe₂O₃, wherein the R₂O is one or two of Na₂O and K₂O, MO is one or more of MgO, CaO, SrO, BaO, and ZnO, and Ln₂O₃ is one or more of La₂O₃, Gd₂O₃, and Y₂O₃.

26. The photosensitive microcrystalline glass product according to claim 24, wherein components thereof in percentage by weight satisfy one or more of the following 14 circumstances:
1) SiO₂/Li₂O is 5.5-10.0;
2) (K₂O+Na₂O)/ZrO₂ is 0.5-7.1;
3) Li₂O/ZrO₂ is 1.2-5.0;
4) (SiO₂+Li₂O)/ZrO₂ is 8.0-55.0;
5) (SiO₂+Al₂O₃)/(Li₂O+Na₂O+K₂O) is 3.0-7.5;
6) R₂O+Li₂O+Al₂O₃ is 15-30%;
7) MO/ZrO₂ is below 2.5;
8) (Sb₂O₃+SnO₂)/Ag₂O is 0.1-5.0;
9) Ag₂O/CeO₂ is 1.0-10.0;
10) ZrO₂/(Ag₂O+CeO₂) is 2.3-50.0;
11) (Ag₂O+SnO₂+Sb₂O₃)/CeO₂ is 1.0-30.0;
12) (Sb₂O₃+SnO₂+CeO₂)/Ag₂O is 0.1-10.0;
13) SnO₂/(CeO₂+SnO₂) is 0-0.9; and
14) Sb₂O₃+SnO₂ is 0.05-1.2%,
the MO is one or more of MgO, CaO, SrO, BaO, and ZnO, and R₂O is one or two of Na₂O and K₂O.

27. (canceled)

28. The photosensitive microcrystalline glass product according to claim 24, wherein components thereof in percentage by weight satisfy one or more of the following 14 circumstances:
1) SiO₂/Li₂O is 7.0-8.5;
2) (K₂O+Na₂O)/ZrO₂ is 0.8-2.5;
3) Li₂O/ZrO₂ is 1.6-3.0;
4) (SiO₂+Li₂O)/ZrO₂ is 13.0-20.0;
5) (SiO₂+Al₂O₃)/(Li₂O+Na₂O+K₂O) is 4.8-5.8;
6) R₂O+Li₂O+Al₂O₃ is 20-25%;
7) MO/ZrO₂ is below 0.5;
8) (Sb₂O₃+SnO₂)/Ag₂O is 1.0-2.6;
9) Ag₂O/CeO₂ is 2.0-4.5;
10) ZrO₂/(Ag₂O+CeO₂) is 11.0-18.0;
11) (Ag₂O+SnO₂+Sb₂O₃)/CeO₂ is 7.5-10.0;
12) (Sb₂O₃+SnO₂+CeO₂)/Ag₂O is 1.5-3.2;
13) SnO₂/(CeO₂+SnO₂) is 0-0.5; and
14) Sb₂O₃+SnO₂ is 0.2-0.7%,
the MO is one or more of MgO, CaO, SrO, BaO, and ZnO, and R₂O is one or two of Na₂O and K₂O.

29. (canceled)

30. The photosensitive microcrystalline glass product according to claim 24, comprising the following components in percentage by weight: 69.5-75.5% of SiO₂; and/or 4-8% of R₂O; and/or 8.5-12% of Li₂O; and/or 5-9% of Al₂O₃; and/or 3-6.5% of ZrO₂; and/or 0.08-0.3% of CeO₂; and/or 0.2-0.5% of Ag₂O; and/or 0.07-0.5% of Sb₂O₃; and/or 0-0.2% of SnO₂; and/or 0-1% of MO; and/or 0-1% of Ln₂O₃; and/or 0-0.2% of Fe₂O₃, wherein the R₂O is one or two of Na₂O and K₂O, MO is one or more of MgO, CaO, SrO, BaO, and ZnO, and Ln₂O₃ is one or more of La₂O₃, Gd₂O₃, and Y₂O₃.

31. The photosensitive microcrystalline glass product according to claim 24, wherein the photosensitive microcrystalline glass product comprises one or more blackened parts and one or more transparent parts, or the photosensitive microcrystalline glass product as a whole is a blackened part, the photosensitive microcrystalline glass product comprises a lithium metasilicate crystalline phase, and in the blackened part of the photosensitive microcrystalline glass product, the lithium metasilicate crystalline phase has a weight percentage of 5-40%.

32.-33. (canceled)

34. The photosensitive microcrystalline glass product according to claim 31, wherein the transparent part of the photosensitive microcrystalline glass product with a thickness of 0.2-1.5 mm has an average transmittance T_{400-800 nm} above 85.0% at a wave band range of 400-800 nm; and/or the blackened part of the photosensitive microcrystalline glass product with a thickness of 0.2-1.5 mm has an average transmittance T_{400-800 nm} above 5.0% at a wave band range of 400-800 nm; and/or the blackened part of the photosensitive microcrystalline glass product with a thickness of 0.2-1.5 mm has a transmittance T_{870 nm} below 15.0% at 870 nm; and/or the blackened part of the photosensitive microcrystalline glass product with a thickness of 0.2-1.5 mm has a transmittance T_{940 nm} below 50.0% at 940 nm; and/or
the photosensitive microcrystalline glass product has a height II for a falling ball test above 800 mm.

35. (canceled)

36. The photosensitive microcrystalline glass product according to claim 31, wherein the transparent part of the photosensitive microcrystalline glass product with a thickness of 0.2-1.5 mm has an average transmittance T_{400-800 nm} of 91.5-95.0% at a wave band range of 400-800 nm; and/or the blackened part of the photosensitive microcrystalline glass product with a thickness of 0.2-1.5 mm has an average transmittance T_{400-800 nm} below 0.5% at a wave band range of 400-800 nm; and/or the blackened part of the photosensitive microcrystalline glass product with a thickness of 0.2-1.5 mm has a transmittance T_{870 nm} of 0.1-5.0% at 870 nm; and/or the blackened part of the photosensitive microcrystalline glass product with a thickness of 0.2-1.5 mm has a transmittance T_{940 nm} of 0.3-10.0% at 940 nm; and/or
the photosensitive microcrystalline glass product has a height II for a falling ball test above 1,000 mm.

37.-39. (canceled)

40. A glass cover plate, comprising the photosensitive microcrystalline glass product of claim 24.

41. (canceled)

42. A device, comprising the photosensitive microcrystalline glass product of claim 24.

43. A method for preparing the photosensitive microcrystalline glass of claim 10, comprising the following steps: forming the photosensitive glass material, and allowing the photosensitive glass material to form the photosensitive microcrystalline glass by a crystallization process, the crystallization process comprises subjecting the photosensitive glass material to mask exposure treatment, followed by crystallization heat treatment, and the mask exposure treatment comprises subjecting a specific position or region of the photosensitive glass material to UV exposure, at a UV wavelength of 313 nm, for an exposure time of 5-60 minutes; or
the crystallization heat treatment is performed in 2 stages, the 2-stage crystallization heat treatment comprises conducting treatment by a nucleation process at a first temperature, and then conducting treatment by a crystal growth process at a second temperature higher than the temperature of the nucleation process, he first temperature is 490° C.-520° C., treatment time at the first temperature is 1-4 hours, the second temperature is 540° C.-620° C., and treatment time at the second temperature is 1-8 hours.

44.-45. (canceled)

46. A method for preparing the photosensitive microcrystalline glass product of claim 24, comprising the following steps: forming the photosensitive glass material, allowing the photosensitive glass material to form the photosensitive microcrystalline glass by a crystallization process, and then allowing the photosensitive microcrystalline glass to form the photosensitive microcrystalline glass product by a chemically strengthening process, the crystallization process comprises subjecting the photosensitive glass material to mask exposure treatment, followed by crystallization heat treatment, and the mask exposure treatment comprises subjecting a specific position or region of the photosensitive glass material to UV exposure, at a UV wavelength of 313 nm, for an exposure time of 5-60 minutes; or
the crystallization heat treatment is performed in 2 stages, the 2-stage crystallization heat treatment comprises conducting treatment by a nucleation process at a first temperature, and then conducting treatment by a crystal growth process at a second temperature higher than the temperature of the nucleation process, he first temperature is 490° C.-520° C., treatment time at the first temperature is 1-4 hours, the second temperature is 540° C.-620° C., and treatment time at the second temperature is 1-8 hours; and
the chemically strengthening process comprises immersing the photosensitive microcrystalline glass in a salt bath of melt Na salts, and/or K salts, and/or mixed Na salts and K salts at a temperature of 350° C.-470° C. for about 1-36 hours.

47.-50. (canceled)
